(19) United States
(12) Patent Application Publication
(10) Pub. No.: US 2026/0267841 A1
(43) Pub. Date: Sep. 10, 2026

(54) ADVANCED DATA MODELING USING ARTIFICIAL INTELLIGENCE AND MACHINE LEARNING

(71) Applicant: Strategy Inc, Vienna, VA (US)

(72) Inventors: Zhili Cheng, Dunn Loring, VA (US); Mohamed Diakite, Vienna, VA (US); Ruiqing Xu, Hangzhou City (CN)

(21) Appl. No.: 19/662,776

(22) Filed: Apr. 29, 2026

Related U.S. Application Data
(63) Continuation-in-part of application No. 19/193,394, filed on Apr. 29, 2025, now Pat. No. 12,675,497.
(60) Provisional application No. 63/797,042, filed on Apr. 29, 2025.
(60) Provisional application No. 63/640,149, filed on Apr. 29, 2024.

(51) Int. Cl. G06F 16/22

(52) U.S. Cl. CPC G06F 16/221

(57) ABSTRACT

Methods, systems, and apparatus, including computer programs encoded on computer-storage media, for advanced data modeling using artificial intelligence and machine learning. In some implementations, the system identifies multiple data tables to be represented in a data model. The system analyzes the data tables using one or more artificial intelligence and/or machine learning (AI/ML) models, including a series of analysis operations including: performing semantic analysis for data table columns; generating names or descriptions for the columns based on results of the semantic analysis performed for the columns; and performing relationship analysis for the multiple data tables. The system generates content of the data model and provides the data model content to one or more applications or services.

### CROSS-REFERENCE TO RELATED APPLICATIONS

This application claims the benefit of priority to U.S. Provisional Patent Application No. 63/797,042, filed on April 29, 2025, and this application is a continuation-in-part of U.S. Patent Application No. 19/193,394, filed on April 29, 2025, which claims priority to U.S. Provisional Patent Application No. 63/640,149, filed on April 29, 2024, and the entire contents of each of the previous applications is incorporated by reference herein.

### BACKGROUND

The present specification relates to data modeling using artificial intelligence and machine learning.

Databases and other data processing systems often use a data model or data schema to interpret the content of data sets and the connections among data sets. In many cases, creating a data model or data schema is a time-consuming process that requires administrators to perform many manual steps.

### SUMMARY

In some implementations, a computer system provides functionality for automated and semi-automated data modeling, powered by artificial intelligence or machine learning (AI/ML) models, such as large language models (LLMs). When a user creates or edits a data model or data schema, the computer system can analyze data set(s) and their metadata to automatically generate recommended actions for, for example, data cleansing, modeling, and data enrichment. The computer system can then indicate the recommended actions as recommendations that the user can apply, edit and then apply, or dismiss. In some cases, when the computer system determines that an action has a high level of confidence of being appropriate for the data set(s) (e.g., a confidence score above a threshold), the computer system can apply the action automatically.

Data models provide an important link for many systems, such as enterprise software applications, chatbots, AI models, web applications, and so on, to the data those systems rely on. The data model is often needed to enable applications and services to discover and use the data in the enterprise. For example, the data model can indicate the data types of stored data, the semantic meanings of the stored data, relationships among the stored data, and how the stored data can be found or accessed. When a data model is inaccurate or absent, many different data-consuming applications and services may fail to find or access the data they need, and so may not operate properly. As discussed below, the computer system can generate data model content (e.g., creating and updating data models) using AI/ML models in a multi-stage process that makes data available to other systems faster and more accurately than previous techniques. The techniques are also helpful to keep data models up to date as the structure of the data or the set of available data sources changes.

In addition, the data model content and recommended changes that the system makes using the AI/ML models can increase the overall computational efficiency of a database system and the various applications and services that use data from the database system. For example, the AI/ML process can determine lookup tables for columns and determine sets of related columns that enable joins to be made more effectively and efficiently. This information in the data model can directly aid the database system in processing queries, allowing results to the queries to be generated with lower latency and lower computational cost. In addition, the information in the data model that results from AI/ML semantic analysis of data table columns (such as a data type, a data role, a data format, a natural language name and/or natural language description) is often very important in allowing other applications and services to understand and interpret stored data. For example, the semantic information in the data model, when provided to LLMs, can significantly improve the accuracy and quality of responses from LLMs, which are able to accurately select appropriate tables and columns of data and understand the meaning of the data when they would not otherwise. Having a standardized approach to generating the data model content can also provide a more consistent and accurate data model than traditional user-entered data, which often fail to completely describe the types of stored data, are slow to update the data model when data is added or table structure changes, and is subject to potential input errors by users.

In general, the computer system can use the AI/ML models to identify, assess, and/or implement changes to data sets and/or their corresponding data models or data schemas. At each stage, the computer system can analyze the output of the AI/ML models to apply additional policies or supplement the output. For example, the recommendations for cleaning or enriching a data set or for modeling a data set can be based on a combination of (i) items generated by AI/ML models as well as (ii) rule, policies, criteria, user preferences, statistical processing, or other processing by the computer system. The computer system can edit or alter items proposed by the AI/ML models to make them more appropriate for a particular data set or data model. As another example, the computer system can filter or select from among the items proposed by the AI/ML models to ensure that changes to data sets or data models meet standards for relevance or appropriateness before being recommended or applied.

The system can provide information about a data set to an AI/ML model and request that the AI/ML model identify types of changes that are most appropriate for the data set. In this process, the system can provide the AI/ML model metadata for the dataset, data labels (e.g., column names, descriptions, identifiers, etc.), sample data or synthetic data of a similar type, an existing data model or data schema, or other information about the data set. The system can also provide the AI/ML model information about a set of operations or types of operations (e.g., transformations, edits, functions, etc.) to consider. The system can also provide the AI/ML model information about previous data models or data sets, including historical information about other data sets and corresponding changes that were made (e.g., data processing or data modeling recommendations that were accepted and the data contexts in which they were accepted). With information about the types of previous changes that were accepted or applied by users, and the contexts in which they were applied, the AI/ML models can more accurately select changes that are appropriate and are likely to be accepted by users. In some ways, the information about accepted recommendations or changes provides a form of learning over time for the system as a whole, so that even an AI/ML model that is not retrained based on the data can still have the accuracy of its selections improve over time as more history data is gathered.

The computer system can use AI/ML models to assess whether any of various types of actions are appropriate for one or more data sets or their data models. The system can instruct the AI/ML models to generate scores or rankings of proposed changes (whether identified by the AI/ML models, the computer system, or a combination of both) to indicate the relevance or appropriateness for the particular data set(s) of interest to the user. For example, the computer system can instruct the AI/ML models to generate confidence scores for each change, or to group proposed changes into categories that specify the priority or likelihood that the changes should be applied. The computer system may additionally or alternatively generate its own scores or measures of the relevance, confidence, or appropriateness of different changes. The computer system can then use scores that it determined and/or the AI/ML model determined to select a subset to recommend to a user.

The computer system can use AI/ML models to implement changes to data sets or data models or data schemas. For example, for each change to a data set or data model that the computer system selects (e.g., from among changes proposed by an AI/ML model for one or more data sets) to be recommended or applied, the computer system can instruct the AI/ML model to generate interpretable or executable code to perform the change. For example, when a data enrichment action is identified, the computer system can instruct the AI/ML model to generate Python code to perform the data enrichment action. The computer system stores the code that the AI/ML model generates so the data enrichment action can be applied when the user approves. In addition, the code can be viewed or edited by the user, if desired. To assist the AI/ML model in generating accurate and effective code that carries out the desired action, the computer system 110 can provide a set of information that specifies the names or identifiers of data objects (e.g., columns, tables, etc.) and the semantic meanings for and relationships among those data objects. In addition, the computer system 110 can provide the AI/ML model information about rules, policies, or standards to be applied, as well as the functional characteristics (e.g., syntax, functions available, operations supported, etc.) of the data processing system that will run the code. As a result, the computer system 110 can guide AI/ML models to generate highly accurate codes segments to implement the various changes for data modeling or data adjustment.

After a user has approved or applied recommended actions, the computer system can store the list of indicated changes to be applied at a future time, such as when publishing the data model or providing access to another system. This improves efficiency by limiting the number of times that data set and data model need to be altered. For example, the computer system accumulates changes to a data set as the user accepts some recommendations and rejects others. If the user desires to add additional changes, or remove previously accepted changes, this can be done by simply adjusting the list of tasks or changes, with minimal delay. The actual changes to the data set (e.g., filling in empty fields, removing whitespace, etc.) can be performed together as a group, by performing the operations of the code segments corresponding to those changes in the process of publishing or providing access to the data model or data sets.

The computer system can be configured to recommend and carry out many different types of actions for data modeling. These include, for example, defining data objects (e.g., attributes, attribute forms, metrics, facts) from data sets (e.g., tables, columns, etc.), setting relationships among data objects, grouping or merging data objects, creating multi-form attributes (e.g., detecting that are multiple columns that can be associated together as an attribute form), validating relationships among data objects, creating new relationships among data objects, generating names or labels or other metadata for data objects, and so on.

The computer system can also be configured to perform data adjustment actions, such as data enrichment, data wrangling, data cleansing, data transformation, etc. To assist in identifying these actions, the computer system can determine characteristics of data sets and their data objects, including by performing statistical analysis of values in the data set and comparing with reference data (e.g., previous data sets analyzed, data representative of various known types of data, etc.). The computer system can then provide the data characteristics, along with descriptions and other metadata, to the AI/ML models so that the AI/ML models can more accurately determine data adjustment actions that are appropriate.

For example, data enrichment actions can include supplementing a data set (e.g., filling in missing data), verifying or validating data, or merging or associating data from different sources into an integrated data set. In some cases, data enrichment includes combining a customer’s own data (e.g., from internal or customer-provided sources) with additional data from other sources, including potentially external or third-party data sources. In some implementations, the system is configured to expand or enhance attributes for a dimension (e.g., time, geography, category, product, etc.).

For example, if a data set has a column in a table that stores time values (e.g., timestamps), the computer system can be configured to generate a time hierarchy with multiple different attribute data objects that represent the time dimension at different levels of granularity or specificity. For example, from the timestamps, the computer system can automatically create and populate additional new attributes that were not present in the original data set for other measures of time, such as day, month, quarter, year, etc. Creating this time hierarchy in the data model allows users and data processing systems to more easily search, filter, aggregate, and otherwise process data according to any of these additional measures of time, and often do so with greater computational efficiency than without these attributes.

As another example, the computer system can automatically create or expand the attribute hierarchy for geographical dimensions. For example, if a data set includes a column that specifies a city, the computer system can automatically create and populate additional attributes for county, state, country, and so on. Where information is available about other regions, such as sales regions or service areas, the computer system can apply those region definitions to populate further attributes. To populate the information, the computer system can leverage AI/ML models to determine the appropriate values, and/or the computer system can access third-party databases or public data to look up the appropriate values.

Other types of attribute hierarchies can be created based on the context of the data. For example, a data set may include different product names or product feature descriptions. The computer system and the AI/ML models can analyze the information to identify commonalities in product names or product features, to create groupings of products that share certain terms or features. For example, the computer system can create product categories or subcategories based on commonalities in the description of different items.

For the creation or expansion of dimension hierarchies, the computer system can often add attributes that are specified at a more general or less-specific level than the stored data. For example, if a date is known, then the month, quarter, and year can be directly derived or extracted from the date. As another example, if a city is known, the county, state, or country can be determined using another data source that specifies the relationships (e.g., which county, state, and country different cities are located in).

Other types of data adjustment, such as data wrangling and data cleansing can include standardizing data, removing duplicates, detecting and correcting inconsistency and errors, identifying and handling missing values, and so on.

In some implementations, the computer system and the AI/ML models are used to perform data discovery, to find relevant or related data at the early stages of data modeling. For example, in addition to or instead of having users manually select data sources or data sets, the computer system can analyze and characterize data sets available and can identify data sets that are appropriate for a user’s topic or task. For example, the computer system can be configured to gather information about various data sets, such as names of data sources, tables, and data objects, as well as data characterizing the types of content in the data sets. The computer system can then store the information in a vector database, such as by generating a vector in a high-dimensional space representing the semantic interpretation (and potentially structure and other characteristics) of each data set or for smaller portions of each data set. Then, the computer system can provide an interface for users to specify keywords or topics of interest, and the computer system can use the vector database to identify a set of tables or other data sets that are relevant. For example, the computer system can determine a query vector representation of the keywords or topics of interest, and compare to the vector representations for data tables to determine which are closest to the query vector representation. In some implementations, the computer system uses AI/ML models in this process, with the results from the vector database being provided to an AI/ML model for further processing and assessment. In this case, the system can use result-assisted generation (RAG) for data discovery to identify data sets relevant to a user’s keywords or topics, such as a query like “sales last year.” The data tables with the closest vector representations can be selected and presented to the user, along with data indicating known or inferred relationships among them. Then, the user can approve the selected data tables or select a subset, which can begin the process of generating recommendations for data modeling and data adjustment actions.

In one general aspect, a method performed by one or more computers includes: identifying, by the one or more computers, multiple data tables to be represented in a data model; analyzing, by the one or more computers, the data tables using one or more artificial intelligence and/or machine learning (AI/ML) models, including a series of analysis operations including: performing, for each of the data tables, semantic analysis for columns of the data table; generating, for each of the data tables, names or descriptions for the columns of the data table based on results of the semantic analysis performed for the columns; and performing relationship analysis for the multiple data tables to determine relationships among the data tables; generating, by the one or more computers, content of the data model that includes the results of the semantic analysis, the names or descriptions for the columns in the data tables, and the determined relationships among the data tables; and providing, by the one or more computers, content of the data model to one or more applications or services.

In some implementations, performing the semantic analysis includes performing semantic analysis for the columns using one or more AI/ML models to infer data types, detect semantic data roles, or detect data formats for the columns.

In some implementations, the one or more AI/ML models perform the semantic analysis using (i) a table name for the data table, (ii) column names for columns in the data table, and (iii) a subset of rows of data of the data table.

In some implementations, the method includes further comprising applying data validation rules to data in the columns based on the determined data types or data formats for the columns.

In some implementations, wherein generating the names or descriptions for the columns is performed by the one or more AI/ML models to generate a natural language column name or a natural language column description based in part on data types or data roles determined through the semantic analysis for the columns.

In some implementations, generating the names or descriptions for the columns is performed by the one or more AI/ML models based on column names generated by the one or more AI/ML models based on the semantic analysis for the columns.

In some implementations, generating the names or descriptions for the columns is performed by the one or more AI/ML models using (i) a table name for the data table, (ii) column names for columns in the data table, and (iii) a subset of rows of data of the data table;

In some implementations, performing the relationship analysis includes performing the relationship analysis to detect within-group relationships and cross-group relationships for groups of columns using the one or more AI/ML models.

In some implementations, performing the relationship analysis includes: performing a first relationship analysis process to detect one or more simple relationships among the data tables, including at least one of a one-to-one relationship between columns or a one-to-many relationship among columns; performing a second relationship analysis process to detect one or more complex relationships among the data tables, including at least one of (i) a hierarchical relationship between columns, (ii) a grouping of related columns, or (iii) a relationship between columns within a group of columns, or (iv) a relationship between columns in different groups of columns; and merging results of the first relationship analysis process and results of the second relationship analysis process, including validating the results to detect whether an inconsistency is present between the results of the of the first relationship analysis process and the results of the second relationship analysis process.

In some implementations, the series of analysis operations includes performing multi-form attribute grouping to group related columns or data objects, such that each group includes an identifier column and a set of related columns; and the generated content of the data model indicates one or more multi-form attribute groupings that indicates an identifier and a corresponding set of related columns.

In some implementations, the multi-form attribute grouping is performed by the one or more AI/ML models based at least in part on one or more table names and column names.

In some implementations, the series of analysis operations includes determining, for each of one or more columns, a lookup table for the column based at least in part on a natural language table name and a natural language column name; and the generated content of the data model indicates one or more determined lookup tables for one or more columns.

In some implementations, determining the lookup table is performed by the one or more AI/ML models based at least in part on a measure of amounts of distinct values for each of multiple columns.

In some implementations, the series of analysis operations includes attribute linking to identify columns of different data tables for joining the different data tables; and the generated content of the data model indicates identified set of columns for joining two or more data tables.

In some implementations, the method includes comprising, based on results of the series of analysis operations, generating user interface data configured to (i) indicate changes to make to the data model or one or more of the multiple data tables and (ii) display one or more interactive controls configured to cause the indicated changes to selectively applied in response to use interaction with the one or more interactive controls; transmitting the user interface data to a client device over a communication network; and receiving data indicating user input through interaction with the one or more interactive controls. Generating the content of the data model is based on the data indicating the user input.

In another general aspect, a method performed by one or more computers includes: providing, by the one or more computer, data for a user interface to create or edit a data model; receiving, by the one or more computers, user input through the user interface that indicates one or more data sets; in response to receiving the user input indicating the data set, generating, by the one or more computers, a set of recommendations for data modeling, data preparation, or data enrichment for the one or more data sets, wherein at least one recommendation in the set of recommendations is generated using one or more artificial intelligence and/or machine learning (AI/ML) models; providing, by the one or more computers, the set of recommendations for display in the user interface in association with one or more interactive controls to accept or dismiss the recommendations; in response to receiving user input accepting one or more of the recommendations in the set of recommendations, updating, by the one or more computers, the data model or the one or more data sets to apply an update corresponding to the accepted recommendation; and providing, by the one or more computers, the updated data set or updated data model to a chatbot or other application.

In some implementations, the one or more AI/ML models includes a large language model (LLM).

In some implementations, the method includes repeatedly providing additional recommendations for display in the user interface as the data model is being created.

In some implementations, the method includes prioritizing recommendations for presentation in the user interface based on user acceptance or user dismissal of previous recommendations.

In some implementations, the method includes learning from user input that accepts or dismisses recommendations for data modeling, data preparation, or data enrichment, to alter which recommendation are presented for creation or editing of future data models.

In some implementations, the method includes searching through existing data repositories using to find data sets and models; and providing a recommendation that indicates a data source to add to the data model.

In some implementations, the method includes storing information about attributes and metrics from data sets in a vector database.

In some implementations, the method includes using the one or more AI/ML models and the vector database to determine whether portions of the one or more data sets represent attributes or metrics.

In some implementations, the method includes providing a list of column names to the one or more AI/ML models along with a description of metrics and attributes; and receiving, from the one or more AI/ML models, an indication of column names with a respective classification.

In some implementations, the method includes determining a vector representation for each of one or more columns of data of the one or more data sets; calculating the distance between the vector representations of the one or more columns and vector representations from the vector database; and based on the calculated distances, determining, for each of the one or more columns of data, at least one of: a type of data object corresponding to the column, a category or dimension represented by the column, or a semantic meaning of data in the column.

In some implementations, the method includes using the vector database to infer hierarchy relationships among columns or data objects of the one or more data sets, based on similarity to other data sets described by the vector database.

In some implementations, the method includes using the one or more AI/ML models to infer one or more relationships between columns of data in the one or more data sets.

In some implementations, the method includes, based on how columns with known properties and labels are grouped in the vector space of a vector database, using the similarity of vector representations of columns in the one or more data sets to the groupings in the vector space to infer properties of the columns of the one or more data sets.

In some implementations, generating the set of recommendations includes determining one or more data preparation recommendations based on a set of stored data preparation rules that specify criteria for generating data preparation recommendations.

In some implementations, the method includes obtaining, from the one or more AI/ML models, inferred information for a portion of the one or more data sets including, for example, a semantic role, a data type, a data format, a delimiter used, or default action to perform when data is missing.

In some implementations, the set of recommendations includes one or more recommended data preparation actions inferred to be appropriate for the one or more data sets, including at least one of: duplicate row removal, standardizing a temporal data format, enriching data by expanding an abbreviation, normalizing data, standardizing data, or filling in one or more missing values.

In some implementations, the set of recommendations includes a recommendation for an aggregation level for data summarization determined based on characteristics of the one or more data sets.

In some implementations, the method includes performing automatic relationship detection and automatic relationship validation for relationships among data objects in the one or more data sets.

In some implementations, the set of recommendations includes a data modelling recommendation comprising at least one of: creating a hierarchy or link between multiple data sets, creating a new relationship between multiple data objects, or associating data from the one or more data sets with an attribute or metric.

In one general aspect, a method performed by one or more computers includes: receiving, by the one or more computers, user input indicating one or more data sets; in response to receiving the user input indicating the data set, providing, by the one or more computers, a request that includes (i) data describing the data set to one or more artificial intelligence or machine learning (AI/ML) models and (ii) an instruction to identify or evaluate potential changes to the data set or a data model for the data set; identifying, by the one or more computers, one or more operations for updating the data set or the data model based on output of the one or more AI/ML models; updating, by the one or more computers, the data set or the data model by applying the identified one or more operations; and providing, by the one or more computers, the updated data set or updated data model to a chatbot, a published data set, a database system, or an application.

In some implementations, the one or more computers provide the data model to a visualization generator to generate a visualization of data, potentially for a visualization that uses data from multiple data sets.

In some implementations, the one or more computers provide at least portions of the data model to an AI/ML model to use in interpreting or processing a request from a user.

In some implementations, the one or more computers use the data model to detect ambiguities in a query or user prompt.

In some implementations, the one or more computers use the data model to determine mapping between terms of a query or user prompt to data elements in the data model.

In some implementations, the one or more computers use the data model to generate a data cube or to process SQL queries.

In some implementations, providing the data describing the data set includes providing at least one of a portion of the data set, metadata for the data set, values describing characteristics of the data set, or labels or identifiers for data object in the data set.

In some implementations, the one or more AI/ML models comprise a large language model (LLM).

In some implementations, the user input is a user prompt to a chatbot.

In some implementations, the user input includes selection of the data set on a user interface.

In some implementations, the method includes using the one or more AI/ML models to generate executable or interpretable code that is configured to perform the identified one or more operations.

In some implementations, generating the executable or interpretable code includes generating the executable or interpretable using the one or more AI/ML models.

In some implementations, the one or more computers provide data for a user interface to display the generated code and is interactive to enable the user to edit the generated code.

In some implementations, the one or more computers determine confidence scores for each of multiple operations, wherein operations that satisfy a first threshold are performed automatically and operations that satisfy a second threshold but not the first threshold are indicated as recommendations on a user interface with interactive controls that are selectable to cause the operations to be performed.

In some implementations, the one or more computers use the one or more AI/ML models to determine which functions or changes to apply, where the one or more operations comprise at least one of: identifying relationships among data elements in the data set or relationships between the data set and another data set; validating relationships; creating metrics; creating attributes; generating levels of aggregation stored in the data model; generating filter conditions; cleansing data (e.g., standardizing data, removing duplicates); generating names or labels for data objects; or enriching data by adding data elements to the data hierarchy and populating values for the added data elements.

In some implementations, the one or more computers determine that a data element in the data set that represents a measurement of time, and in response, automatically add or recommend to add data elements that represent other measures of time to complete a hierarchy of data elements representing units or increments of time. As a result, the time dimension is indicated at multiple or additional levels of detail or levels of granularity. The data can be enriched to provide values for the additional time attributes, especially expanding to show broader measures that can be determined from narrower or more specific measures from the original data.

In some implementations, the one or more computers are configured to determine that a data element in the data set that represents a geographical dimension and then expand a geographical hierarchy.

In some implementations, to create a metric, the one or more computers can be configured to provide, to the one or more AI/ML models, data that (i) identifies operations that are supported and (ii) syntax for applying the operations. The one or more computers can be configured to: store function descriptions in a vector database; identify one or more metrics to be created based on a user prompt; evaluate which functions are needed using the one or more AI/ML models; select one or more functions from the vector database; provide retrieved function specifications from the vector database with the user request to the one or more AI/ML models; and receive from the one or more AI/ML models a formula for the metric.

In some implementations, the one or more computers can be configured to wait until the data is published to apply the set of operations or set of changes. For example, the one or more computers can be configured to: accumulate changes to the data set or data model for the data set over time, without applying the changes to the data set or data model for the data set; receive input indicating an instruction to publish the data set; in response to receiving the input indicating an instruction to publish the data, apply the accumulated changes and publishing the data with the accumulated set of changes applied.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1A is a diagram showing an example of a system for data modeling and data adjustment using artificial intelligence or machine learning.

FIG. 1B-1J are diagrams showing examples of processes that can be used by the system to perform data modeling and data adjustment.

FIGS. 2A-2K are diagrams showing examples of user interfaces for data modeling and data adjustment using artificial intelligence or machine learning.

FIG. 3A-3E are diagrams showing examples of user interfaces that indicate automated recommendations for data modeling and data adjustment determined using artificial intelligence or machine learning.

FIG. 4A-4D are diagrams showing examples of user interfaces that indicate actions for data modeling and data adjustment determined performed using interactions with a chatbot based on artificial intelligence or machine learning.

FIG. 5A-5E are diagrams showing examples of user interfaces that indicate actions for data modeling and data adjustment, including enriching data by creating attributes and attribute relationships.

FIG. 6 is a diagram showing an example of a user interface for data wrangling with recommendations determined using artificial intelligence or machine learning.

FIGS. 7A-7J are diagrams showing examples of user interfaces that show various types of recommendations for data modeling and data adjustment that are determined using artificial intelligence or machine learning.

FIGS. 8A-8F are diagrams showing examples of user interfaces that show relationships between data objects and actions determined using artificial intelligence or machine learning to validate or establish relationships among data objects.

Like reference numbers and designations in the various drawings indicate like elements.

### DETAILED DESCRIPTION

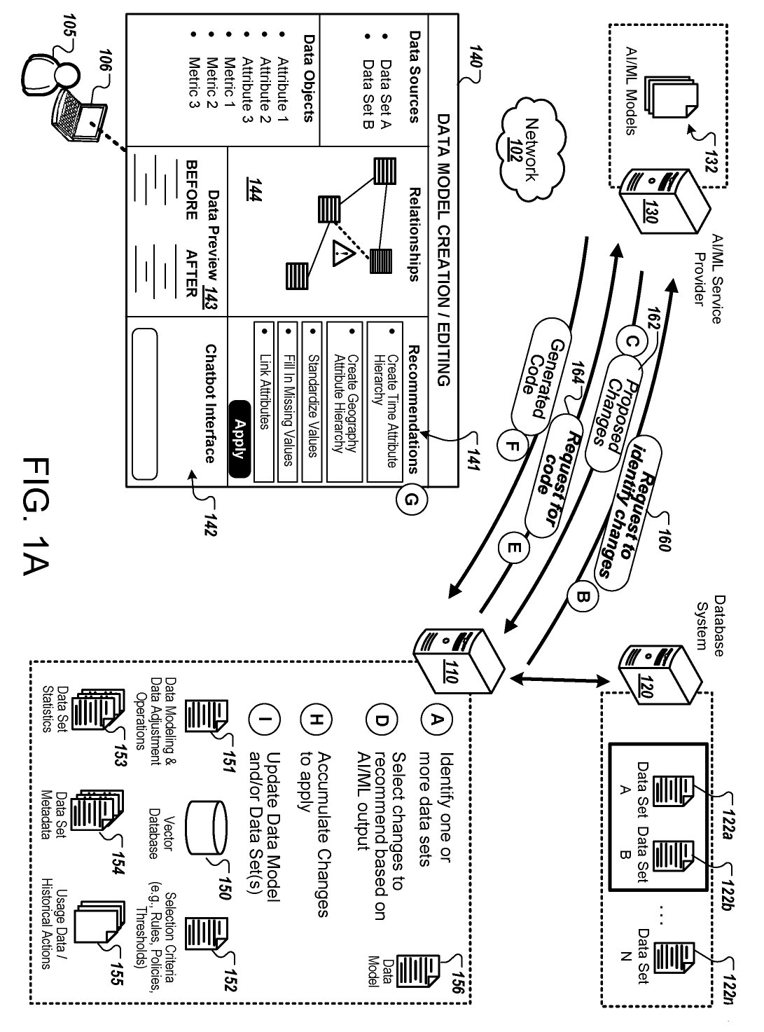

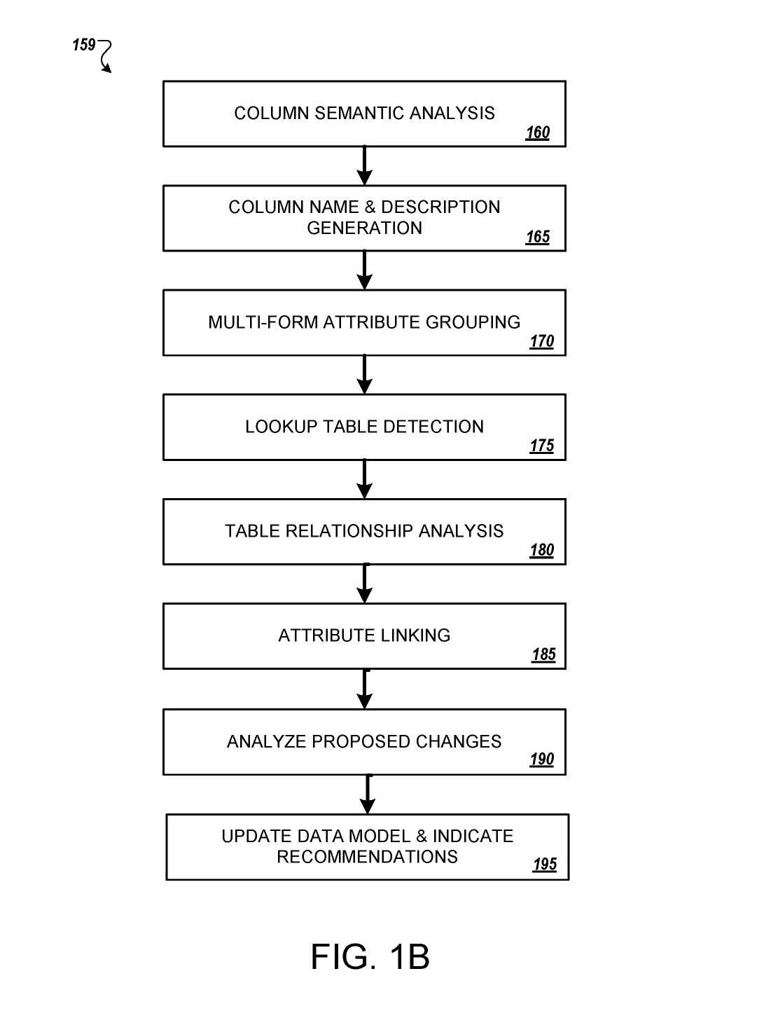

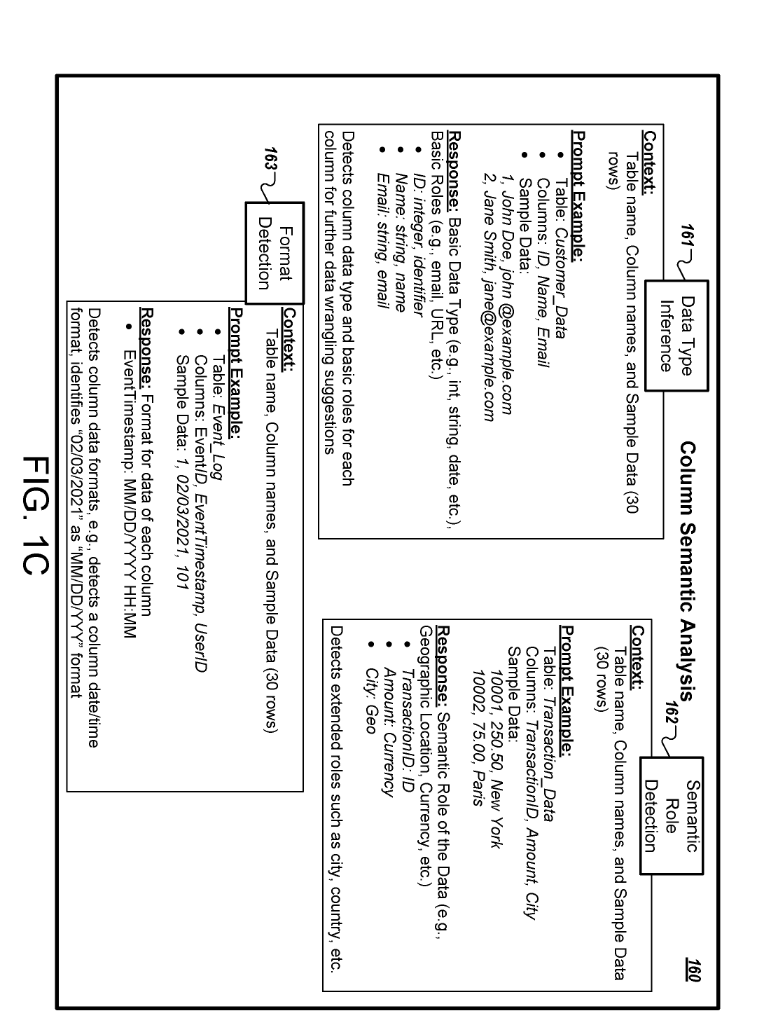

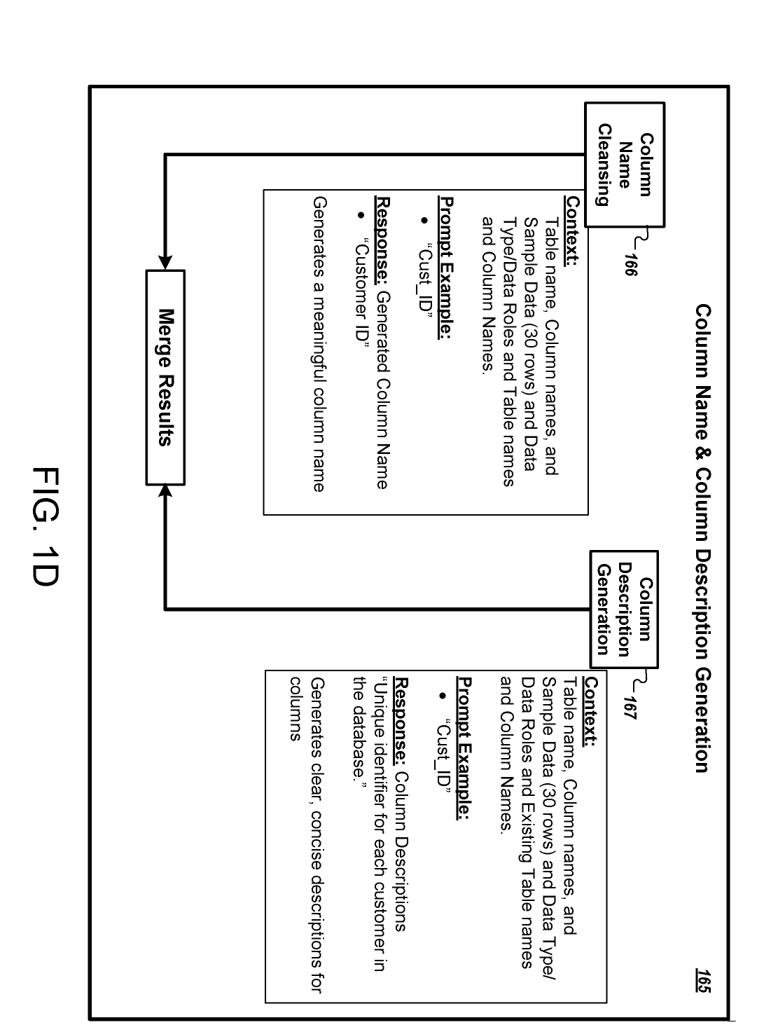

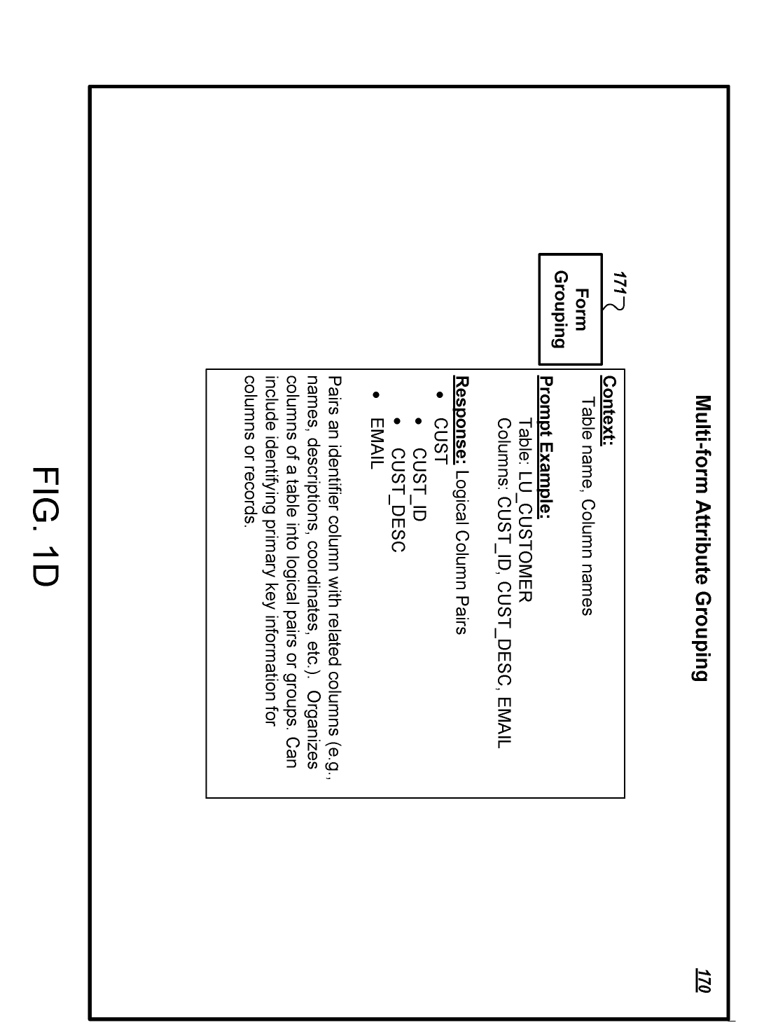

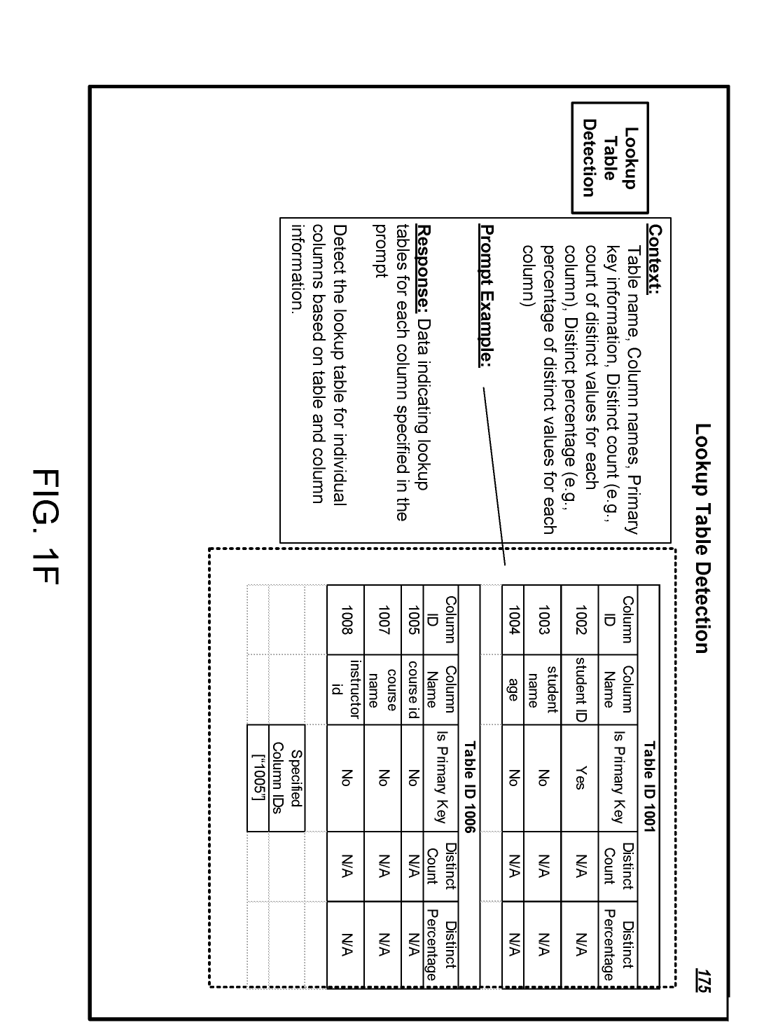

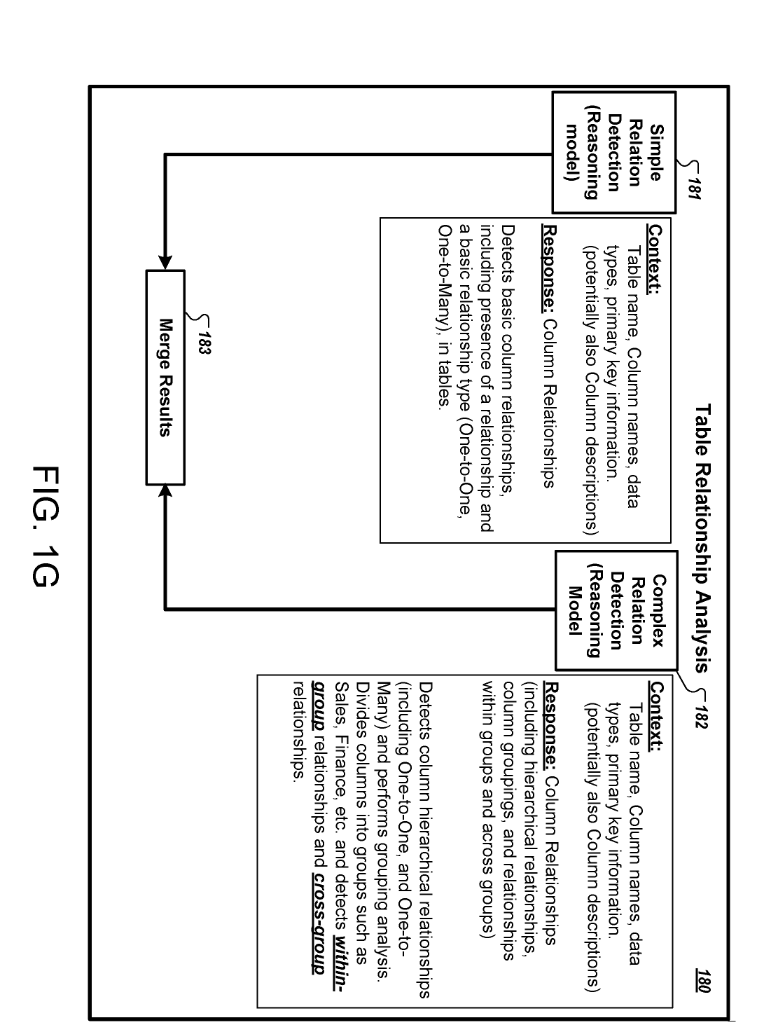

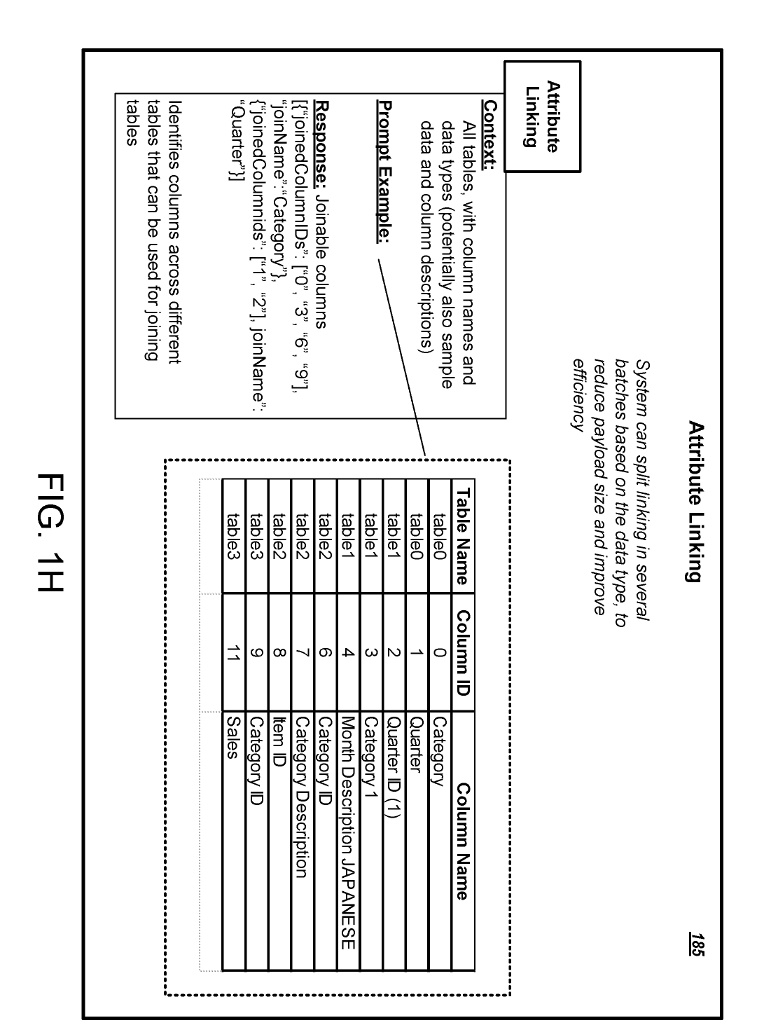

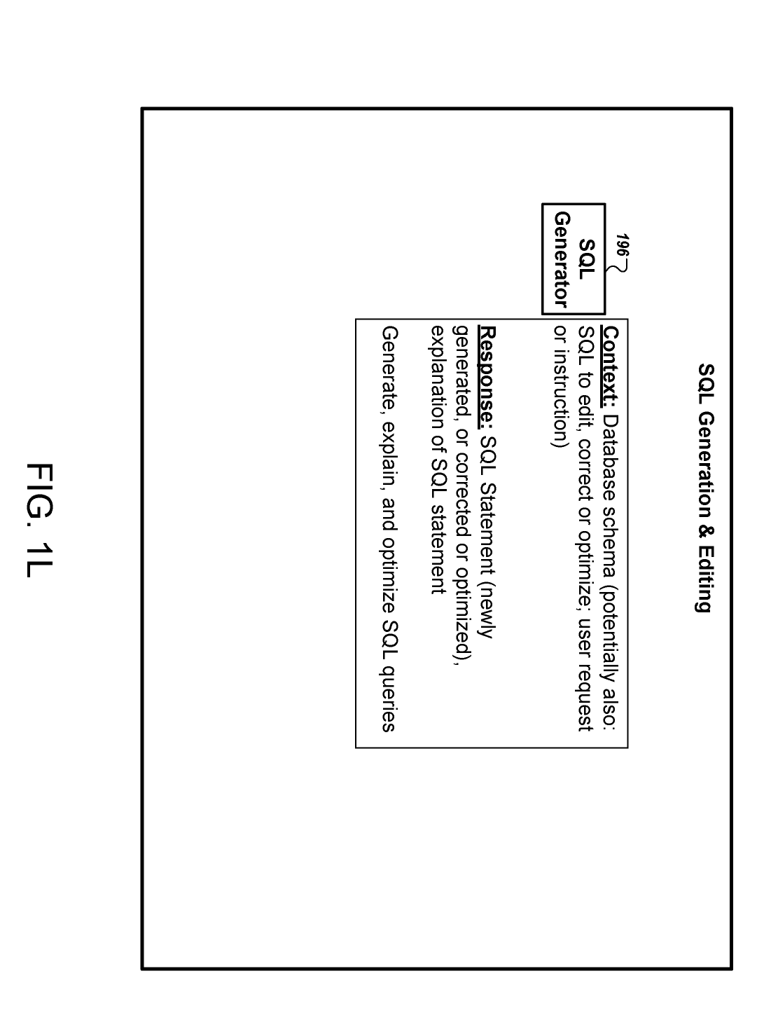

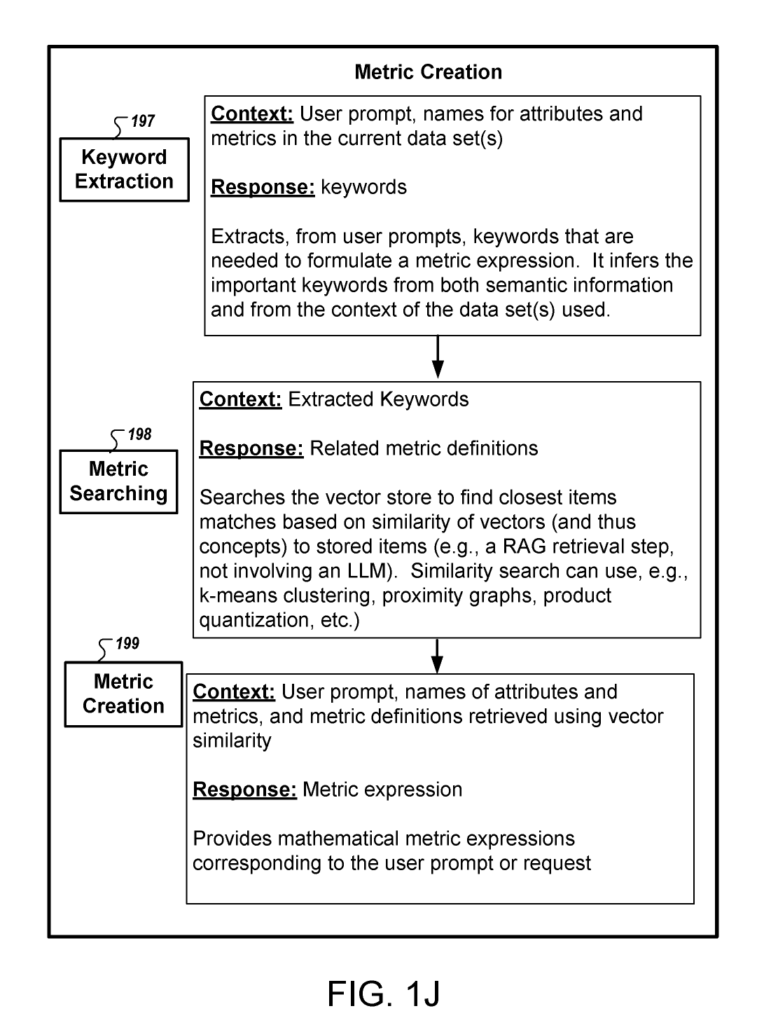

FIG. 1 is a diagram showing an example of a system 100 for data modeling and data adjustment using artificial intelligence or machine learning. The system 100 includes a computer system 110, a database system 120, and an AI/ML service provider 130. The system also includes a user device 106 of a user 105. The elements of the system 100 communicate over a network 102, such as the Internet. The computer system 110 that uses AI/ML models 132 to automatically select actions for data modeling and data adjustment, as well as implement those actions so they can be carried out to create or edit a data model and to improve and enhance data sets. The computer system 110 can provide data for a user interface 140 for data preparation and data modeling, such as a web page, a web application, data shown in a native application, etc. For example, in the example of FIG. 1, a user 105 has a user device 106, which displays a user interface 140 based on data received from the computer system 110 over a network 108.

Workers in businesses often spend significant time and resources to perform data wrangling, including steps such as discovering the data sets that are relevant for a task, structuring data in an appropriate way (including determining appropriate data models and data schemas), cleaning the data, enriching the data, and validating the data, before the data can be published and used by servers, applications, users, and more. By leveraging AI/ML models 132 in some or all of the steps of data wrangling, including in generating and adjusting data models, the system 100 can streamline the process of making data sets accessible and usable by many different systems and software applications. The use of the AI/ML models 132 and automated selection of data modeling and data adjustment actions increases productivity and makes data analytics tools more accessible to a broader range of users.

The system 100 can perform automatic modeling and data adjustment to streamline data preparation and modeling, for analysis, chatbot integration, and other uses. The system improves user interaction with data across all levels, from novice to expert, by automating much of the data cleaning, transformation, and enrichment processes. This efficiency reduces manual input and expertise requirements for users, freeing users to focus on analysis and insights, which speeds up decision-making and deployment. The system 100 can align the capabilities of multi-table data import (MTDI) systems with data processing platforms, paving the way for a seamless modeling experience.

The system 100 can assist users with automated data cleaning. In many cases, a business user wants the system 100 to automatically detect and correct errors and inconsistencies in the data, to ensure accuracy in my analyses without manual intervention. The system ballows this process to occur through automated workflows and conversation-based experiences rather than clicking buttons to search for or create changes to data sets and data models. The system 100 can also enable users to perform data transformation with minimal effort. Business users often need to convert data into a format suitable for analysis, without needing detailed technical knowledge of database structure and operation. The system 110 provides a guided experience where the system proactively identifies and prompts the about the next actions to prepare a dataset or data model.

Referring to FIG. 1, the computer system 110 initially communicates with the user device 106 to provide information for the user interface 140 over the network 102. For example, the user interface 140 can be configured to assist and guide the user 105 through data preparation and data modeling. In some implementations, the user 105 can use the user interface 140 to prepare a data set, potentially combining data from multiple data sources or data sets, that can be used as the source of data for an AI/ML chatbot. In other cases, the user uses the user interface 140 for data preparation for other purposes, such as publishing a data cube, providing data to be used by an application, making data available to a third-party system, and so on. The user interface can be part of a software-as-a-service (SaaS) platform, which assists users to prepare data and generate data models, even if the data resides on premises, on cloud computing platforms, or a combination of multiple locations. The user 105 authenticates to the computer system 110, so that the user’s identity is determined and the user’s permissions can be determined.

The computer system 110 can be implemented using one or more servers, such as one or more cloud computing systems, one or more on-premises servers, etc. For example, the computer system 110 can be an application server. The computer system 110 provides front-end functionality to interface with various client devices. For example, the computer system 110 can provide an interface for creating and editing chatbots and other interactive applications that leverage AI/ML models. The interface can be an application programming interface (API), a user interface (e.g., by providing user interface data for a web page or web application), or another type of interface. The computer system 110 performs various other functions to generate and save customized chatbots, to manage and grant access to existing chatbots, and to coordinate the processing of user prompts to generate responses from the chatbots.

The database system 120 can provide various data retrieval and processing functions. For example, the database system 120 can be a database management system (DBMS), and can include the capability to process operations specified in structured query language (SQL), Python code, or in other forms. The database system 120 stores or has access to various datasets 122a-122n, which can be private datasets for organization, such as a company. The database system 120 can store and use datasets in any of various forms such as tables, data cubes, or other forms.

The AI/ML service provider 130 can be a server system or cloud computing platform that provides access to one or more AI/ML models 132, such as LLMs. The computer system 110, the database system 120, and the AI/ML service provider 130 may be implemented as separate systems or may be integrated in a single system. For example, the AI/ML service provider 130 can be a third-party service or can be managed and operated by the same party as the computer system 110 and/or the database system 120.

In the example, a series of operations and data flows are shown as stages labeled (A) through (I). The operations can be performed in the order indicated or in another order. These stages represent operations for an example as discussed below, but the same operations can be repeated or supplemented in various combinations and sub-combinations also.

In stage (A), the computer system 110 identifies one or more data sets to be used for data modeling or data preparation. Identifying a data set is typically one of the first steps performed. For example, the user 105 may use the user interface 140 to select data files to upload or import, or the user 105 may select data sets or data sources that have already been registered with the computer system 110. For example, the user 105 may specify one of the data sets 122a-122n that is available from the database system 120. As another example, the user 105 may specify a data set available from a third-party system, which makes data available through an application programming interface (API), cloud computing platform, or other access mechanism. The user 105 can identify or add a data set in various ways, such as by dragging and dropping a file, selecting an icon in the user interface 140, selecting data sets from a list, and so on. In the example, the user 105 selected two data sources, Data Set A 122a and Data Set B 122b.

In some implementations, the computer system 110 performs data discovery to find and suggest to the user 105 data sets to use. The computer system 110 can use the AI/ML models 132 to perform data discovery, to find relevant or related data at the early stages of data modeling or data preparation. For example, in addition to or instead of the user 105 manually selecting data sources or data sets, the computer system 110 can analyze and characterize data sets 122a-122n available and can identify one or more data sets that are appropriate for a user’s topic or task.

For example, to prepare to perform data discovery, in advance of a user’s task, the computer system 110 can gather information about various data sets 122a-122n, information such as names of data sources, tables, and data objects, as well as data characterizing the types of content in the data sets 122a-122n. The computer system 110 can then store the information in a vector database 150, such as by generating a vector in a high-dimensional space representing the semantic interpretation (and potentially structure and other characteristics) of each data set or for smaller portions of each data set.

Once the vector database 150 has been populated, the computer system 110 can provide an interface for the user 105 to specify keywords or topics of interest, and the computer system 110 can use the vector database 150 to identify a set of tables or other data sets that are relevant. For example, after receiving a query from the user 105, the computer system 110 can determine a query vector representation of the keywords or topics of interest, and compare the query vector representation with the vector representations for data tables to determine which are closest to the query vector representation. In some implementations, the computer system 110 uses the AI/ML models 132 in this process, with the results from the vector database 150 being provided to an AI/ML model 150 for further processing and assessment. In this case, the computer system 150 can use result-assisted generation (RAG) for data discovery to identify data sets relevant to a user’s keywords or topics, such as a query like “sales last year.” The computer system 110 selects the data tables with the vector representations closest to the query vector representation, and can present these to the user 105, along with data indicating known or inferred relationships among the selected data tables. In other cases, information about the results from the vector database are provided to the AI/ML models 132 processing first, and data tables that the AI/ML models 132 indicate to be most relevant to the query (in view of the vector database results) are then provided to the user. The user can approve the selected data tables, or select a subset of the data tables to use, which can begin the process of generating recommendations for data modeling and data adjustment actions.

In stage (B), the computer system 110 uses information about the identified one or more data sets to request that the AI/ML models 132 determine data modeling or data preparation actions. The computer system 110 initiate the process of analyzing data sets and identifying recommended data modeling and data preparation actions, to automatically surface recommendations to the user 105.

The computer system 110 can identify appropriate actions in various different ways. In some cases, the computer system 110 analyzes the data sets 122a, 122b and determines data set statistics 153 for the different data sets and their components. These statistics 153 and other data can characterize the selected data sets 122a, 122b, indicating information that describes the structure, meaning, and content of the data sets 122a, 122b. The computer system 110 can also apply selection criteria 152, which specify rules, policies, thresholds, and other criteria for different types of actions. For example, the selection criteria 152 can indicate standardization rules or preferred formats for different types of data (e.g., addresses, names, email addresses, phone numbers, etc.), and the computer system 110 can apply these rules to detect when data of a particular type deviates from the preferred format or uses inconsistent formats. The computer system 110 can also store a set of operations 151 to evaluate. For example, the set of operations 151 can include a list of data modeling actions and data preparation actions, along with a criteria for determining when each is appropriate. For some types actions, the computer system 110 can determine that an action is appropriate without using the AI/ML models.

The computer system 110 can also use the AI/ML models 132 to identify data modeling and data processing actions. For example, the computer system 110 can generate and send a request 160 for the AI/ML models 132 to determine changes to a data model or data set. The computer system 110 can include in the request 160 a prompt or instruction for the AI/ML models 132 to consider each of a set of different possible actions, and to determine whether each is appropriate for the current data set. The computer system 110 can include in the request 160 information about the data sets 122a, 122b, such as the column names, table names, metadata, sample data (e.g., a few rows or synthetic data representative of the data content), and so on. This information can provide the AI/ML models 132 the ability to refer to components of the data sets 122a, 122b with identifiers or names that are consistent with those used by the computer system 110, as well as give the AI/ML models 132 information to infer data types and the interpretation of different portions of the data.

In addition, the computer system 110 can include in the request 160 the data set statistics 153 and data set metadata 154, which can further give the AI/ML models 132 the ability to detect anomalies and infer the overall characteristics of the data sets 122a, 122b, even when the content of the data sets 122a, 122b is not provided. This improves privacy and saves time and network bandwidth because the data sets 122a, 122b do not need to be transferred to the AI/ML service provider 130. In addition, providing characterization data or measures derived from the data sets 122a, 122b speeds the processing of the AI/ML models 132 and reduces the computational complexity and cost, because the AI/ML models 132 do not need to process the content of the data sets 122a, 122b.

The computer system 110 can include other information in the request 160 to assist the AI/ML models 132 in making an accurate identification of data modeling and data processing actions. For example, the computer system 110 can provide the set of operations 151, so the AI/ML models 132 has a defined set of actions or changes to consider, and so the AI/ML models 132 can consider each of the possible changes. In addition, the computer system 110 can provide the selection criteria 152, so the AI/ML model 132 can apply the rules, policies, thresholds, or other criteria in generating its output. Optionally, the computer system 110 can also provide examples of the various different types of possible actions or changes. For example, this can include, for each type of action to be considered, (1) one or more example patterns, data set characteristics, or data contexts when the action is appropriate, and (2) one or more example patterns, data set characteristics, or contexts when the action is not appropriate. These examples can guide the AI/ML models 132 by giving reference examples for detecting when the different types of actions are appropriate. In addition, the computer system 110 can further examples through usage data or historical actions 155. The data 155 can provide records or statistics for examples where data modeling or data preparation actions were recommended to users, together with the result whether the user accepted or dismissed the recommendation. More generally, examples of properly-formed reference data models or data schemas can be provided, labeled as needing particular actions or not. This can guide the AI/ML models 132 to determine when the data set or data model being assessed is similar to those that previously needed a particular type of change (so that change should be recommended), or if the data set has characteristics that are more similar to data sets or data models that did not need that type of change (so that change should not be recommended).

In stage (C), the computer system 110 receives output 162 that the AI/ML models 132 generated in response to the request 160. The output 162 indicates a set of changes that one or more AI/ML models 132 indicated to be appropriate for the data model being edited or for preparing the data sets 122a, 122b. For example, the output 162 can indicate a subset of the set of operations 151 that were provided to the AI/ML model 162 to consider. As discussed above, the request 160 can provide the selection criteria 152 for determining whether each type of change is appropriate. The request 160 can also include instructions to select or indicate only changes or actions that are most relevant or have a minimum level of confidence or likelihood of being appropriate for the current data.

In some implementations, the computer system 110 includes in the request 160 an instruction to provide a ranking of the appropriateness of the different actions or changes. In addition, or as an alternative, the computer system can instruct the AI/ML models 132 to provide a score for each action or change selected, such as a confidence score or relevance score. In some cases, the score for a type of change can be a measure of how well the AI/ML models 132 estimates that information about the current data model or data sets 122a, 122b matches or is similar to other examples in which that particular change was performed. As a result, the output 162 from the AI/ML models 132 can include indications of the appropriateness of different changes, whether relative to each other (e.g., a ranking) or on an absolute or non-relative scale.

In stage (D), the computer system 110 analyzes the output 160 from the AI/ML models 132 and select changes or actions to perform. The output 160 can indicate a subset of potential changes that the AI/ML models 132 are most likely to be appropriate for the current data sets 122a, 122b. The computer system 110 can further assess the appropriateness of these changes, by verifying the appropriateness according to the selection criteria 152 and by generating its own set of scores for the relevance or appropriateness of the selected changes. The computer system 110 can thus further limit or filter the changes suggested by the AI/ML models 132 based on its own analysis, to ensure accuracy and ensure that the recommendations made to the user 105 will be useful. In addition, the computer system 110 can supplement the set of proposed changes from the AI/ML models 132 with items that the computer system 110 determined from its own analysis of the data sets 122a, 122b.

In stage (E), the computer system 110 requests for the AI/ML models 132 to generate interpretable or executable code to carry out the set of changes that the computer system 110 has selected. For example, the computer system 110 generates a second request 162 for code to carry out each of the changes that the computer system 110 has selected based on its own analysis and its review of the output 162 from the AI/ML models 132. As an example, the computer system 110 can request for the AI/ML models 132 to generate code for functions in the Python programming language or in another programming language. To facilitate the processing by the AI/ML models 132, the computer system 110 can provide with the request 164 a list of the changes that the computer system 110 has selected to be recommended to the user 105. If needed, the computer system bcan again provide descriptions of the types of changes to be made as well as characteristics of the data sets 122a, 122b. Nevertheless, in many cases, the AI/ML models 132 will retain this information from the context of the session, as long as the amount of data that has not exceeded the context window for the AI/ML model 132. When appropriate, the computer system 110 can provide additional context about the changes to be made, so that the generated code appropriately references the particular tables, columns, data objects, rows, fields, and other items that need to be changed. In other cases, the computer system 110 can fill in values for parameters in the code to make these references after receiving the generated code.

In addition, new code may not need to be generated for every change period for example, many standardized functions such as removing leading or trailing whitespace may be already stored by an available to the computer system 110, so they do not need to be generated again.

In stage (F), the computer system 110 receives generated code 166 that the AI/ML models 132 provide in response to the second request 164. The computer system 110 you can perform validation and testing operations on the generated code 166, to verify that each function or type of change that the code implements can be executed properly. If there are errors or inconsistencies, the computer system 110 can make edits or perform iterative requests to the AI/ML models 132 to correct the code. In addition, the computer system 110 can update fields or values in the code to specify particular portions of the data sets that should be operated on. For example, for code configured to operate on particular fields or particular values, the computer system 110 can identify or verify that the code operates on the fields or values that the function should operate on.

In stage (G), the computer system 110 provides data indicating the selected changes to the user device 106 over the network 102. The user device 106 updates the user interface 140 to show the various recommended items. In the example, the user interface is 140 populates a recommendations area 141 to indicate recommendations including creating a time attribute hierarchy, creating a geography attribute hierarchy, standardizing values, filling in missing values, and linking together certain attributes. Beyond indicating a type or category of change to make, the various items can indicate specifically which data objects, tables, types of values, or other specific items would be changed. The items in the recommendation area 141 are selectable so that the user 105 can interact with them one by one to instruct individual recommended changes to be made. Similarly, the recommendation area 141 can include one or more controls to apply all recommended changes. The recommended changes can include items that prepare the data, and thus alter or adjust the data sets 122a, 122b. Other recommended changes can include items that build or alter a data model for the data sets 122a, 122b.

The user interface 140 includes other areas that can facilitate changes to data models and data sets. For example, the user interface 140 can include a chatbot interface 142 with a text field, in which the user 105 can enter text prompts or instructions to a chatbot. The chatbot is provided the context of the current data model being generated and the data sets 122a, 122b, so the user 105 can refer to items on screen or in the data sets 122a, 122b when requesting changes.

The user interface 140 also shows a data preview area 143 that can be used to illustrate the effect of one or more proposed changes. For example, if the user selects one of the items in the recommendation area 141, the user interface 140 is updated to show example records with the values before making the change and the resulting values that would occur after making the change. As a result, the user 105 can see the effect of a recommended change even before accepting or applying that change.

The user interface 140 shows another area 144 that illustrates connections among data objects. For example, the area 144 can show tables and the relationships among them, or data objects and relationships among them. In some cases, the recommended changes determined by the computer system 110 include changes to add, alter, or remove relationships in the data model. For example, the area 144 shows a warning that a relationship represented by a dotted line does not meet validation rules, and so needs to be removed or changed. This type of recommended change can be determined by the computer system 110 using its own processing of rules and/ or based on analysis and output generated by the AI/ML models 132.

As the user 105 accepts or applies recommended changes from the recommendation area 141, and makes requests in the chatbot interface 142, and edits relationships in the area 144, the data model represented in the user interface 140 is also updated. Areas of the user interface 140 that indicate the attributes, metrics, and other data objects in the data model are also updated.

In stage (H), the computer system 110 accumulates changes to make based on the interactions of the user 105 with the user interface 140. As the user 105 applies recommended changes or makes manual edits, the computer system 110 maintains a list of these items, and during the session builds the list of changes to later apply. In many cases, changes that would affect the data sets 122a, 122b are not applied immediately, which gives time for the user 105 to review and consider the full set of changes before incurring the processing and delay of applying the changes.

In stage (I), the computer system 110 applies the accumulated changes to update the data model and or data sets 122a, 122b. As noted above, many changes to the data model can be performed over the course of the users interactions, especially so those changes are reflected in the user interface 140 and in the data model records. Nevertheless, other accumulated changes corresponding to recommended items that the user accepts or applies can be deferred until a publishing event triggers application. For example, the user 105 finalizes the data model and selects to publish the data to an application, a chatbot, or another system. In response, the computer system 110 performs the functions (e.g., generated code) for the recommend items that the user 105 has applied, as part of finalizing and publishing the data. The computer system 110 also stores the data model 156 and can make it available to other systems to be able to access and interpret the data in the data sets 122a, 122b.

FIG. 1B-1J are diagrams showing examples of processes that can be used by the system to perform data modeling and data adjustment. The example of FIG. 1A shows stages (B) and (C), in which the computer system 110 sends information to be processed by the AI/ML models 132 and receives proposed changes or recommendations in response. These steps can be performed in a series of multiple interactions that address different aspects of data modeling. In some implementations, a series of interactions can be performed to incrementally build understanding about the characteristics and content of data sets 122a-122bto be described by a data model 156. In some cases, depending on the item to be assessed, the computer system 110 can generate requests to the AI/ML models 132 for each table or for each column of each table of data. In addition, or as an alternative, the computer system 110 may send requests for the AI/ML models 132 to perform analysis for a set of multiple tables (e.g., for some or all of the data in the data sets to be described by the data model 156).

FIG. 1B shows an example of a process that the computer system 110 can use to perform a series of interactions with the AI/ML models 132 to generate recommendations. The various steps or stages can be performed in the order shown, or many can be performed separately to achieve specific analysis results. In some implementations, one or more of the steps or stages illustrated can build on the results of the previous step. For example, the output of one step may be provided as input or context to the next step.

FIG. 1B shows a process 159 that includes: column semantic analysis 160 to determine data types, semantic data roles, and data formats; column name and description generation 165 to generate a meaningful natural-language column name and a description of each column;

multi-form attribute grouping 170 to group related columns or data objects; lookup table detection 175 to determine a lookup table for each individual column (e.g., specifying a data set, table, and column where each attribute, metric, or other data object can be found); table relationship analysis 180 to determine column relationships (e.g., detecting the presence of a relationship, a type of relationship (e.g., one-to-one or one-to-many), hierarchical relationships, grouping of columns and detection of relationships between columns within groups and across groups); attribute linking 185 to identify columns that can be used for joining tables; analyzing proposed changes 190; and updating the data model 156 and indicating recommendations 195.

Each of the steps or stages shown in FIG. 1B can have multiple components and each can make use of an AI/ML model 132 or a retrieval using a vector store or a vector similarity search. FIGS. 1C-1H illustrate steps 160, 165, 170, 175, 180, and 185 in further detail. For each of these steps, and for sub-components of them, the computer system 110 can store predetermined instructions that are tailored or targeted to specific functions or operations. Each request to the AI/ML models 132 can include a particular set of context for one or more columns or tables, along with one of the predetermined instructions corresponding to the particular type of analysis or generation needed.

FIG. 1C shows additional detail about operations that the computer system 110 can perform to perform column semantic analysis. These include data type inference 161, semantic role detection 162, and format detection 163. Each of these operations can include a different type of request to an AI/ML model 132, and type of request can be performed for each table of data of the data sets 122a-122bselected to be described by the data model 156. For example, if there are 5 tables, the data type inference 161, semantic role detection 162, and format detection 163 would be performed for each of the 5 tables.

For data type inference 161, the computer system 110 provides the AI/ML model 132 context that includes a table name, column names for the columns of the table, and a set of sample data from the table for each column (e.g., 30 rows of data from the table). The computer system 110 provides an instruction for the AI/ML model 132 to determine, for each column in a table, a data type of the data in the column and a basic semantic role for the column. For example, the data type can indicate whether the data is an integer, a string, a date, geographical location, and so on. Similarly, the basic semantic role for the data can indicate the meaning or content of the data, such as, e-mail, a URL, a street address, a zip code, and so on. As an example, the table Customer_Data is indicated in the prompt, along with column names “ID,” “Name,” and “Email,” and several columns of example data. Based on the instruction in the prompt, and the context provided with the prompt (e.g., including the metadata for the table name and column names and the sample data), the AI/ML model 132 generates a response that specifies the data type and basic semantic role for each column. For example, the response can indicate that: column ID has a data type of integer and the semantic role is as an identifier; column Name has a data type of string and a semantic role of name (e.g., name of a person); and column Email has a data type of string and a semantic role of email address. By sending a request and response like this for each table in the data sets 122a-122b to be analyzed and described by the data model 156, the computer system can detect the column data types and semantic roles for each column of data.

The computer system 110 then uses the detected data types and semantic roles to apply appropriate validation and data wrangling rules for each data type. For example, based on the data types, the computer system 110 checks whether the data in the Email column all meet the required syntax for email addresses and can create recommendations to correct entries that do not. Similarly, the computer system 110 can examine values in the ID column to identify fields that are missing, null, or have values that are not an integer, and so represent outliers or invalid identifiers, and the computer system 110 recommends corrections. The data types and data roles can also be provided to the AI/ML models 132 for further AI/ML processing and validation later on.

For the semantic role detection 162, the computer system 110 provides the AI/ML model 132 context that includes a table name, column names for the columns of the table, and a set of sample data from the table for each column (e.g., 30 rows of data from the table). The computer system 110 provides an instruction for the AI/ML model 132 to determine, for each column in a table, extended semantic roles. For example, rather than just determining that a value represents geographical information, the semantic role detection can determine more specifically that a column of data represents a city, a country, etc. The example shows sample data for a table named “Transaction_Data” and three columns named “TransactionID,” “Amount,” and “City.” Based on the instruction from the computer system 110 to determine the semantic roles, and the information about the data provided, the AI/ML models 132 provide data indicating that column TransactionID represents an identifier, that column Amount represents currency (e.g., monetary values), and that City represents a geographical location or more specifically a city.

For format detection 163, the computer system provides the AI/ML model 132 context that includes a table name, column names for the columns of the table, and a set of sample data from the table for each column (e.g., 30 rows of data from the table). The computer system 110 provides an instruction for the AI/ML model 132 to determine, for each column in a table, the data format for the column. The example shows sample data for a table named “Event_Log” with three columns named “EventID,” “EventTimestamp,” and “UserID.” After being instructed by the system to determine the data formats for the columns of this table, the AI/ML model 132 provides a response that indicates that the EventTimestamp column MM/DD/YYYY HH:MM (e.g., two digit month, a slash, two digit day, a slash, a four-digit year, a space, two digit hour, a colon, and a two digit amount of minutes). The other two columns can be detected to simply have integer data formats. From the data formats determined by the AI/ML models 132, the computer system 110 can perform analysis on the data in the tables to identify cases where the data formats are not followed correctly, and the computer system 110 can provide recommendations that specify changes for specific records or fields to follow the determined data formats. The formats that are detected allow the computer system 110 to effectively parse data, detect incorrectly formatted data, and perform other operations.

The computer system 110 can save the information determined by data type inference 161, semantic role detection 162, and format detection 163 in the data model 156. For example, the computer system 110 can automatically update the data model 156 to indicate, for each column the data types, data roles, and data formats determined for each column. This information can also be used to generate or describe the various logical data objects that will be shown to the user as attributes, metrics, etc.

FIG. 1D shows column name and column description generation 165 performed using the one or more AI/ML models 132. Based on semantic information, the computer system 110 can obtain a name and description for columns. This includes column name cleansing 166 and column description generation 167. In some implementations, to enable the AI/ML models 132 to benefit from the context of all of the tables and relationships that may be present, the column name cleansing 166 and column description generation 167 each performed once, with the full context information for all tables. This can improve accuracy by, for example, providing additional context to allow more accurate column names, and also to show relationships that allow more accurate descriptions.

For column name cleansing 166, the computer system 110 provides the AI/ML model 132 with a table name, column names for the columns in the table, and sample data from the table (e.g., 30 rows), as well as the data types and data roles determined through the column semantic analysis 160. The computer system 110 also provides the AI/ML model 132 any existing table name or label for the table and existing column names or labels (e.g., metadata or natural language names other than the formal identifiers). With this context, the computer system 110 provides an instruction for the AI/ML model 132 to generate a natural language column name for each of the columns in the table. The instruction can include criteria specifying desired criteria for the names, e.g., length, descriptiveness, etc. The instruction can include examples of column references and natural language names as well. The AI/ML model 132 provides a response that includes a generated column name for each of the columns of the table described in the context. For example, if the table has a column named “Cust_ID” the AI/ML model 132 can provide a new name of “Customer ID” to be used. In this way, new names can be determined for some or all of the columns in a table, and the process is performed for each of the tables.

For column description generation 167, the computer system 110 provides the AI/ML model 132 with a table name, column names for the columns in the table, and sample data from the table (e.g., 30 rows), as well as the data types and data roles determined through the column semantic analysis 160. The computer system 110 also provides the AI/ML model 132 any existing table name or label for the table and existing column names or labels (e.g., metadata or natural language names other than the formal identifiers). With this context, the computer system 110 provides an instruction for the AI/ML model 132 to generate a concise description of each column. The computer system 110 can provide the AI/ML model 132 criteria for generating the description (e.g., one sentence or one line, etc.) and can give examples of inputs and appropriate outputs. The AI/ML model 132 provides output that includes a column description generated based on the table and column information provided in the context. For example, for a table that includes a column named “Cust_ID,” the AI/ML model is given the column name and the data type (e.g., integer), and data role (e.g., identifier), and other information about this and other columns in the table. The AI/ML model 132 generates a column description of “unique identifier for each customer in the database” for the “Cust_ID” column.

The computer system 110 merges the results from the column name cleansing 166 and column description generation 167 to save in the data model 156 the generated column name and column description for each of the columns of each of the tables. In some implementations, the same techniques used to generate names and descriptions for columns can also be used to generate names and descriptions for tables, data sets, or other items.

FIG. 1E shows processing for multi-form attribute grouping 170 performed using the one or more AI/ML models 132. In many cases, there may be multiple columns that describe an entity, such as a first name and last name that both relate to the same person. The AI/ML model 132 can be used to identify related types of data that can be associated to form a single logical attribute form that has multiple fields. This process involves form grouping 171 processing that uses a request to an AI/ML model 132, which can be performed for each table of the data sets 122a-122bcorresponding to the data model 156. The context provided to the AI/ML model 132 includes the table name and the names of each of the columns of the table. The column names can be column names that an AI/ML model 132 generated, such as through the column name generation processing of step 165. In some implementations, the column descriptions are also provided as context to the AI/ML model 132. The original column names and/or descriptions can optionally be provided to the AI/ML model 132 also.

The computer system 110 sends the table and column information (e.g., all for the same table) to the AI/ML model 132 with an instruction (e.g., a prompt from the system 110) to identify related columns, e.g., columns that all describe properties of the same entity. For example, if the table “LU_CUSTOMER” and column names “CUST_ID,” “CUST_DESC,” and “EMAIL” are provided, the AI/ML model 132 provides logical column pairs or groups. For example, for the three columns, the AI/ML model 132 provides output indicating that two of the three columns, “CUST_ID” and “CUST_DESC,” relate to the same entity (e.g., customer or “CUST”), and so should be grouped together in a multi-attribute form. In general, the multi-form attribute grouping can pairs or associate an identifier column with one or more related columns (e.g., names, descriptions, coordinates, etc.). This can organizes columns of a table into logical pairs or groups. In addition, the AI/ML model 132 can be instructed to select or determine identifying primary key information for columns or records. The groupings that the AI/ML model 132 determines can be saved and provided as data modeling recommendations to be presented to the user.

FIG. 1F shows an example of lookup table detection 175 performed using the one or more AI/ML models 132. The lookup table detection is configured to optimize query generation by finding a lookup table that can connect to the source table for the information in a given field or column. In general, logical data objects such as attributes, metrics, attribute forms, etc. are abstractions, and the data model 156 generally should provide a link or connection to the source table that is the source of the values for the data objects. Thus, a lookup table in this context can be an identification of the table from which values of a data object can be sourced or accessed. The lookup table detection 175 can map the relationships of tables to data objects. Most of the time, attribute fields or columns come from the same table where the column is stored. A data table or schema can show if there is a join needed or available for a data object.

In the example, lookup table detection 175 is performed with a request to an AI/ML model 132 for each table of the data sets 122a-122bcorresponding to the data model 156. The context provided with the request can include the table name of the current table, column names for the table, primary key information (e.g., an identification of the primary key column or data object), a distinct count of values for the columns (e.g., for each column, what is the count of distinct values in the column), and a distinct percentage of values for the columns (e.g., for each column, what percentage of values in the column are distinct). In some implementations, the request to the AI/ML model 132 includes information about multiple tables or all tables in the data sets 122a-122b, so that possible joins can be determined. With this information the computer system 110 provides a instruction for the AI/ML model 132 to identify the lookup table, or source table, for each of a designated set of columns. In the illustrated example, a single specified column ID of “1005” is provided, to request the lookup table information for that particular column. Other types of requests can be made with lists of multiple columns or all columns of a table to request lookup table information for some or all columns. The response from the AI/ML model 132 provides data indicating lookup tables for each column specified in the prompt. This allows the process to detect the lookup table individual columns based on table and column information. The computer system 110 updates the data model 156 with the lookup table information, and notifies the user with an error or a recommendation if there is a non-standard situation, such as a failure to find a lookup table, conflicting information, etc.

FIG. 1F shows an example of table relationship analysis 180 performed using the one or more AI/ML models 132. This involves simple relation detection 181 and complex relation detection 182, with the results being merged 183 afterward. This process can be performed for each table of the data sets 122a-122b, e.g., with simple relation detection 181 and complex relation detection 182 being done for each table. The simple relation detection 181 and complex relation detection 182 can be performed using requests to a reasoning model, e.g., an LLM that is configured to break down problems into smaller, logical steps, often referred to as "chain-of-thought" reasoning.

Table relationship analysis can be configured to determine the hierarchy of tables, and can involve collecting information for primary and foreign keys. If the information is not available, the computer system 110 asks the AI/ML model 132 to infer the keys. The request to the AI/ML model 132 can be for a set or sequence of operations, which makes the reasoning model an effective type of model to use. For example, the table relationship analysis can involve asking the model 132 to determine a set of columns related to a key, then identify in each group that are related, then determine what are the relationships across groups, and then repeat all of these steps again for additional levels of connections or associations. The results from the AI/ML model 132 can effectively build relationships table to table, and group to group, until an overall hierarchy is built.

For the simple relation detection 181, the AI/ML model 132 is asked to identify relationships between columns in a table. The computer system 110 provides the AI/ML model 132 the instruction with context including a table name, column names for the columns in the table, data types for the columns, and primary key information, and potentially also column descriptions. The output of the AI/ML model 132 are column relationships, including where a relationship is present, a type of relationship. This detects basic column relationships, including presence of a relationship and a basic relationship type (e.g., one-to-one, one-to-many), within a table.

For the complex relation detection 182, the AI/ML model 132 is asked to identify more complex relationships, including hierarchical relationships, column groupings, and relationships within groups and across groups. The computer system 110 provides the AI/ML model 132 the instruction with context including a table name, column names for the columns in the table, data types for the columns, and primary key information, and potentially also column descriptions. In addition, to facilitate the determination of relationships across groups, information about column groups in a table can be provided if known, otherwise the AI/ML model 132 can generate the group information and infer additional relationships between the groups. As a result, the AI/ML model 132 can be used to detect column hierarchical relationships (including one-to-one, and one-to-many) and performs grouping analysis. The output can indicate a hierarchy of columns, and can divides columns into groups (such as Sales, Finance, etc.) by topic, entity, dimension, or other criteria, and detects within-group relationships and cross-group relationships.

After relationships are identified using the simple relation detection 181 and complex relation detection 182, the computer system 110 validates the results. The two processes should provide consistent results, even if the simple relation detection 181 does not provide as many or all of the types of relationships that are determined through the complex relation detection 182. When the computer system 110 detects a mismatch or inconsistency among the outputs, the computer system 110 can provide the information to the AI/ML model 182 and ask it to resolve the discrepancy if possible, or the computer system 110 can flag the issue for the user as an error or a recommendation for a change to be made.

In some implementations, the grouping and relationships among groups can be performed for multiple levels to determine a hierarchy, which may include instructing the AI/ML model 132 to perform the analysis for multiple levels of groups, or may include iteratively sending additional prompts to request information about additional levels. In some implementations, the computer system 110 and the AI/ML model 132 use semantic information at each analysis step. For example, when determining whether to create an attribute or to group attributes, the system 110 can use the AI/ML model 132 to (1) evaluate whether another attribute with similar name, description, and/or data type has been created, (2) compare how close the existing attribute or group is to the new candidate attribute or group, and (3) determine relationships based on the similarity.

FIG. 1H shows an example of table attribute linking 185 performed using the one or more AI/ML models 132. The attribute linking can be performed across all of the tables of the data sets 122a-122b rather than for a single table at a time. Nevertheless, to increase efficiency and reduce the amount of context the AI/ML model 132 needs to process in a single request, the computer system 110 can split the task into several batches based on the data type of the columns. As context, the computer system 110 provides the AI/ML model information about all tables, including column names and data types (e.g., integer, string, etc.). The computer system 110 provides an instruction for the AI/ML model 132 to identify attributes that can be linked or joined. For example, the AI/ML model can provide output that indicates joinable columns (e.g., a list of column identifiers to be joined, and a name for the join). In general, the attribute linking can be used to identify columns across different tables that can be used for joining tables together. In the processing, the AI/ML model 132 can rely on the generated column names and generated column descriptions from step 165.

In the processing for steps 160, 165, 170, 175, 180, and 185, the requests to the AI/ML models 132 can be considered separate requests, which do not maintain context from one request to another. In other words, the full input, context, and output of one request or step is not maintained and propagated for requests for other tables or for other steps. Nevertheless, the information generated during the processing by the AI/ML model 132 is often used in later steps. For example, the semantic roles, data types, and data formats determined in step 160 can be provided to assist in generating column names and column descriptions in step 165. In addition, the generated column names and column descriptions (as well as potentially semantic roles, data types, and data formats) can be used to perform attribute grouping 170, table relationship analysis 180, and attribute linking 185. These processes of incrementally building the data model 156 through a series of different types of requests to the AI/ML models 132 helps ensure accuracy and reveal errors and inconsistencies where they can be corrected or brought to the attention of the user. For each of the steps, 160, 165, 170, 175, 180, and 185, the computer system 110 can use a different instruction or set of instructions to the AI/ML models 132. As a result, the computer system 110 selects the appropriate predetermined instruction appropriate for each stage of processing.

Referring again to FIG. 1B, after performing the other steps, the computer system analyzes the proposed changes 190 to the data model 156. Many types of changes, such as the generation of column names and the detection of data types and data formats can be applied automatically where there is high confidence or high consistency among the data set 122a-122b. The computer system 110 can validate relationships, attributes, attribute forms, inferred keys, and other outputs to determine whether they meet predetermined criteria for that type of modeling output.

The computer system 110 then updates the data model 156 and indicates recommendations 195. In some implementations, changes that have at least a minimum level of confidence or that satisfy corresponding rules or criteria can be applied automatically. Items that have lower confidence, or have inconsistencies, can be provided as recommendations, for the user to approve or adjust. In some cases, the data modeling changes made using the process 159 lead to other recommendations. For example, the detection of a data type and data format in the process 159 can lead to the computer system 110 attempting to standardize a column’s data or to identify outliers or missing values. The data modeling information generated in the process 159 using the AI/ML models 132 can thus lead to additional data cleansing and data enrichment recommendations (e.g., to change the format of certain rows that do not follow the identified format for the column, to fill rows identified to be missing data, to identify outlier values or values that do not fit the data type for the column, and so on.

The various steps of the process 159 result in the automatic creation of relationships, hierarchies, attributes, attribute forms, metrics, etc., including related information such as primary keys, lookup table identification and more. The computer system can translate this data into recommendations based on the confidence level of different relationships, attributes, or other data. One way that the computer system 110 can do this is by using vector similarity to compare to other characteristics of other data sets. For example, the computer system 110 can store vector embeddings that represent well-formed properties of data sets, and the computer system 110 can use vector search functionality to determine whether there are other similar attributes, relationships, or other items or properties. The greater the similarity to data set characteristics known to be correct, even if for other data sets or contexts, the higher the confidence can be. The computer system 110 can use rules as well. For example, most multi-form attributes do not have more than two fields or related columns. The computer system 110 can have a rule to automatically create attribute forms of two fields, but if an attribute form with more than two is indicated, then add this as a recommendation for the user to see and accept before adding it to the data model 156.

In general, the computer system 110 generates and provides recommendations after a user adds new tables. To avoid showing disconcerting changes to a data model 156, the computer system 110 can avoid making changes after a user has saved it, unless the user initiates an update cycle or adds a new table. The computer system 110 can show generating new recommendations or refreshing recommendations as an option that the user can initiate. In general, actions such as identifying attributes and metrics and setting names and descriptions are done automatically, without requiring a user to view and accept a recommendation. For relationships (e.g., between tables or columns), the system 110 can provide a user-selectable setting whether to automatically create attribute relationships or not. If automatic creation is enabled, then the computer system 110 can apply a threshold, such as a minimum 90% confidence or more, for automatic creation of attributes, and candidates with lower confidence are suggested as recommendations.

FIG. 1I shows interactions that the computer system 110 can use to perform generation and editing of SQL statements. For example, when a user asks for a metric to be created or edited, or if a user discusses a SQL query to be generated or edited, the computer system 110 can interact with the AI/ML models 132 to request the generated SQL or edited SQL. For example, the computer system 110 can have an SQL generator module that manages requests to an AI/ML model 132. The computer system 110 provides context to the AI/ML model including a database schema or existing content of a data model. A user’s request or instructions, such as a question or request from the user, can be provided, along with potentially existing SQL statements to edit, correct, optimize, or explain. The computer system 110 can also provide a system instruction that explains the function the model 132 should perform. The AI/ML model 132 then generates and outputs the SQL statement or natural language explanation of a SQL statement, as requested by the user or the system.

The SQL generator 196 can be used to implement changes or carry out requests a user makes through a chatbot interface for the purpose of data cleansing, data modeling and data enrichment. As an example, in the context of importing a data set or generating a data model, the user may provide a user prompt in a chatbot interface, “union these tables.” The user did not request to create a SQL statement, and simply entered the request in the chatbot assistant for data modeling. Nevertheless, the computer system 110 uses the SQL generator 156 to generate the SQL statement to carry out the request. The computer system 110 uses the state of the user interface (e.g., data from the client device, provided over the network 102, indicating the user selections or state of the user interface) to determine the appropriate context for the request. In this example, the user has selected two tables or has two table open for editing or data modeling. The computer system 110 provides the user prompt with the information about the applicable tables and the information about the content of the tables (e.g., data schemas, or existing data model content), and instructs the AI/ML model 132 to generate a SQL statement that will carry out the join. In response the AI/ML model 132 outputs the SQL statement that will perform the join of the applicable tables. The computer system 110 saves the resulting union in the data model 156, and the joined tables become accessible as a table in the data model 156.

FIG. 1J shows examples of techniques that the computer system 110 can use to automatically perform metric creation using AI/ML models 132. Metric creation can be used to generate new logical data objects in the data model 156 from one or more columns of data. Metrics can be data objects that represent various types of operations on data (e.g., mathematical operations sum, mean, maximum, minimum, etc.), as well as filtering, aggregation, sorting, and more. The created metrics can then be provided as logical data objects in the data model 156 that can be re-used, e.g., shown on user interfaces for users to select, provided for chatbots to access, and so on.

In general, the metric creation process can enable a user to simply type a request, e.g., “create a metric for monthly sales” and the computer system 110 uses the AI/ML models 132 to generate the metric definition automatically. Through multiple interactions or operations, the computer system 110 can identify (1) the columns or data objects to be operated on (e.g., a column of sales data and a column with date information), and (2) the function to apply (e.g., aggregate), and then combine the elements to define the metric (e.g., a formula that aggregates values in the sales data column by month using data in a date column).

Metric creation can include three main steps or stages, keyword extraction 197, metric searching 198, and metric creation 199.

The keyword extraction 197 can involve the computer system 110 making a request to the AI/ML model 132 that includes the user prompt and names for attributes and metrics in the current data set(s). The computer system 110 provides an instruction for the AI/ML model 132 to identify keywords in the prompt, such as items to be represented or to be components or results of the metric. The keyword extraction can be sued to identify words representing functions to be performed as well as the data objects to be operated on and parameters to apply. The AI/ML model 132 provides output of keywords, extracted from the user prompts. The AI/ML model 132 infers the important keywords from both semantic information and from the context of the data set(s) used.

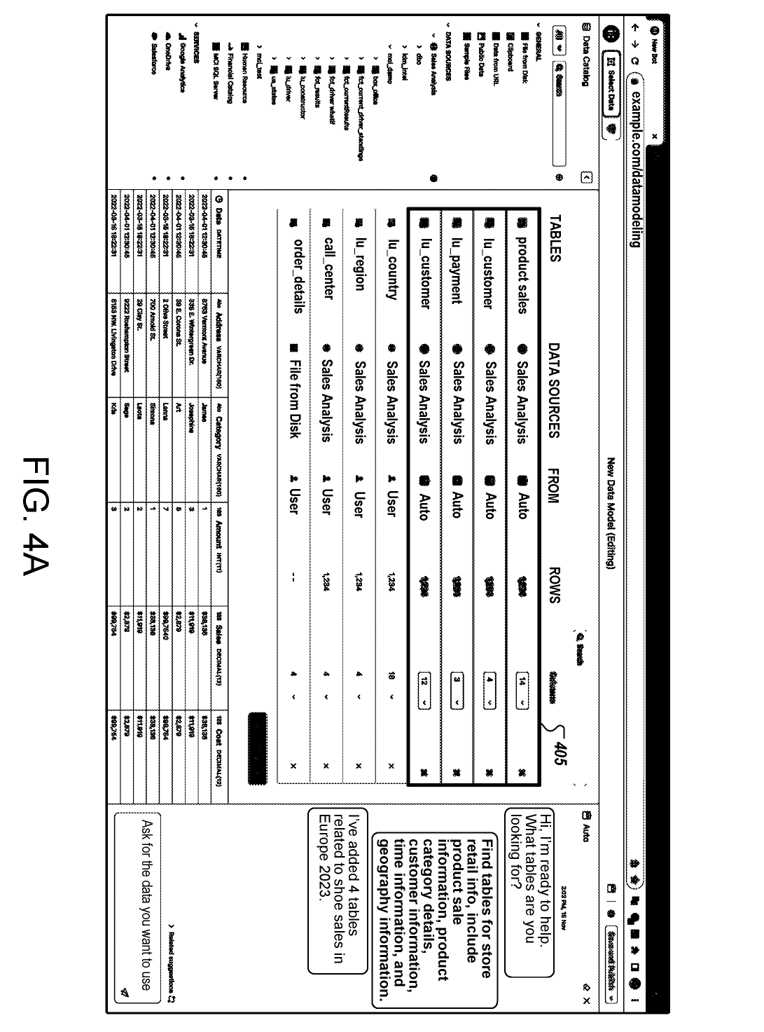

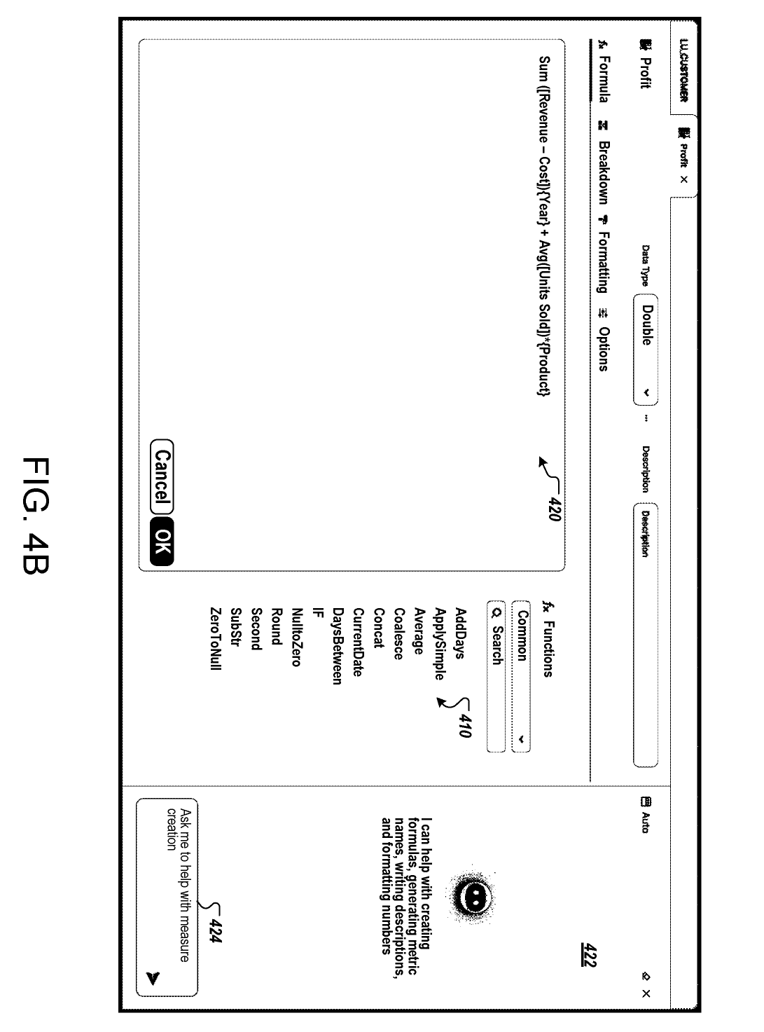

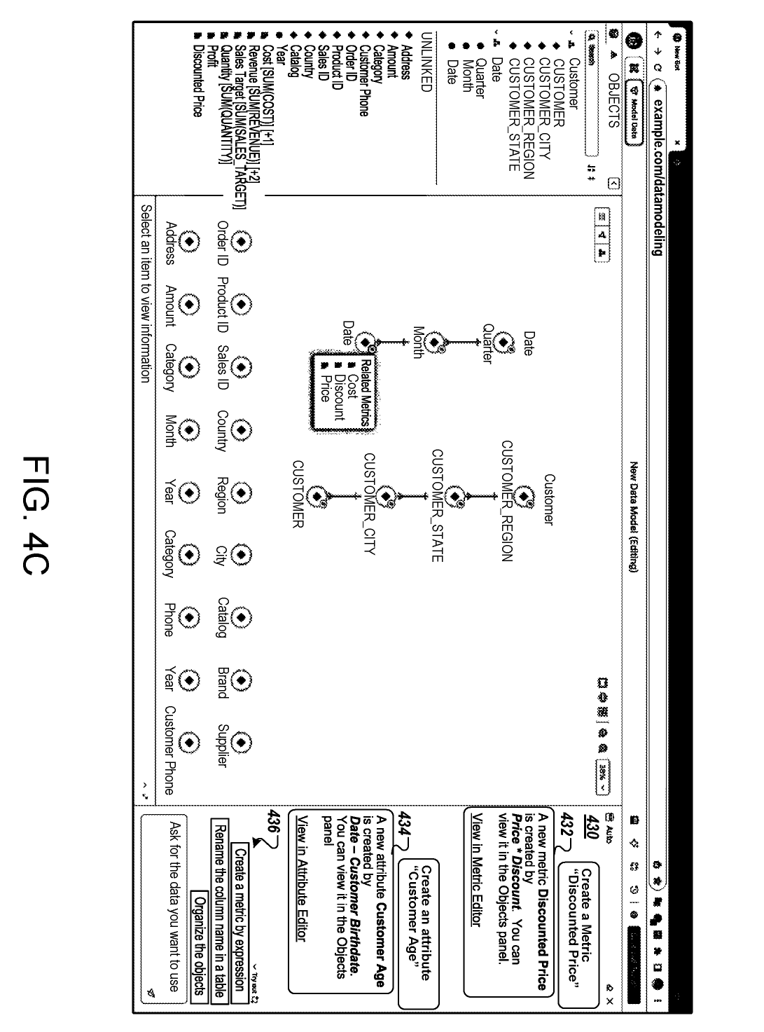

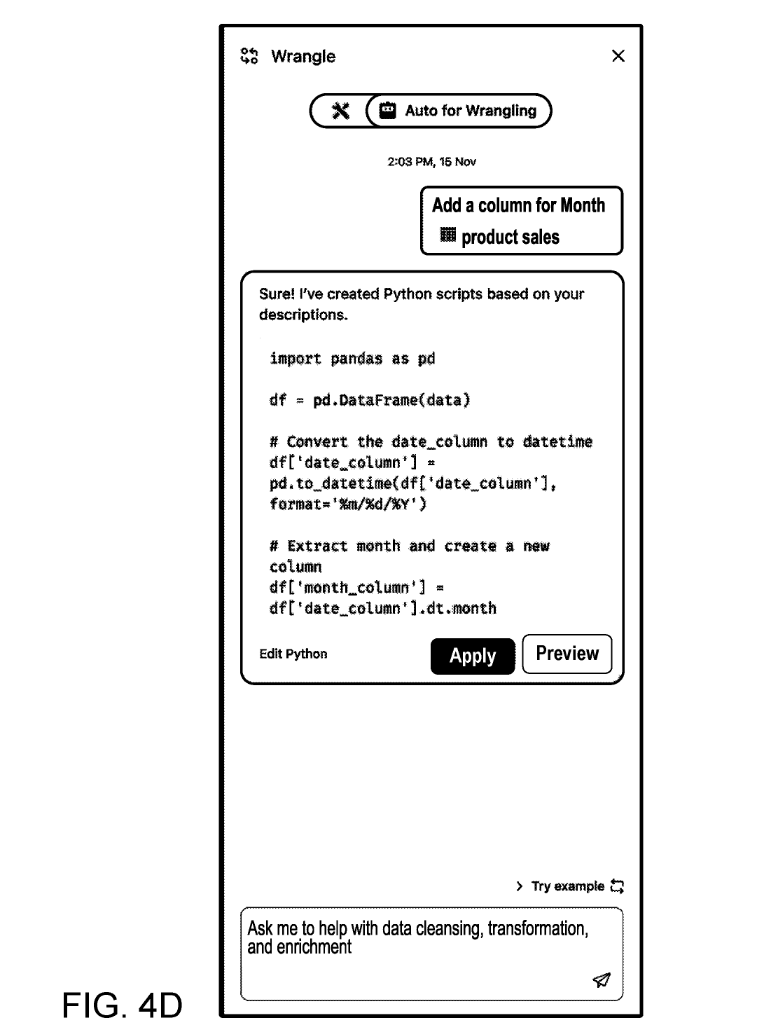

The metric searching 198 involves searching an index or database for functions to be applied in the metric being created. In general, this does not involve an LLM, but instead can include using semantic search techniques, such as searching content of a vector database 150. In some implementations, the computer system 110 has a vector store of function definitions, each representing a different function (see FIG. 4B, listing a few example functions 410). The computer system 110 uses semantic searching, e.g., vector similarity or vector distance searches, to identify the functions that are closest semantically to the extracted keywords. For example, the computer system 110 can generate vector embeddings from the extracted keywords, and compares them with stored vector embeddings for the function definitions of various functions. The function that is closest in the vector space can be selected as the function to use for the new metric.

In some implementations, the computer system 110 additionally or alternatively searches for example metrics, not only the particular function to apply. For example, the computer system 110 can store in a vector database 150 or other vector store vector embeddings for various metrics that have been created for various data sets. The computer system 110 can use vector embeddings for extracted keywords to retrieve the semantically closest example metrics or metric templates, which can provide more detail than a function definition alone. In general, the metric searching 198 can searches the vector store to find closest items matches based on similarity of vectors (and thus concepts) to stored items (e.g., a RAG retrieval step, not involving an LLM). Similarity search can use any of various techniques, such as nearest neighbor search, k-means clustering, proximity graphs, product quantization, etc.

Metric creation 199 involves the computer system 110 sending to the AI/ML model 132 the user prompt, the names of attributes and metrics, and the function definitions and/or metric definitions retrieved using vector similarity. The computer system 110 instructs the AI/ML model 132 to create a metric expression based on the user prompt, using the attributes and metrics available from the data sets. The provided function definitions or metric definitions provide the most like functions or templates that will meet the user’s needs. The AI/ML model 132 outputs a metric expression that references the attributes and metrics of the data sets. The computer system 110 shows the formula to the user (see FIG. 4B) and/or saves it in the data model 156.

The computer system 110 can instruct the AI/ML model 132 to also provide a natural language text description to accompany it. In some implementations, this is performed as a separate interaction with the AI/ML model 132 that provides the metric formula and information about the data sets (e.g., the names and descriptions of the attributes and metrics), and instructs for an explanation to be generated.

In some cases, a user interface for metric creation can be provided, and from the context of this interface, the intent to create a new metric is already known. For example, if a user enters text in a particular field, or in a chatbot field while on a page or tab for creating a metric, the user may simply enter “monthly sales” and the computer system 110 automatically invokes the automatic metric creation, without requiring the user to enter a user prompt that specifically requests metric creation. Similarly, the computer system 110 can provide suggested queries that specify different types of metrics, and user selection of one of the suggested queries (which simply include a type of data such as “West region profit” or “average revenue”) causes the automatic metric creation to be invoked so the metric is created, with a formula and natural language description, and then shown to the user and/or saved in the data model 156.

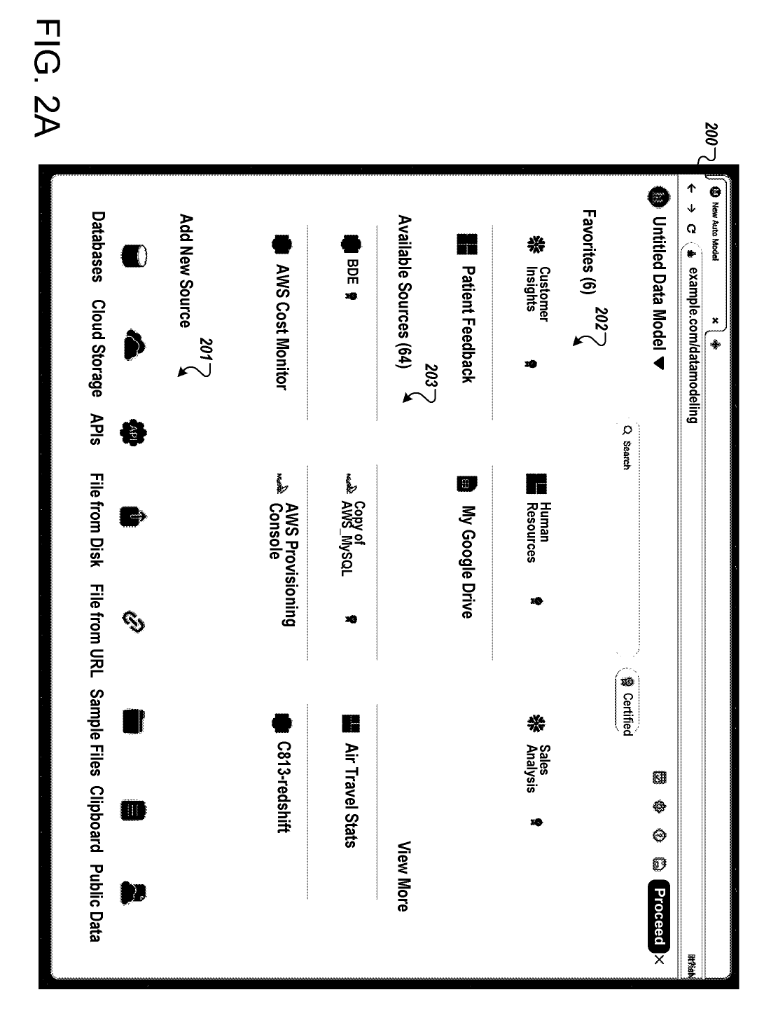

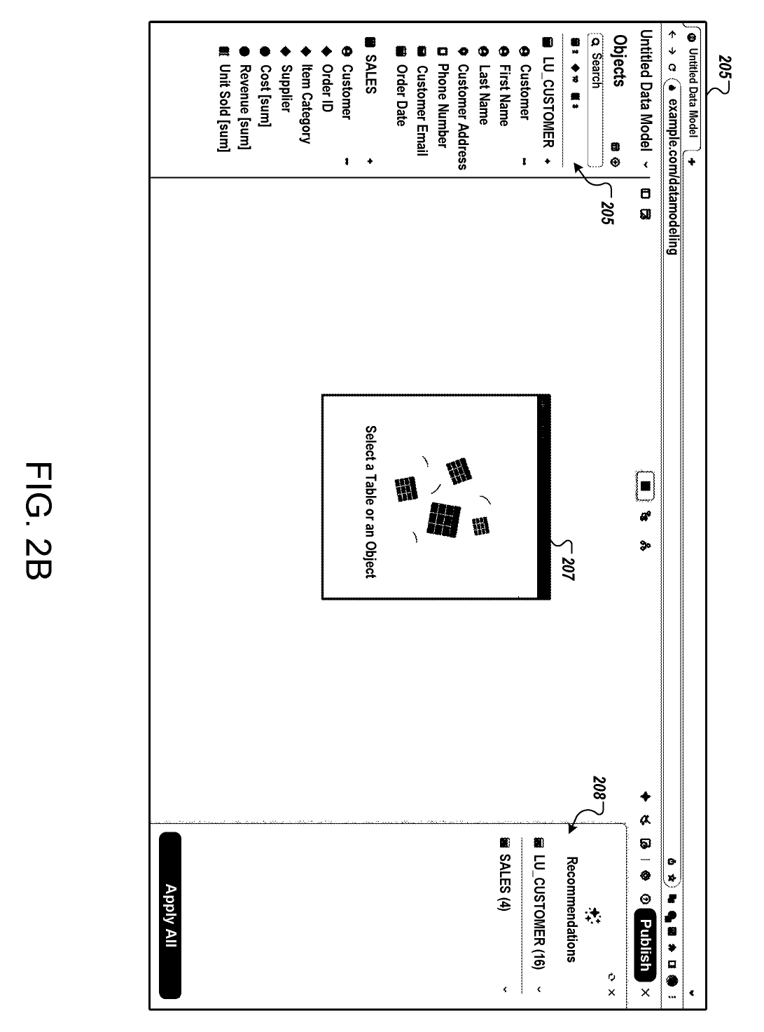

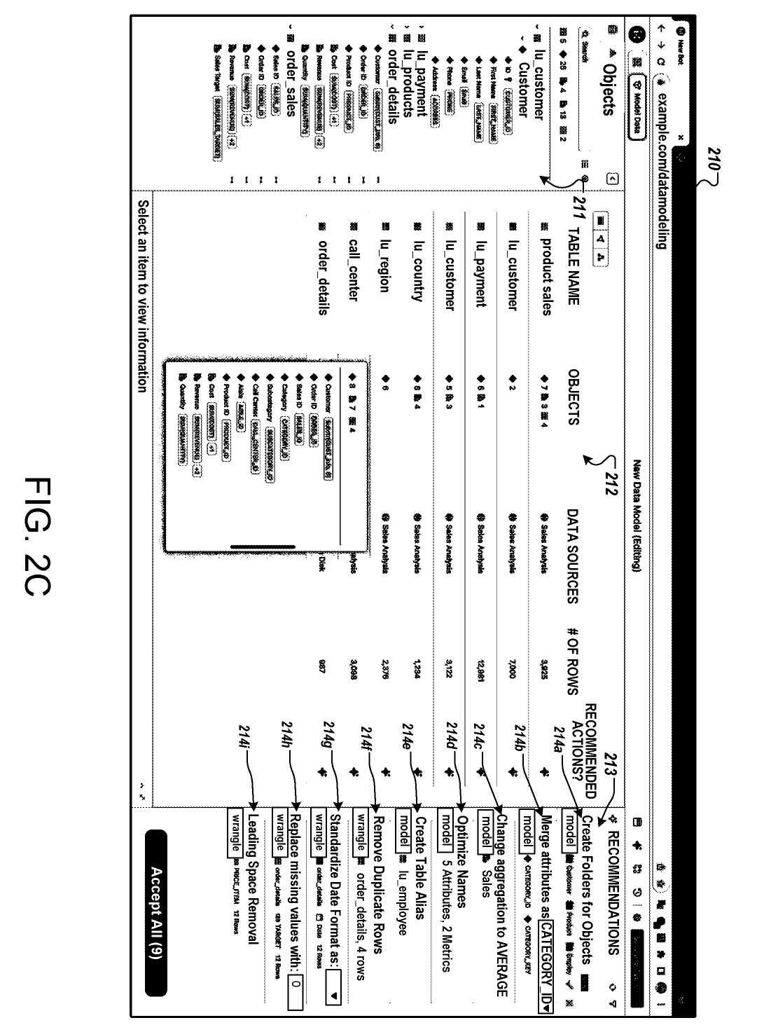

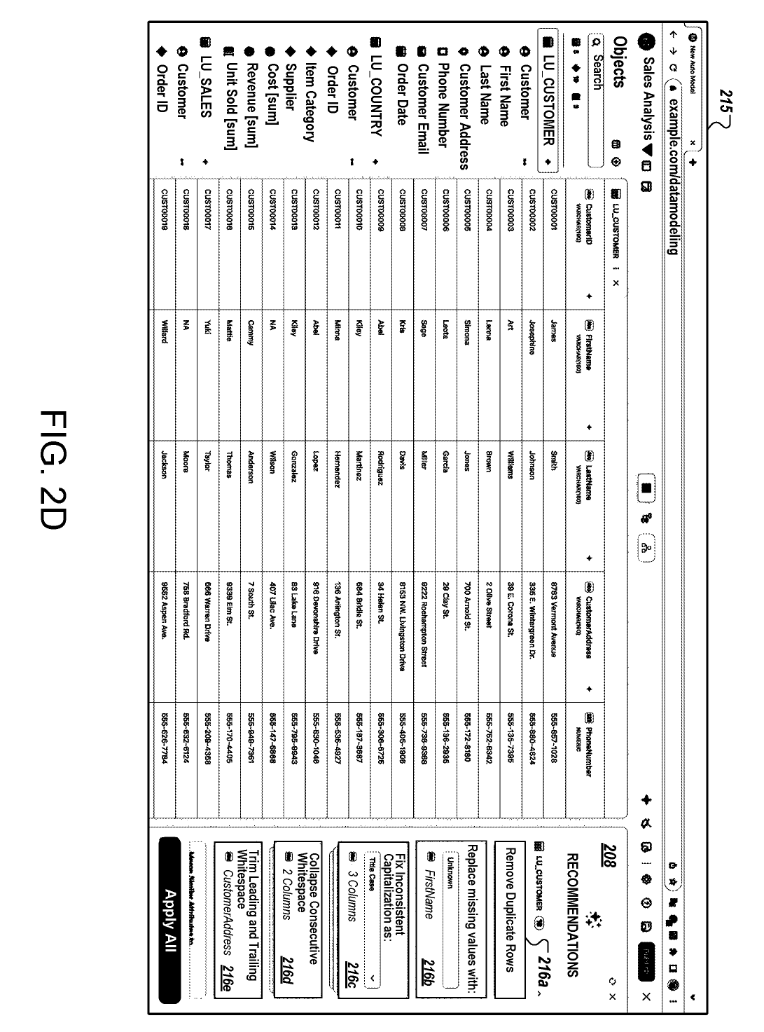

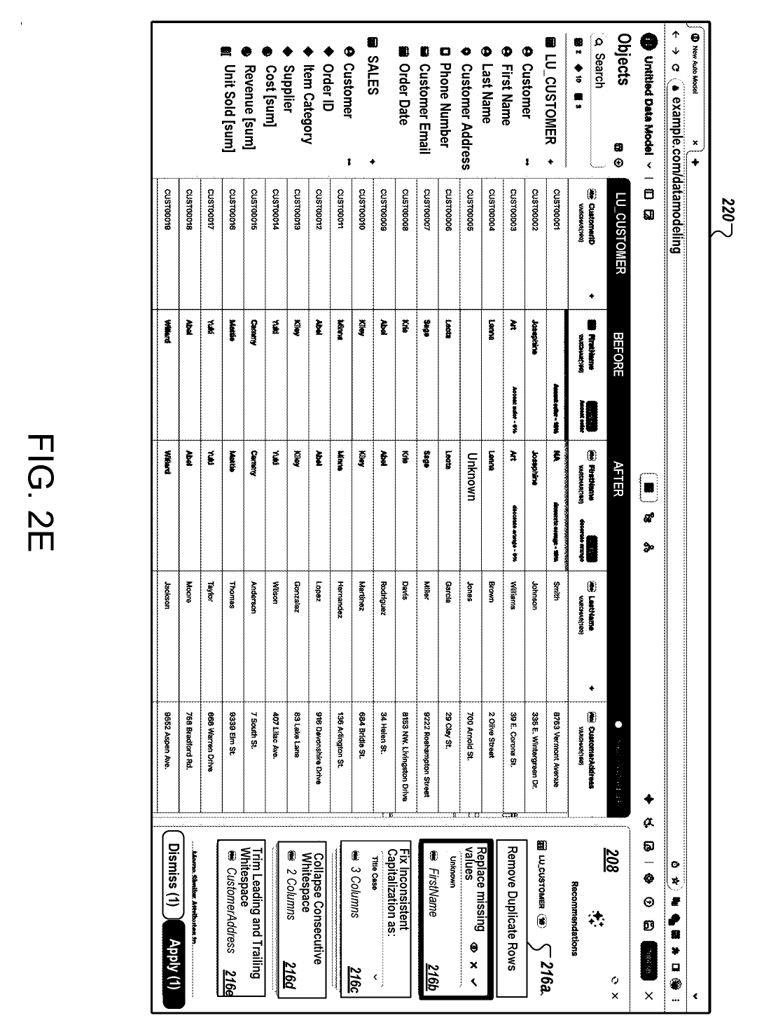

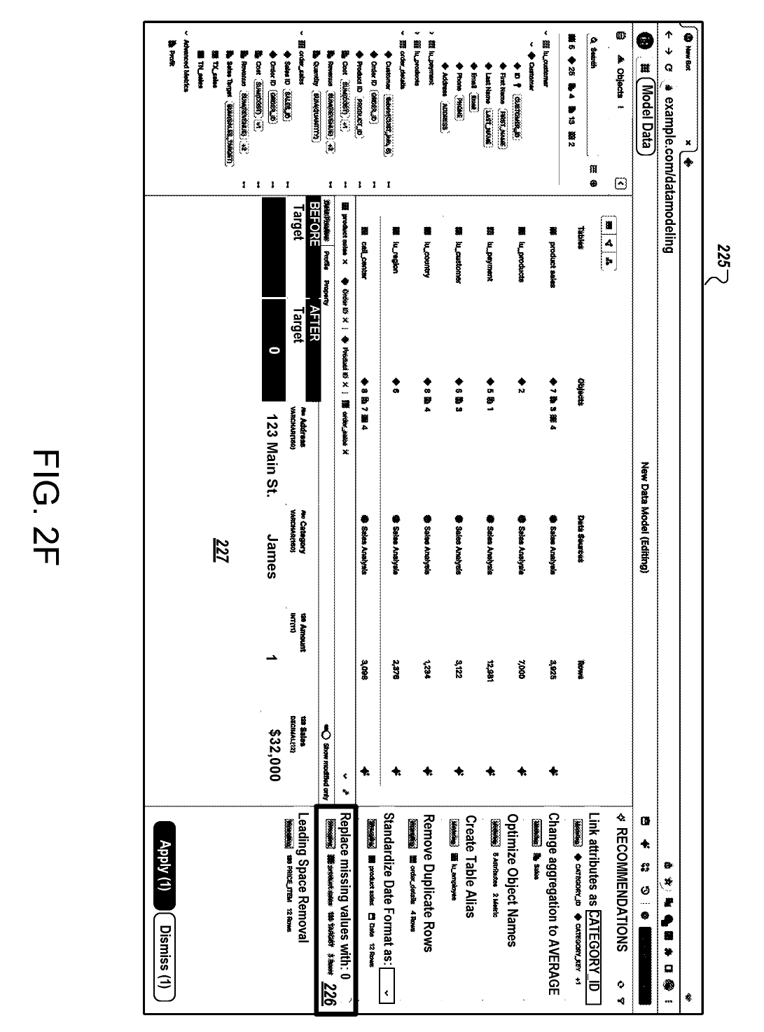

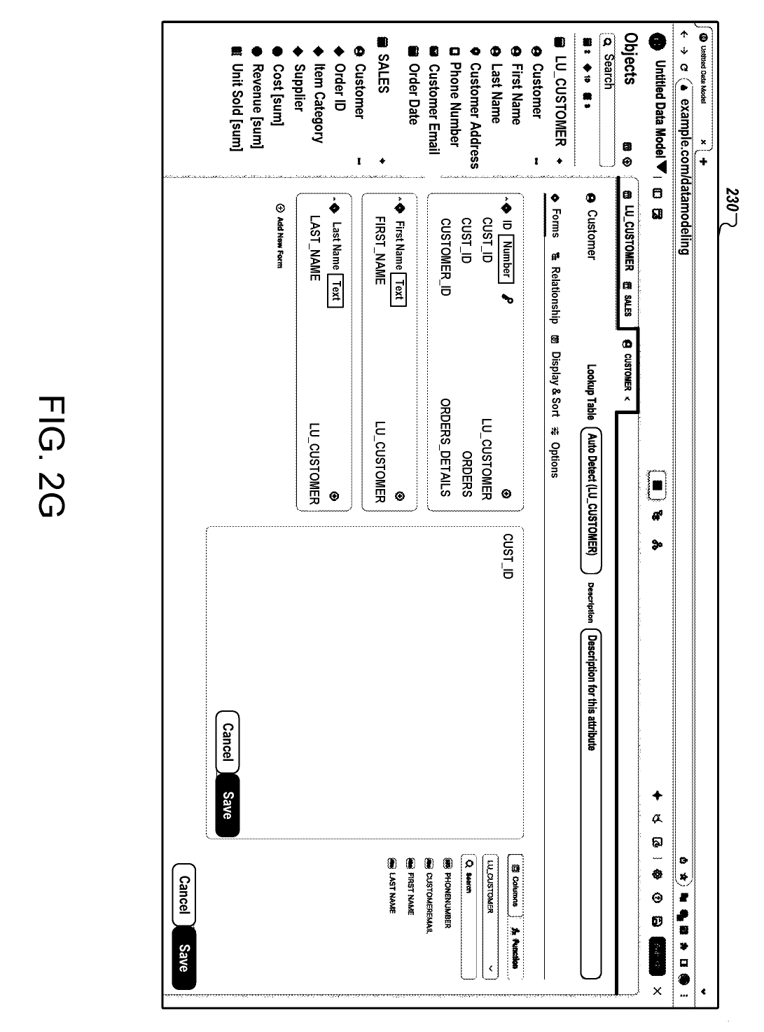

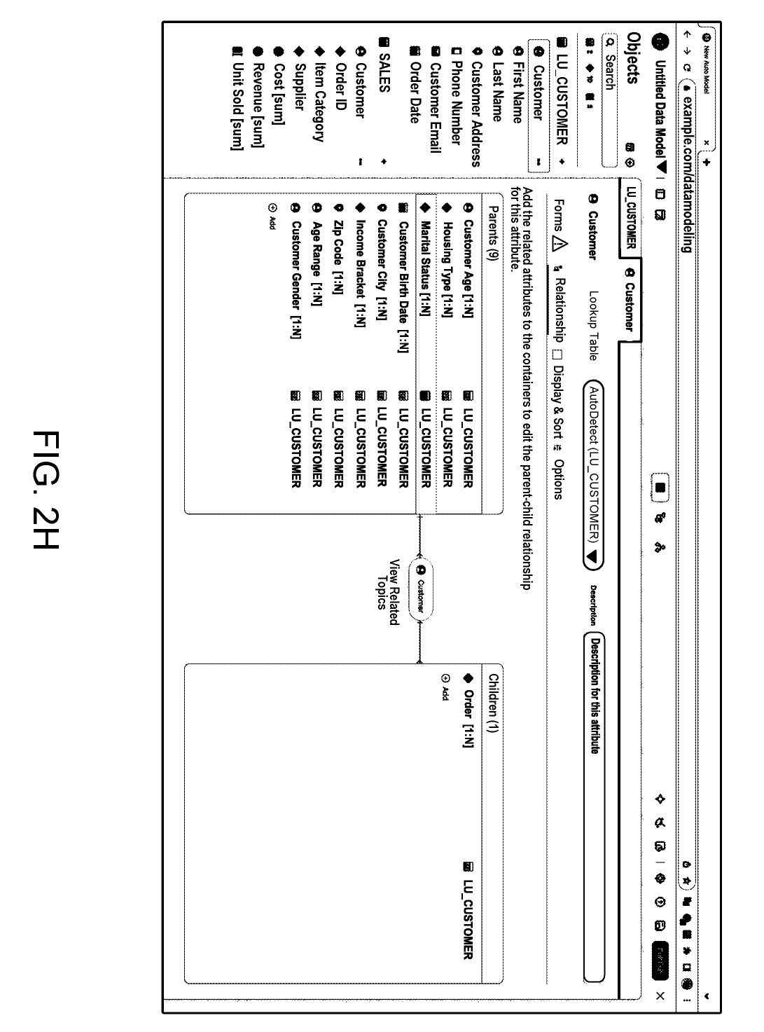

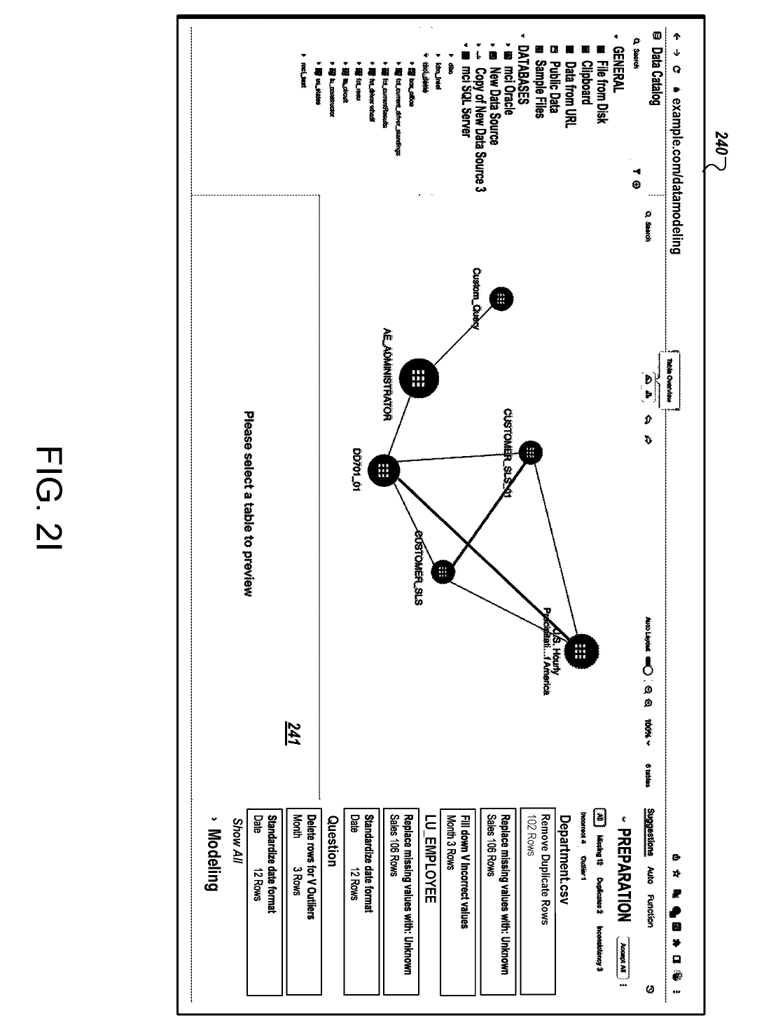

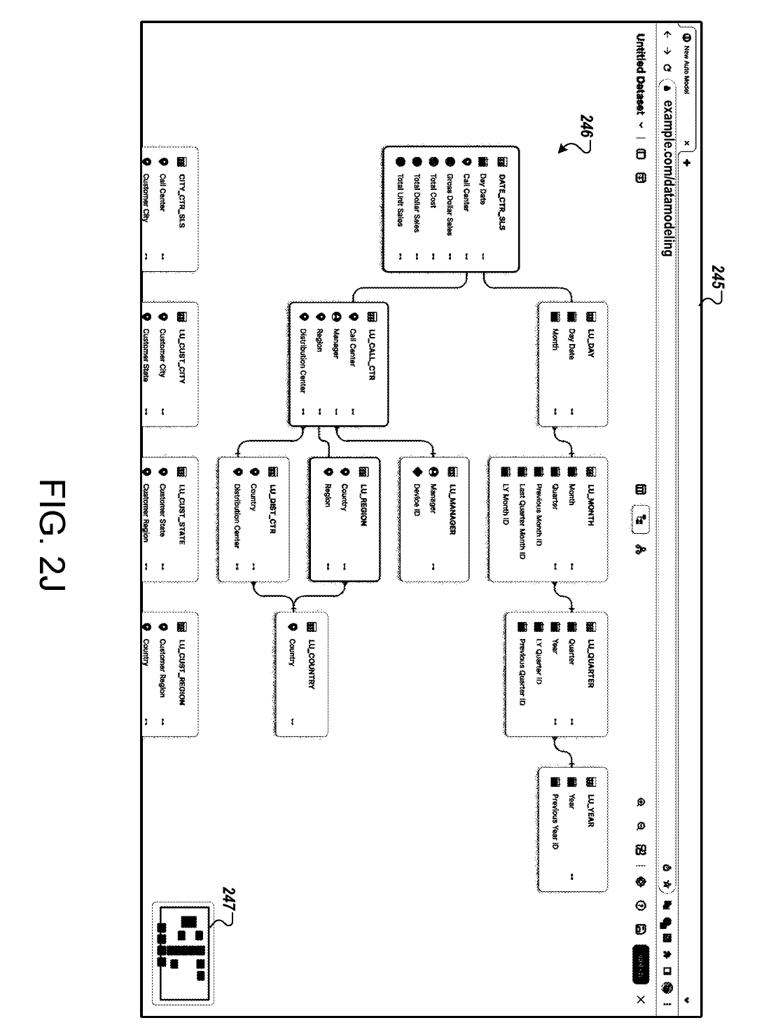

FIGS. 2A-2K are diagrams showing examples of user interfaces for data modeling and data adjustment using artificial intelligence or machine learning. The user interfaces in the examples are shown in a web browser of a client device of a user, such as a web browser of the user device 106 of the user 105. The computer system 110 sends data over the network 108, including recommended actions for data modeling and data adjustment, for presentation in the user interfaces. In some implementations, the data modeling interface can be provided as a web page, a web application, content of a native application executing on a client device, and so on.

The computer system 110 can also use the techniques described in U.S. Patent Application No. 19/193,394, filed on April 29, 2025, which is incorporated by reference herein, to create data models, enrich data, cleanse data, and perform other operations.

FIG. 2A shows a user interface 200 for selecting data sources to describe in a data model. The user interface 200 can be shown in a process or interface for creating or editing a data model. The user interface 200 allows a user to select from many different sources 201, such as databases, cloud storage, data available from application programming interfaces (APIs), files from disk, files from a URL (e.g., accessed over a network), samples files, data from the clipboard, or public data. Other data sources that are frequently or recently used by the user or the user’s organization can be shown also, e.g., data sources 202 showing databases or data sets Customer Insights, Human Resources, Sales Analysis, Patient Feedback, or Google Drive. Similarly, other available data sources 203 known to the system include spreadsheets, a MySQL database, data sets available from cloud computing sources such as Amazon Web Services (AWS), and so on.

The system can be configured so that, in response to the user selecting one or more data sets or data sources, the computer system 110 begins to analyze the selected data and characteristics of the data (e.g., columns, labels, data object relationships, etc.) to identify, assess, and generate code for data modeling actions or data adjustments (e.g., data cleansing, data wrangling, data enrichment, etc.).

FIG. 2B is a diagram showing another user interface 205 for selecting data sources for a data model. The user interface 205 shows a state after a user has selected two databases, labeled LU_CUSTOMER and SALES, to be described in the data model. The user interface 205 shows an object region 206 showing the data objects (e.g., attributes, metrics, facts, etc.) identified from the data sources. The user interface 205 includes a central region 207 that includes one or more interactive controls for a user to select additional data sources or data sets. The central region 207 can include a drop target for a user to drag and drop items (e.g., files, links, references, etc.) to add them to the data model being created or edited.

The user interface 205 includes a recommendation area 208 that shows set of recommendations that the computer system 110 determined using output of the AI/ML models 132. The recommendations are shown grouped according to the data source or data set that they correspond to, and in the current view, are collapsed to show the total number for each data source. For example, there are 16 recommended data modeling or data adjustment actions for the LU_CUSTOMER database or table, and 4 recommended data modeling or data adjustment actions for the SALES database or table. The recommendation area can include one or more interactive controls, such as buttons or selection controls, that enable a user to accept or apply recommended actions as a group, in subgroups, or individually. In some implementations, the recommendation area 208 can include what are more controls to dismiss or ignore recommended actions. In addition, the recommendation area 208 can include a control to initiate analysis to refresh or obtain new recommended actions. The recommendation area 208 can be provided as a panel or pane of the user interface, and the recommendation area 208 can be hidden or displayed based on interactions of the user (e.g., buttons or icons that trigger the recommendation area 208 to be shown or hidden).

FIG. 2C is another example user interface 210 for creating or editing a data model. The user interface 210 shows a workspace where the user 105 can view characteristics of the data set(s) selected and the data objects and relationships of the data model. The user interface 210 shows an object region 211 that shows a hierarchy of different data sources or data sets, and the different data objects (e.g., attributes, attribute forms, metrics, facts, etc.) that have been identified or defined in the data model for the data. In this example, there are various different tables, labeled lu_customer, lu_payment, lu_products, order_details, order_sales, and so on. Each of these items can be expanded to show data objects that are included in or are derived from the corresponding table. For example, the lu_customer table has an attribute form labeled “Customer,” and there are several grouped attributes (e.g., ID, First Name, Last Name, Email, Phone, and Address) that are grouped together in the attribute form. Each data object can be represented with, for example, an icon indicating the type of data object, a label (e.g., a natural language or human-readable name), and an identifier (e.g., a column name or identifier in the table).

The user interface 210 includes a central region 212 that shows additional information about a portion of the data set or data model that the user 105 has selected to view or edit. In this case, the central region 212 shows information about various tables being described in the data model, including columns that respectively indicate the table names, number and type of objects (e.g., number of attributes, number of metrics, etc.), the data sources the tables were obtained from, the number of rows in each table, and an icon indicating whether there are recommended actions for the table. The elements in the central region 212 are interactive to bring up for display more detailed information. In the example, the user 105 has clicked or hovered over an element for the object types for the call_center table, which triggers display of a detail pane listing, for example, the 8 attributes and 7 metrics that are defined or available for that table.

The user interface 210 includes a recommendation area 213 that shows a set of recommended actions for data modeling and data adjustment that the computer system 110 has determined. As discussed above, the computer system 110 can automatically select and recommend changes to a data set (e.g., for data wrangling, data cleansing, data enrichment, etc.) and/or to a data model. The computer system 110 can initiate the processing to identify, assess, and implement these changes automatically and in the background, without requiring the user to request changes or recommendations. In some implementations, an icon or symbol is shown when recommended actions are available, and the user 105 can interact with the icon to cause the recommendation area 213 to be displayed.

The recommendation area 213 shows various different proposed changes to the data model or the corresponding data set(s). Each recommendation item includes a brief statement of the type of change to be made, an indication of the data objects that would be affected, a category of the change (e.g., data modeling or data wrangling). In some cases, the recommendation item includes one or more interactive items, such a text field or drop-down box, so a user can enter or select parameters for making a change.

The first recommended item 214a is to create folders for objects, and the item lists objects (e.g., Customer, Product, Employee) for which folder creation is recommended. The recommended item also includes a check symbol that the user 105 can interact with to apply that specific change, or an “x” symbol that the user 105 can interact with to dismiss the recommendation. The computer system 110 can identify that this proposed change is appropriate based on policies or knowledge base data that specify best practices for folder structure. This information can be provided to the AI/ML models 132 with a request to identify and/or assess potential changes, and the AI/ML models 132 can indicate that changes would be needed for the folder structure to align with the standards or policies provided to the AI/ML models 132.

The second recommended item 214b is to merge multiple attributes as a specific attribute or attribute form. Here, the computer system 110 has provided information to the AI/ML models 132 describing the data objects available, and the AI/ML models 132 generated output indicating that the attribute CATEGORY_ID and CATEGORY_KEY appear to include same or similar type of data, or serve a similar function, and so should be merged. The computer system 110 can additionally perform a statistical analysis of the values for the two columns, to determine whether there are shared values, a shared data format, a shared data type, and so on. The computer system 110 can use this information to validate and assess the appropriateness of the recommendation from the AI/ML models 132. As another example, the computer system 110 can provide the statistical analysis results as input to the AI/ML models 132, which the AI/ML models 132 can use to more accurately generate its indication of changes to be made.

The third recommended item 214c is to change the aggregation function used for a particular metric, labeled “Sales,” to average. The computer system 110 can support various different types of aggregation, such as maximum, minimum, average, and so on. The computer system 110 can provide information describing these functions and circumstances for which the different functions are best suited in input to the AI/ML models 132. In addition, the computer system 110 can provide the AI/ML models 132 information about historical recommendations that were accepted by users and/or data models that were created and the aggregation functions selected for different types of data objects. With this information, the AI/ML models 132 can apply the historical data to determine which aggregation function would be appropriate for a particular data object, taking into account the data format or data type and the semantic meaning of the data indicated by the labels and context. Similarly, the computer system 110 can identify metrics that do not have an aggregation function specified and can select, based on rules and policies and/or output of the AI/ML models 132, which aggregation function should be used. In the recommendation item, the aggregation function can be shown as a drop-down box having a list of aggregation functions, so the user can change the aggregation function to a different option if desired.

The fourth recommended item 214d is to optimize names of various attributes and metrics. The recommended item indicates that there are 5 attributes and two metrics that are proposed to be changed. For example, this can include providing a plain language or human readable name or label instead of a column identifier from the data set. The AI/ML models 132 can identify when an appropriate name or label is missing and then generate names from the information about the data set that is provided to the AI/ML models 132. For example, metadata and description information for data sets can be provided to the AI/ML models 132, along with historical data or statistical data indicating other datasets, their data objects, and the appropriate titles or labels for their data objects. The AI/ML models 132 can use the previous records, along with any rules or policies provided by the computer system 110, to infer appropriate names for data objects.

The fifth recommended item 214e is to create a table alias for a particular table, e.g., lu_employee. For example, this item 214e can be a name or label for a table, inferred by the AI/ML models 132 in a similar manner that names or labels are inferred for other data objects.

The sixth recommended item 214f is to remove duplicate rows in the table labeled order_details. The computer system 110 can provide information that describes conditions or data characteristics for the AI/ML models 132 to detect and identify. The presence of duplicate rows can be one of those conditions or characteristics. In some implementations, the computer system 110 can itself apply rules and policies to detect conditions such as duplicate rows, and can then specify a change to remove the duplicates as a recommended item. In the example, the recommended item 214 F shows the name of the affected table as well as the number of rows identified as duplicates to be removed (e.g., 4 rows).

The seventh recommended item 214g is a recommendation to standardize the date format used in a date attribute of the order details table. The recommended item 214g indicates that 12 rows have values that would be updated by this action. The computer system 110 can detect the need for standardization based on its own analysis and processing of the data sets identified for this data model. As another example, the computer system can generate statistical information and characterization data describing the formatting and types of data in the data set, and can provide that information to the AI ML models 132, so the AI/ML models 132 identify and infer the need for standardization and the type of standardization to perform. In general it is not efficient or desirable for the AI/ML models to access large amounts of underlying data. As a result, it is more efficient and preserves the privacy of the customers data if the computer system 110 analyzes the data and provides statistics or characteristics to the AI/ML models 132, without the need to reveal the actual data content to the AI/ML models 132 and without the need to transfer data sets to the AI/ML service provider 130 over the network 108.

The eighth recommended item 214h is to fill in empty fields for a data object, labeled “target,” in the order_details table. The recommended item 214hindicates that 12 rows are affected and have missing values for the “target” data object. The recommended item 214hhas a text field where the user 105 can view and edit the value to be populated in the empty fields. The computer system 110 can apply rules and policies to determine when information is missing for data object and what the replacement data should be. The computer system 110 can also provide information to the AI/ML models 132 and leverage the AI/ML models 132 to identify or infer which values should be populated in empty fields. For this information, the computer system 110 can provide the AI/ML model records of previous contexts in which empty fields were identified and filled, along with metadata and data object characteristics the assist the AI/ML models 132 to accurately determine appropriate changes.

The ninth recommended item 214i is to remove leading whitespace from values of a particular data objects labeled PRICE_ITEM. As with other data wrangling and data cleansing operations, the computer system 110 can analyze the data set to identify conditions, such as leading or trailing white space, and then apply rules or policies to surface corrective actions as recommended items. In addition, the computer system 110 can use the A/ML models to confirm or assess the appropriateness of the changes, based on the characteristics and statistics that the computer system 110 generates.

For any and all of the recommended items 214a-214i shown in the recommendation area 213, or for other recommendations, the processing to generate the recommendations and/or to carry out the recommended actions can be performed as combination of processing of the computer system 110 and processing of AI/ML models 132. As discussed above, the AI/ML models 132 can be used in many instances to identify when a change or other action is appropriate. In other cases, the computer system 110 may be able to more directly identify when a certain type of change is appropriate, such as for missing values or non-standard data formats. For all of these cases, however, the computer system 110 can leverage the AI/ML models 132 to generate interpretable or executable code to carry out the recommended action. For example, even if the computer system 110 can determine by its own processing that missing values are present in a data set, the computer system 110 may still interact with the AI/ML models 132 to select appropriate value(s) to fill in those empty fields, and the determination may be made row by row based on other context, as a group (so all empty fields are populated with the same new value), or in another manner. In addition, the computer system 110 can instruct the A/ML models 132 to generate code for a function that will find and fill empty fields with the appropriate values.

FIG. 2D is another example of a user interface 215 that shows another example of recommended actions for data modeling or data preparation. The example shows the recommendation area 208 from FIG. 2B, but with the set of recommendations for the LU_CUSTOMER table expanded to show individual items. This view shows a recommendation 216ato remove duplicate rows, a recommendation 216b to replace missing values in the FirstName column with a particular value (e.g., “Unknown”), a recommendation 216cto fix inconsistent capitalization to title case for three columns, a recommendation 216d to collapse consecutive whitespace for two columns, and a recommendation 216e to trim leading and trailing whitespace for values in the CustomerAddress attribute. Other recommendations for the table are not shown but can be accessed by scrolling the recommendation area 208.

Alongside the recommendations, the user interface 215 also shows a view of data from the table, which provides context for the recommendations. In some implementations, selecting one of the recommendations 216a-216ecauses the user interface 215 to show a preview area or a more detailed overlay providing more information about the recommended change and slash or the effects on the data model or data sets.

FIG. 2E shows another example user interface 220 showing the result of these are one of five interacting with a specific recommendation 216b. This causes the user interface to 20 to be updated in a few ways. First, compared to the user interface 215 in FIG. 2D, the center portion of the user interface 220 now shows a before and after comparison for the first name column, showing how an empty field would be replaced with a value. The controls at the bottom of the recommendation area 208 are also updated, so the user can apply or dismiss the specific selected recommendation 216b individually. The user interface presentation of the recommendation 216b is also updated to include controls for the user to dismiss (an “x” icon) or accept (a check icon) the recommendation. Other controls can be provided, such as to view the generated code or other operations that would be performed by accepting the recommendation 216b.

FIG. 2F is an example user interface 225 showing that when the user 105 selects a particular recommendation 226, a preview area 227 can be updated to show the results of the recommended change. In this case, a setting is applied to limit the preview to modified records only, which helps make isolate the changes that will occur. In this case, the selected recommendation 226 is a change to replace missing values of the ”target” data object with the value zero.

FIG. 2G is an example user interface 230 showing a visualization of a customer attribute form, and the grouping of different related attributes in it. For example, an attribute labeled “ID” is formed by merging three different attributes, the attribute CUST_ID from the table LU_CUSTOMER, attribute CUST_ID from the table ORDERS, and the attribute CUSTOMER_ID from the table ORDERS_DETAILS. Other attributes in the attribute form include a First Name and Last Name. The user interface 230 provides the user 105 controls to edit the attribute form and relationships, including to merge or separate data from different sources. The information shown can also be used to illustrate a recommended change to the user 105, which the user 105 can then choose to accept or reject.

FIG. 2H is an example user interface 235 showing another view of the Customer attribute form in relation to other data objects. For example, the interface 235 shows parent data objects for the Customer attribute form and child data objects for the Customer attribute form. The relationships are specified as either one-to-one (1:1) or one-to-many (1:N). In many cases, the computer system 110 automatically determines proposed relationships among data objects. For example, the relationship of attributes as a parent or child to another attribute, and whether the relationship is one-to-one or not, can be inferred by the computer system 110 which may rely on output of the AI/ML models 132. The computer system 110 can provide the AI/ML models 132 examples of collections of data set characteristics and resulting relationships, as well as criteria for forming relationships among data objects, to guide the AI/ML models 132 in determining relationships to propose to include in a data model.

FIG. 2I is an example user interface 240 showing an example of relationships among various tables. The example shows tables as nodes or icons, with lines between them showing the presence of relationships among the tables. The tables are selectable, and when selected the user interface 240 populates a preview area 241 with data for the selected table. Similarly, the lines or connections between tables are selectable to trigger display of information providing more detail about the type of connection that is present, as well as to allow editing by the user 105 and for the user to accept or dismiss any recommendations the computer system 110 makes for the connection.

FIG. 2J is an example user interface 245 showing connections among tables, but with the table elements represented with larger units showing the data objects contained within. The connections can be determined using the table relationship analysis 180 discussed in FIG. 1G.

FIG. 2K is an example user interface 250 showing a view in which the computer system 110 has identified an inconsistent attribute relationship, and proposes a change to correct the relationship. The system specifies that the current relationship in the data model does not align with the underlying relationship in the data, and recommends to change the relationship to “one-to-many.” For example, the computer system 110 can use information from the table relationship analysis 180 to compare to the current content of the data model 156, and differences from what the table relationship analysis determines can be listed as recommendations or noted as errors to be corrected, as shown in FIG. 2K.

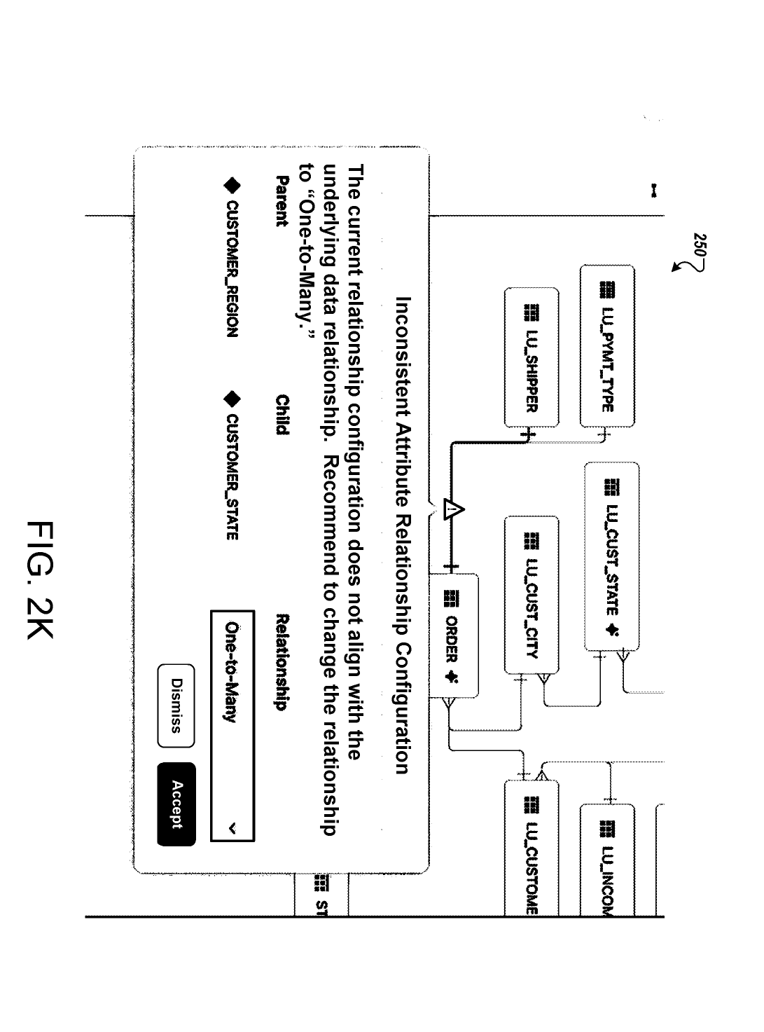

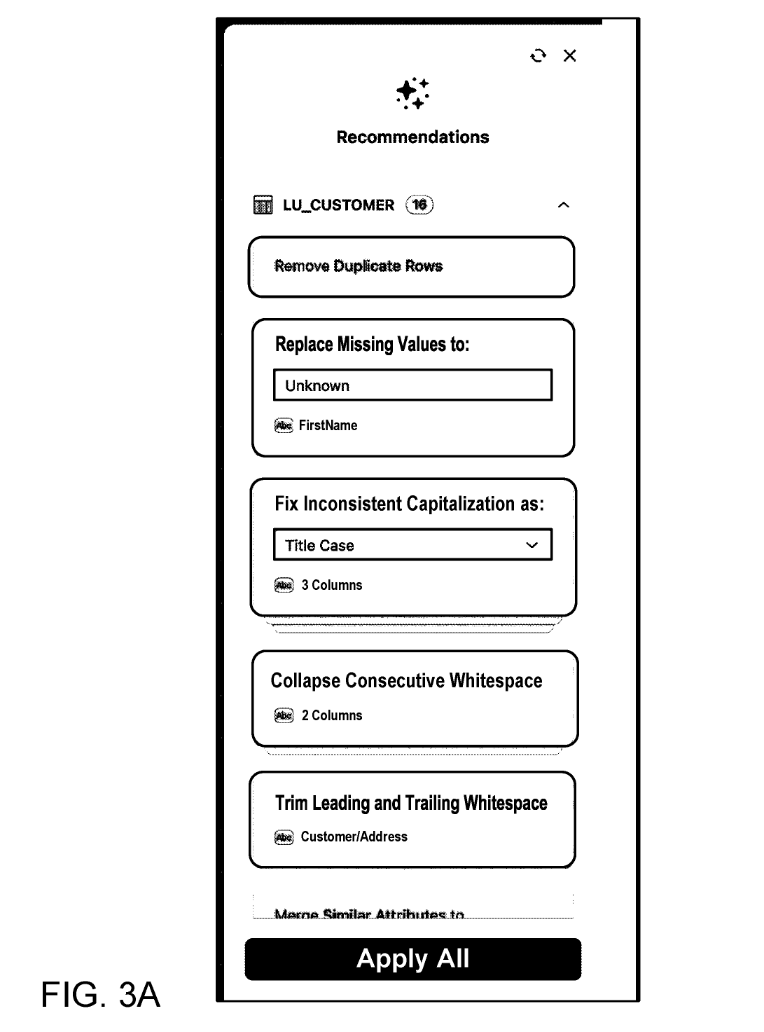

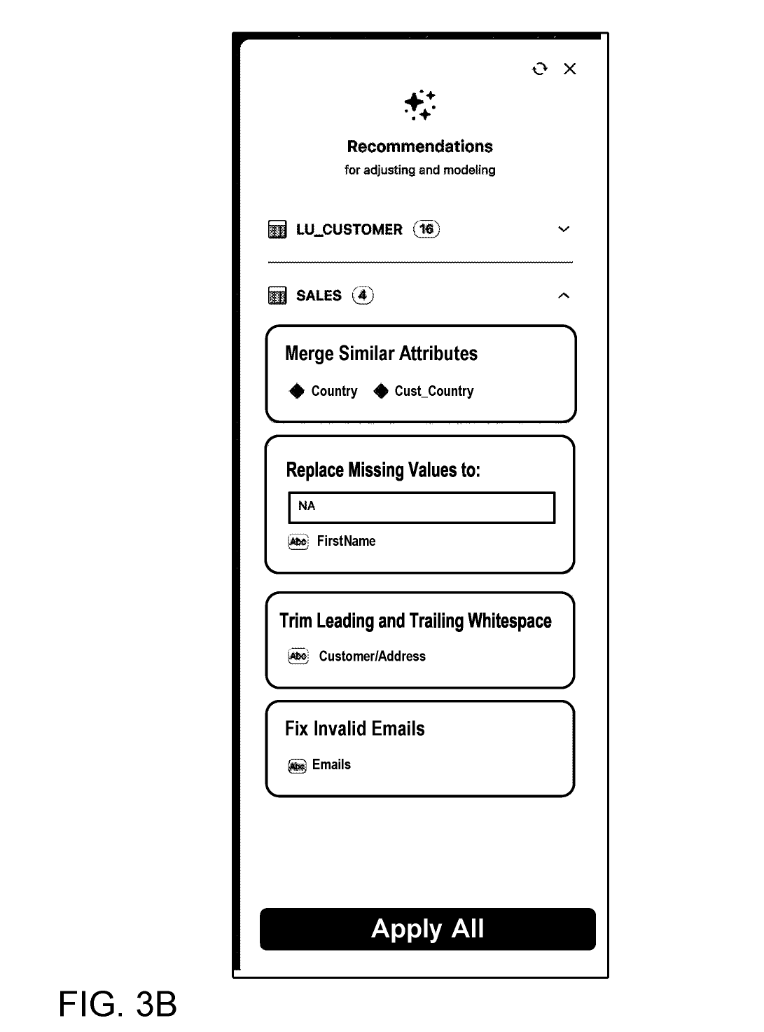

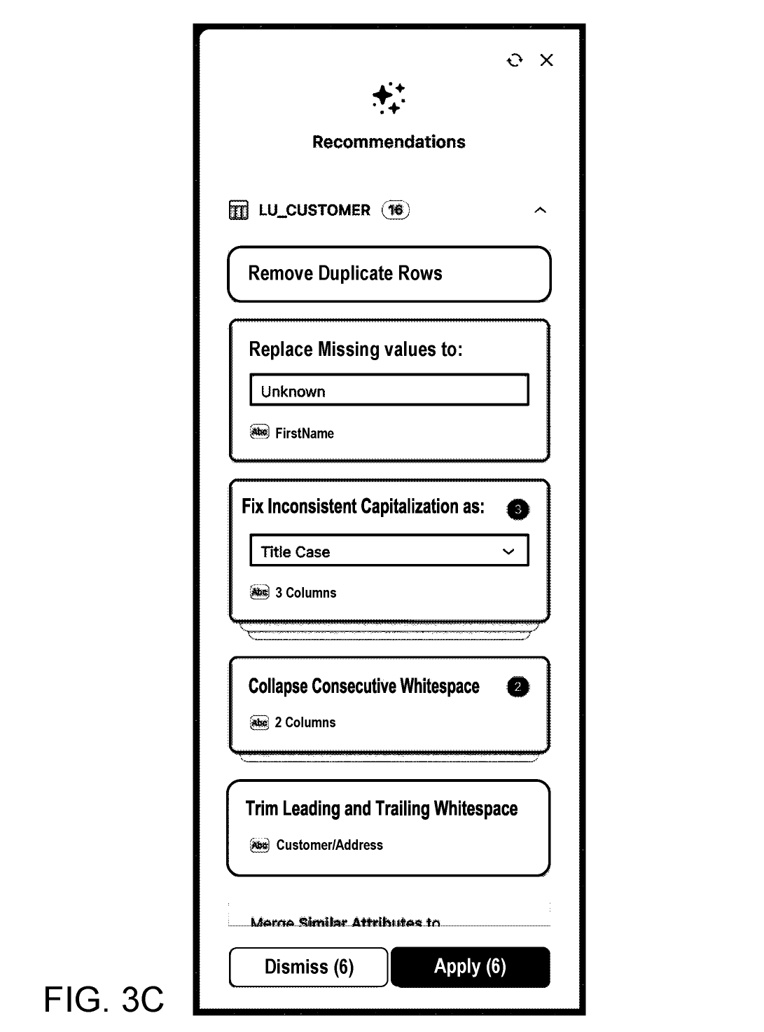

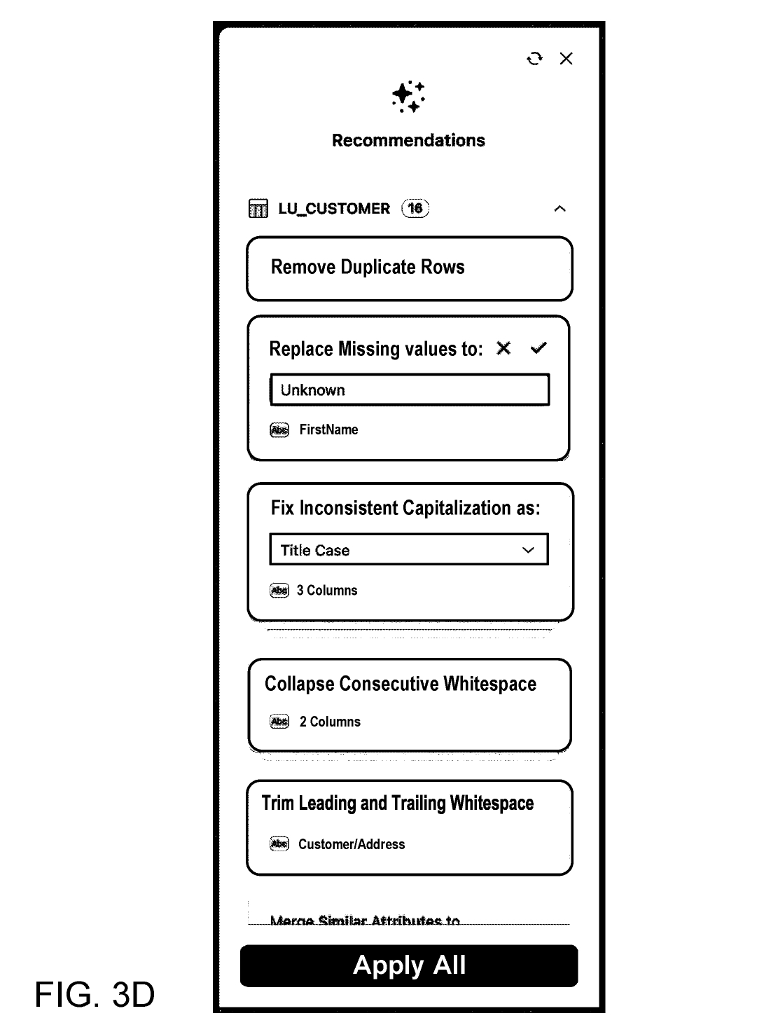

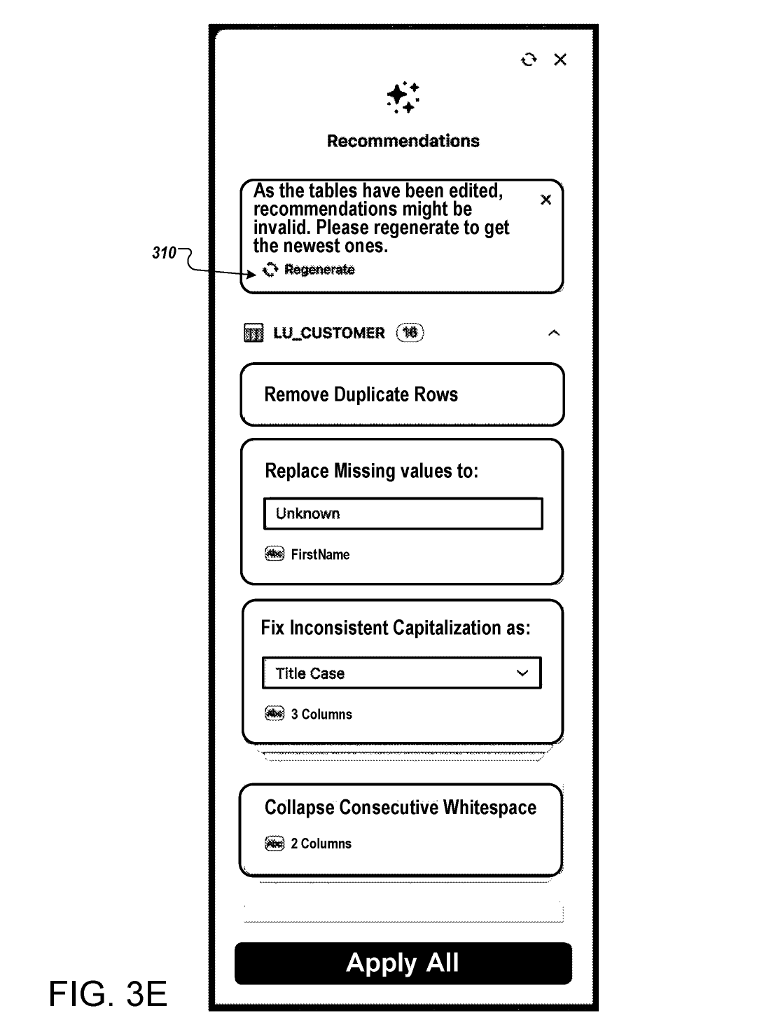

FIG. 3A-3E are diagrams showing examples of user interfaces that indicate automated recommendations for data modeling and data adjustment determined using artificial intelligence or machine learning. For example, the user interfaces show how recommendation areas can be adjusted to allow users to select individual recommendations to apply or dismiss (FIG. 3D, showing an x or checkmark to dismiss or apply a single recommendation), or select groups of recommendations to apply or dismiss (FIG. 3C), or to apply or dismiss all recommendations (FIG. 3A, 3B) (for a single table or all tables). FIG. 3E shows a control 310 that a user can use to regenerate recommendations. This option can be presented when tables have been edited or tables or data sources have been added or removed from the data model.

FIG. 4A-4D are diagrams showing examples of user interfaces that indicate actions for data modeling and data adjustment determined performed using interactions with a chatbot based on artificial intelligence or machine learning.

FIG. 4A shows a conversation in which a chatbot interface assists the user in data discovery. The user asks for tables with certain information to be added, “Find tables for store retail info, include product sale information, product category details, customer information, time information, and geography information.” The computer system 110 uses semantic searching, e.g., vector similarity searching, to find tables or other data sources accessible to the user that have data objects (e.g., attributes or metrics) that are relevant to the items the user specified. The tables that are found to have data objects corresponding to those user-specified terms (e.g., found tables 405) are integrated so they will be described in the data model and relationships will be determined with respect to other tables.

FIG. 4B shows a interface for creating or editing metrics. An interface region 420 shows the formula for a metric called “Profit.” Common functions 410 that the user can select are also shown. The interface includes a chatbot interface 422 including a text entry field 424 for providing instructions or requests to the data modeling assistant chatbot.

FIG. 4C shows a chatbot interface 430 where the chatbot assists the user with various actions, including creating a metric 432 and creating an attribute 434. The techniques of FIG. 1J (metric creation) can be invoked to perform these actions. The same techniques can also be used to create attributes on behalf of a user. Suggested queries 436 show other prompts the user can select, representing additional actions the chatbot can perform.

FIG. 4D shows the capability of the chatbot interface to generate code or instructions that implement a user’s request. In the example, the user request to add a column for month to the table names “product sales.” The computer system 110 uses the AI/ML models to generate Python code that will create the column as requested.

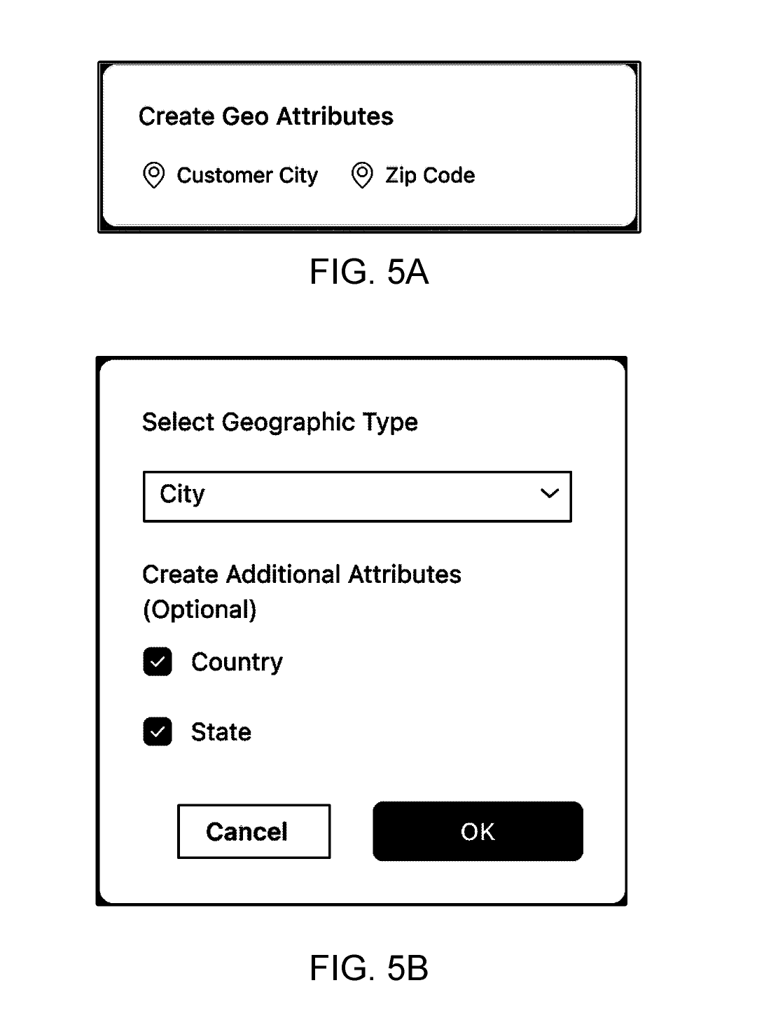

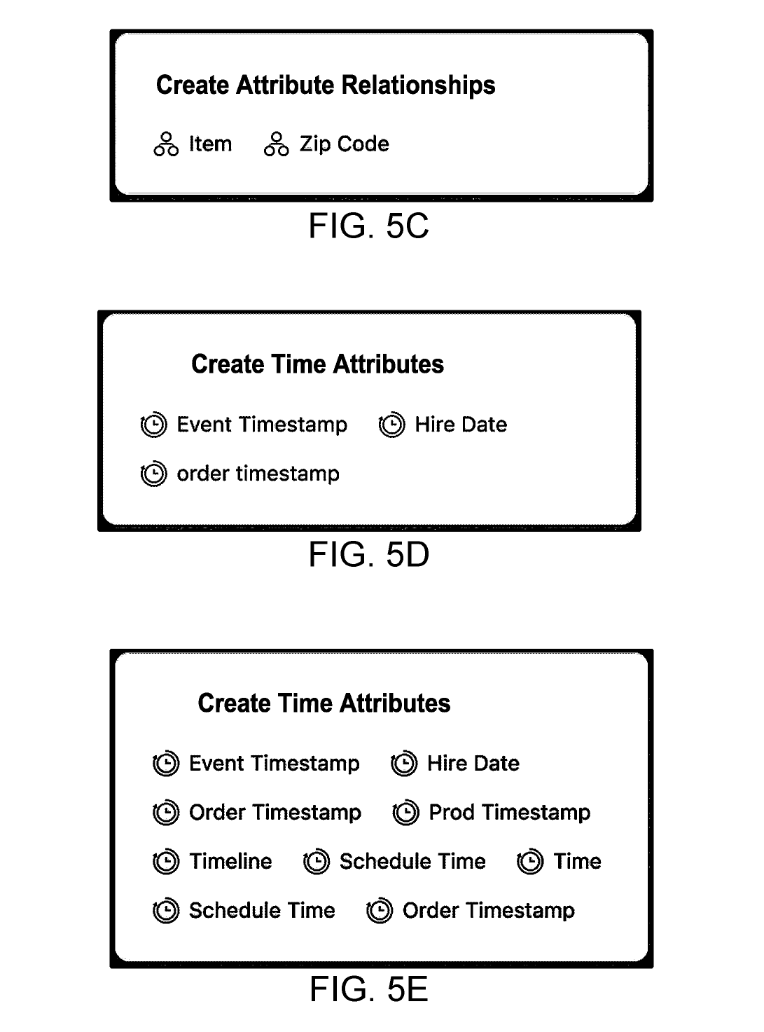

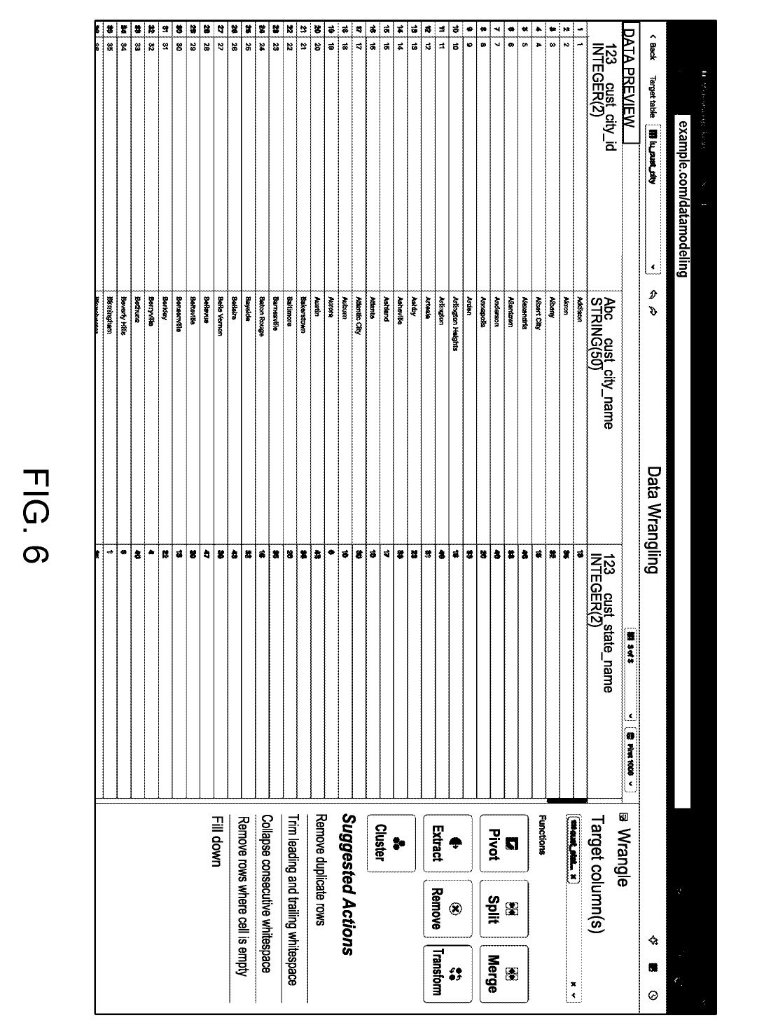

FIG. 5A-5E are diagrams showing examples of user interfaces that indicate actions for data modeling and data adjustment, including enriching data by creating attributes and attribute relationships.

FIG. 5A shows a recommendation item to create geographical attributes “Customer City” and “Zip Code.” From analysis of the information that is in a data set, the computer system 110 can identify additional parts of an attribute hierarchy to add. For example, if a geographical element such as street address is provided, the computer system 110 can be configured to suggest other geographical attributes to add, such as separate attributes for city and zip code here. Other such as county, state, and country, or coordinates for latitude and longitude, can also be recommended. In addition, the computer system 110 can enrich the data set by using other databased or data sources to enrich the data, by filling in the appropriate values for the new attribute columns.

FIG. 5B shows another example interface for a recommendation, with additional parameters for the user to customize which attributes are created.

FIG. 5B shows a recommendation from the computer system 110 to create attribute relationships, between an Item column and a Zip Code column. For example, the relationship can be determined based on the analysis in the process 159 of FIG. 1B.

FIGS. 5D and 5E show examples of recommendations for creating time attributes. This shows various time-related attributes that the computer system 110 has detected in a data set and is showing to the user to create and add to a data model.

FIG. 6 is a diagram showing an example of a user interface for data wrangling with recommendations determined using artificial intelligence or machine learning. the interface can show a data preview, showing various rows of information, along with recommendations (e.g., suggested actions), such as removing duplicate rows, trimming leading and trailing whitespace, collapsing consecutive whitespace, removing rows where a cell is empty, and so on

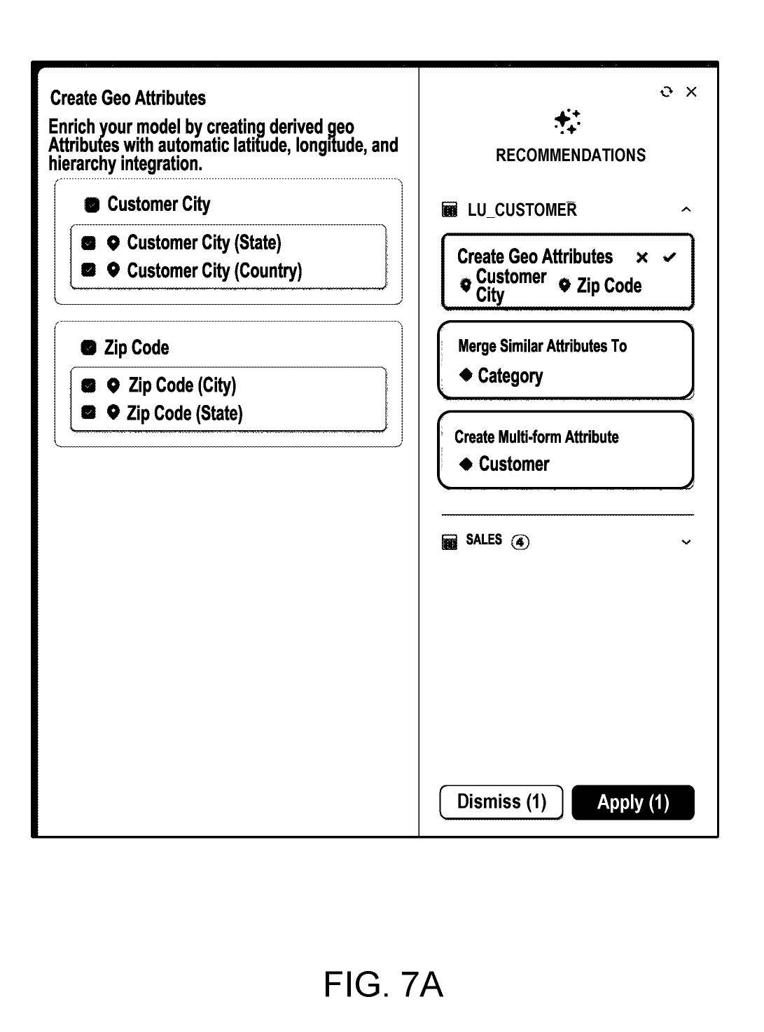

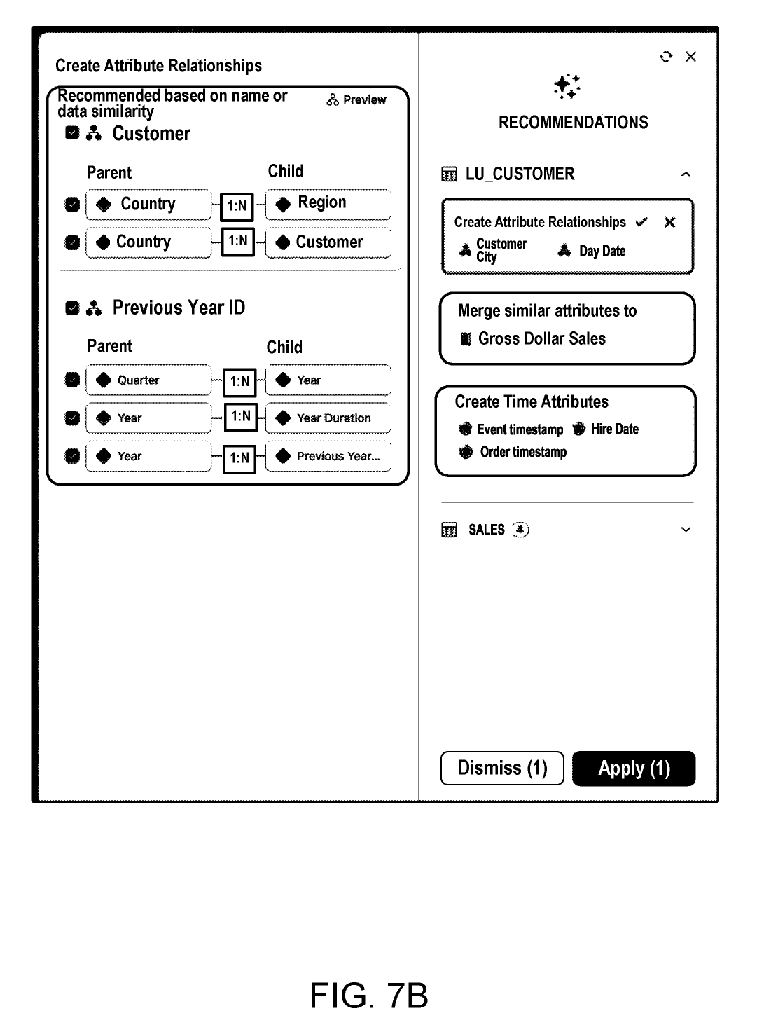

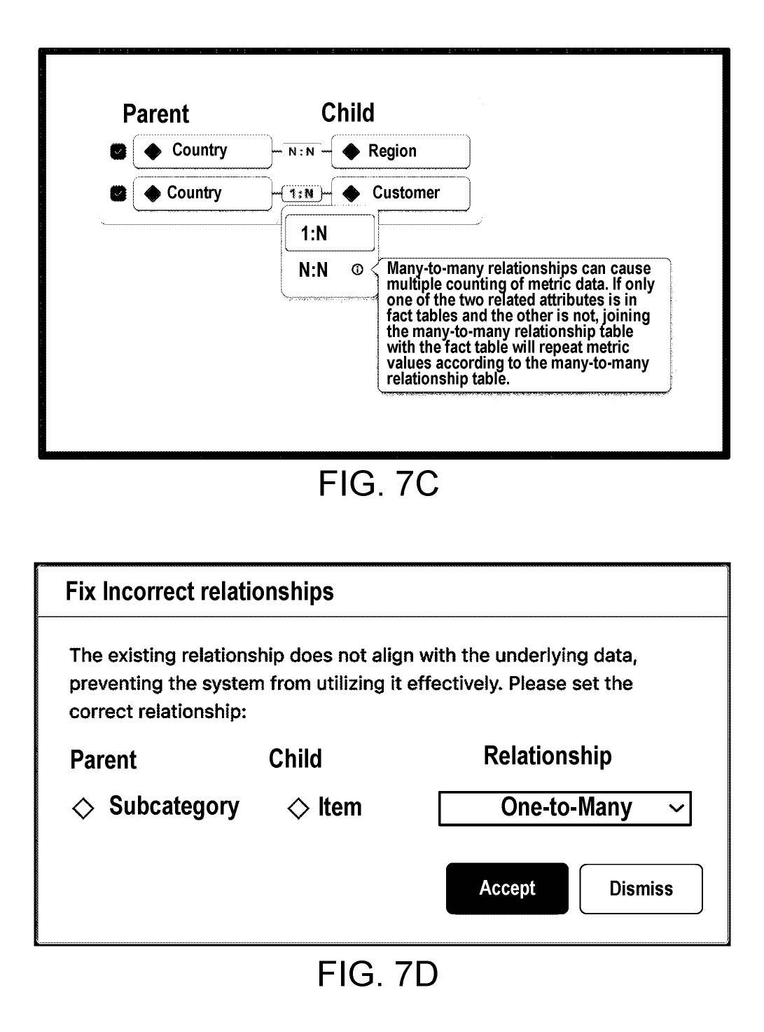

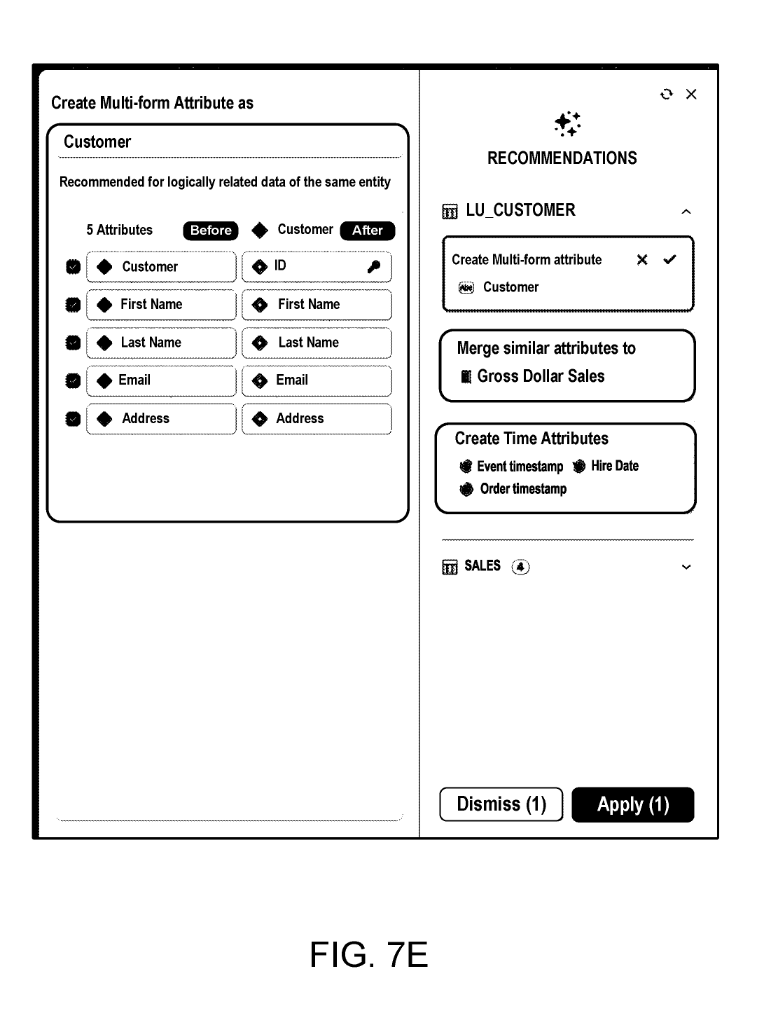

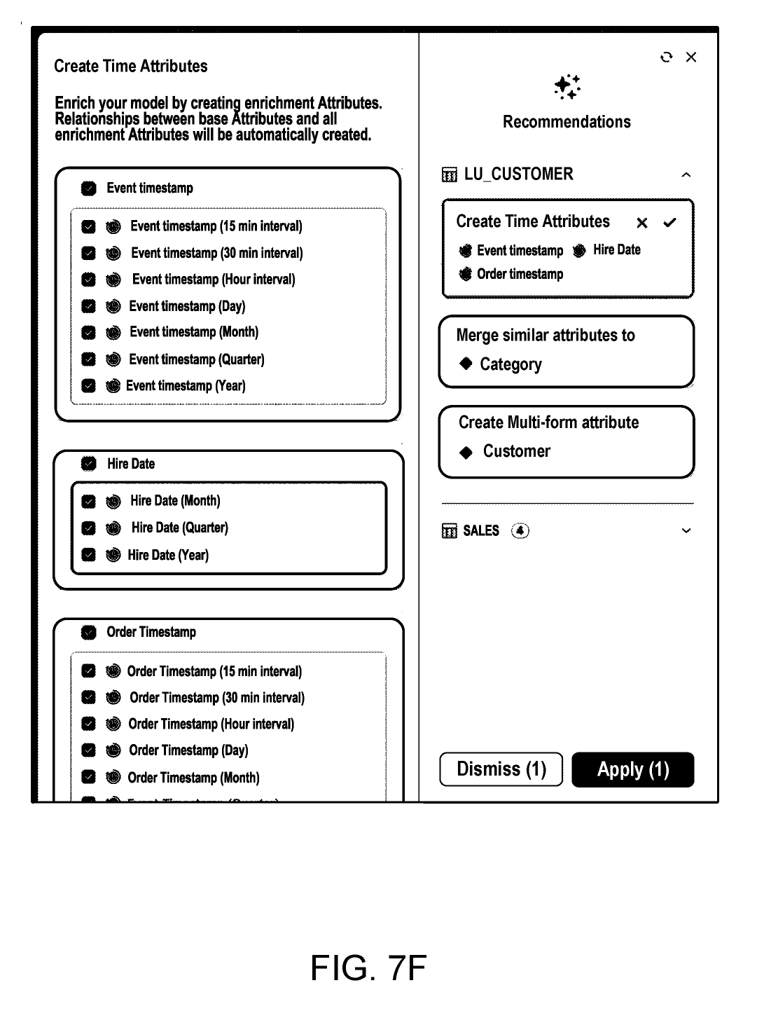

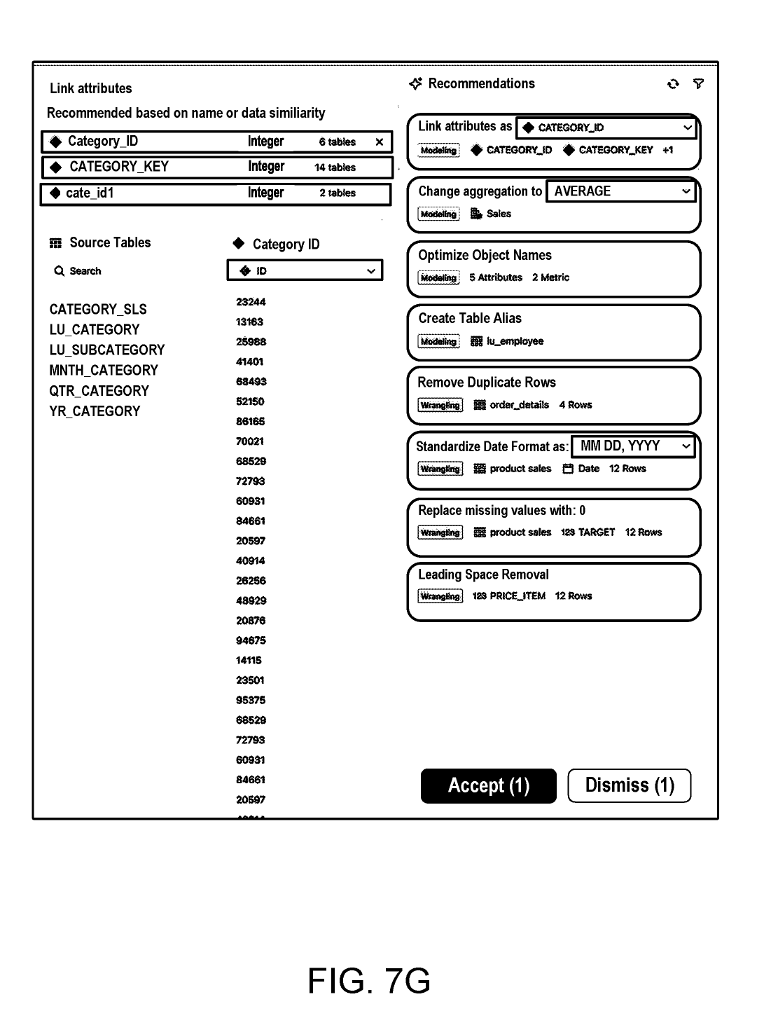

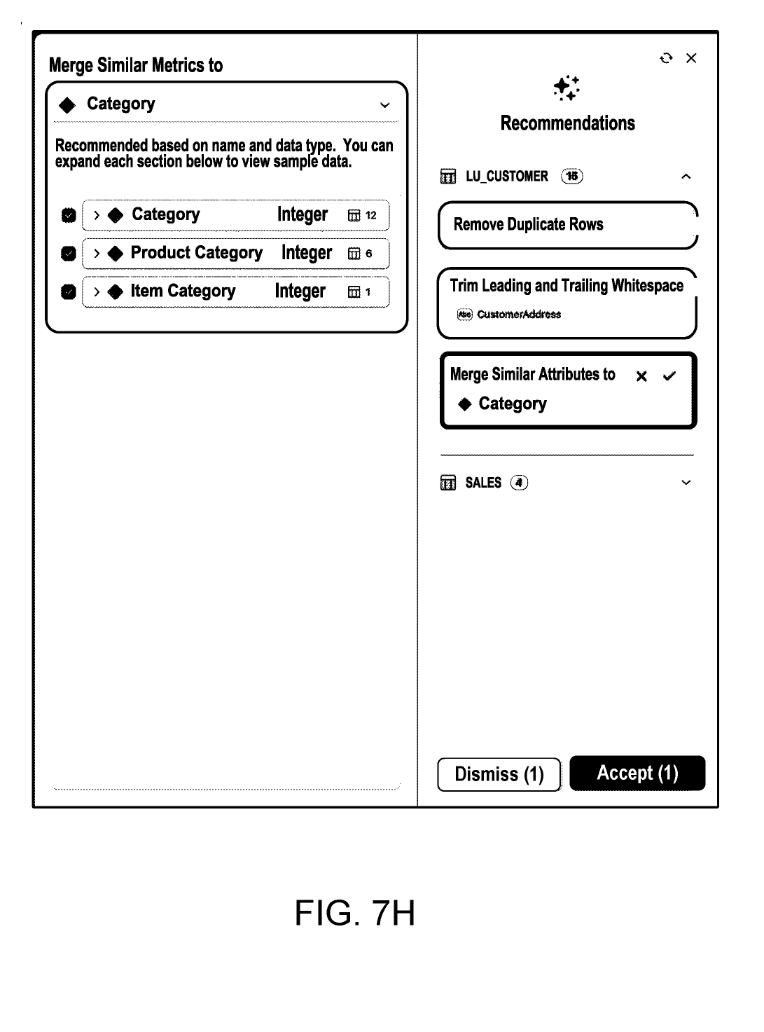

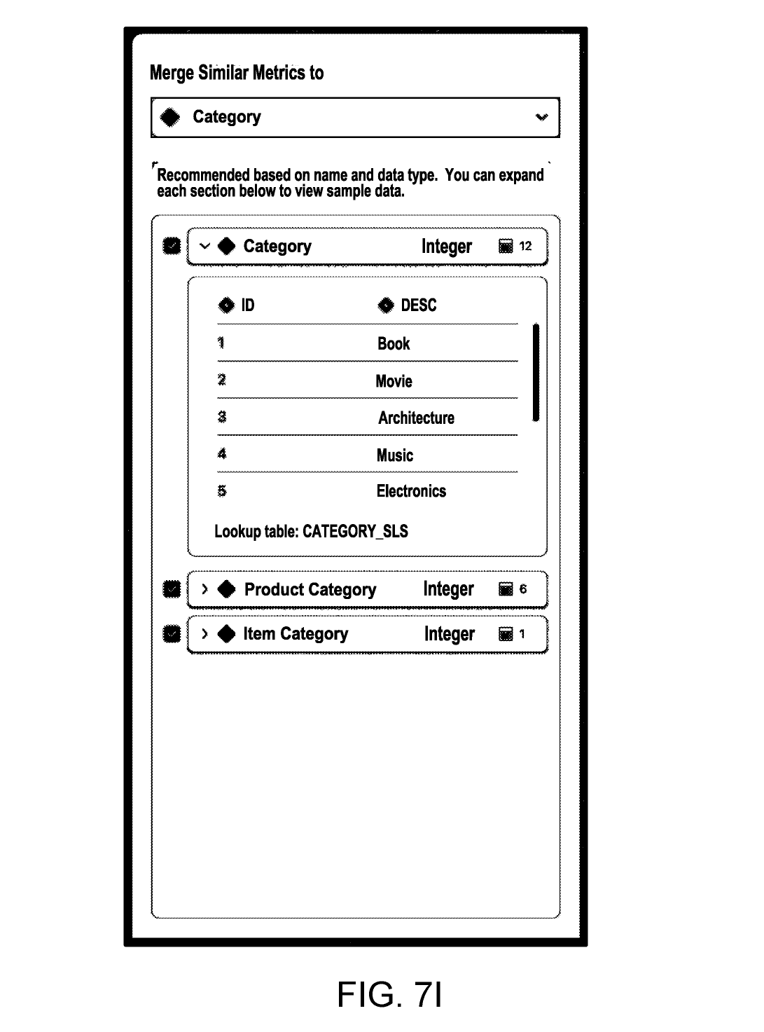

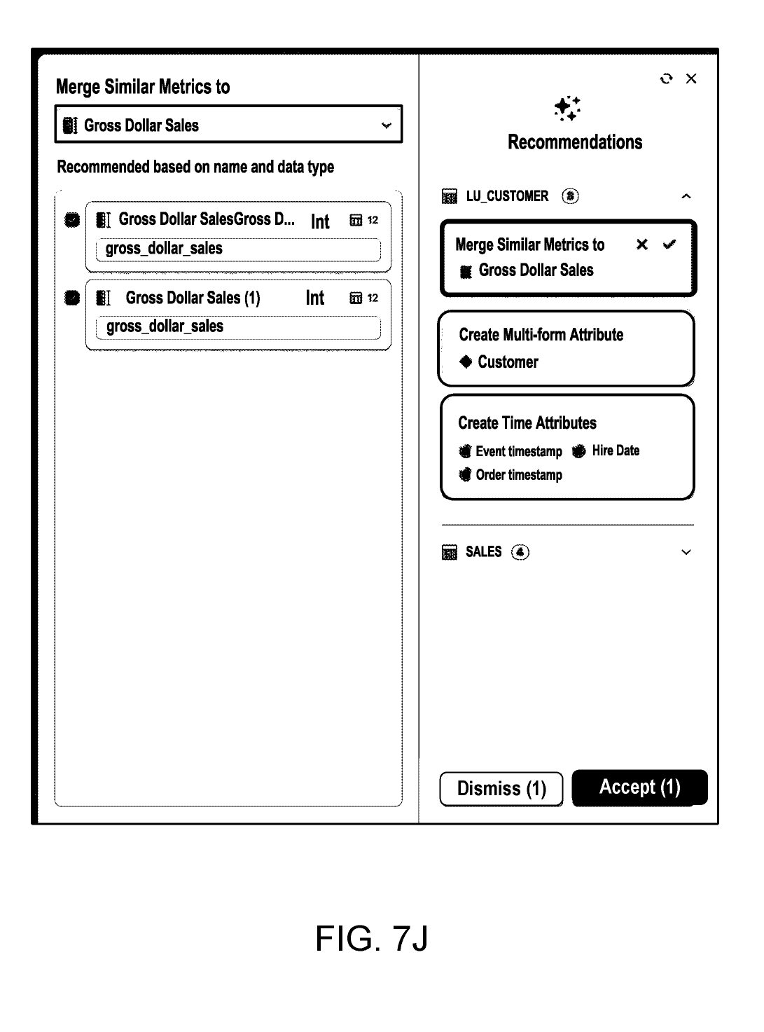

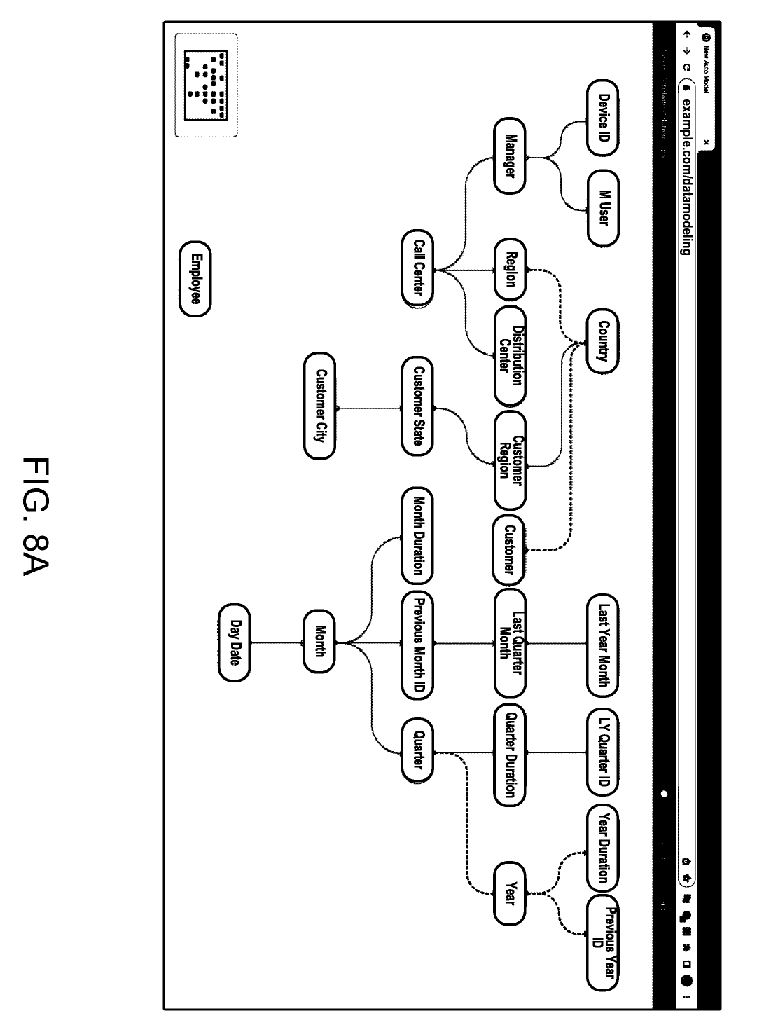

FIGS. 7A-7J are diagrams showing examples of user interfaces that show various types of recommendations for data modeling and data adjustment that are determined using artificial intelligence or machine learning. In some implementations, when a user selects a recommendation, the user interface can show an expanding panel or pane adjacent to the recommendation area. For example, a flyout region can extend to the side to provide additional information and controls for customizing the recommendation.

FIG. 7A shows an example where the creation of geographical attributes is shown in more detail with a pane to the left. FIG. 7B shows additional detail for creating attribute relationships, e.g., based on the attribute relationships determined by the computer system 110 in the analysis process 159. FIGS. 7C and 7D show examples of interfaces providing the ability to fix incorrect relationships in a data model, when errors are detected by the computer system 110.

FIG. 7E show a detailed view for creating a multi-form attribute. The detailed view shows five separate attributes in a “before” column, next to information in an “after” column that groups five attributes together into a “Customer” multi-form attribute.

FIG. 7F shows an example of a detailed view of a recommended expansion of time hierarchies for time-related column data. In the example, the computer system 110 determines that the timestamp data or date data can be represented at different levels of granularity that may be useful for aggregating and filtering in the future. As a result, the computer system 110 recommends creating new attributes that specify time in different intervals, such as every 15 minutes, every 30 minutes, ever hour, and so on for time stamps, and for dates to add separate year, month, and quarter attributes.

FIG. 7G shows an example with detail about a recommendation to link attributes. The interface view shows the source tables considered, and three identified attributes (e.g., Category_ID, CATEGORY_Key, and cate_id1) that are identified by the computer system 110 (using the AI/ML models 132) that they should be merged. In this case the recommendation to link or merge the columns (e.g., join them as a single logical object), is based on similarity in names or descriptions and data similarity (e.g., same data type and potentially shared data values). This can be done using the attribute linking 185 processing discussed above.

FIG. 7H, 7I, and 7J show a detailed views of recommendations to merge metrics, determined based on the similarity of names and descriptions as well as shared data types.

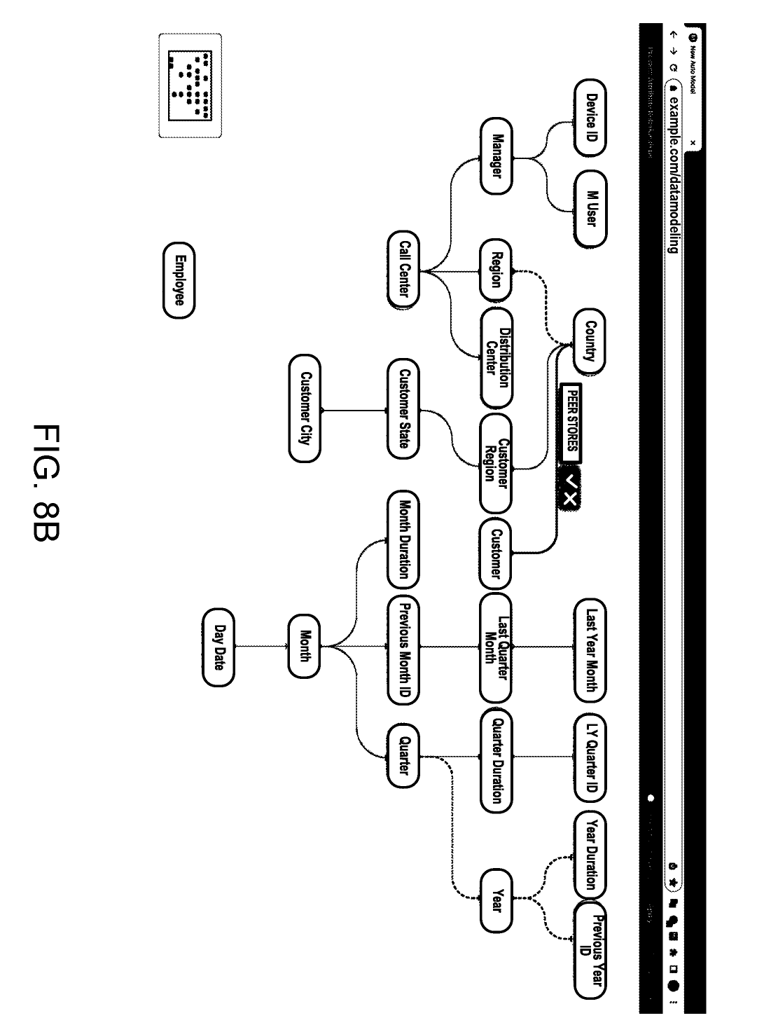

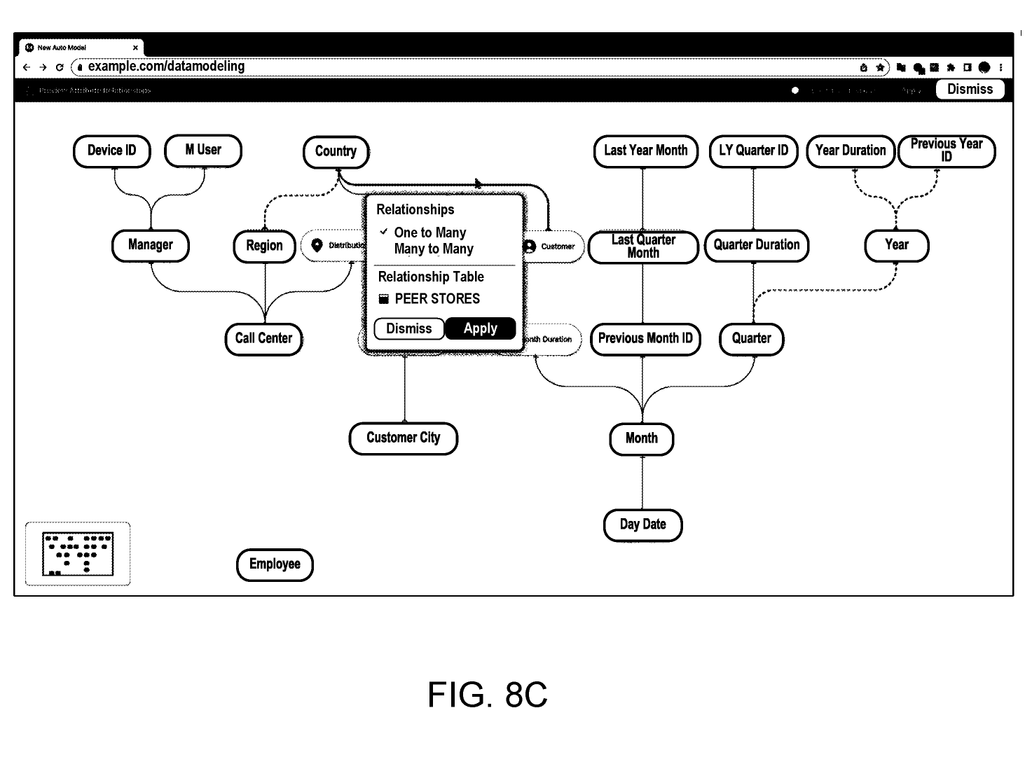

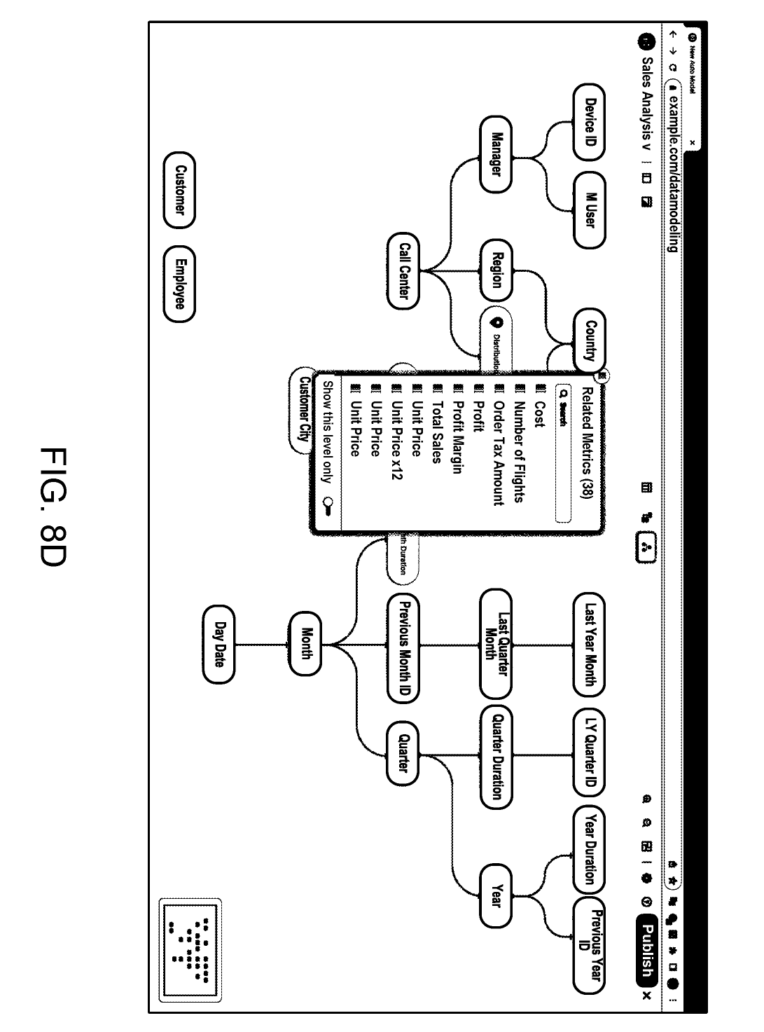

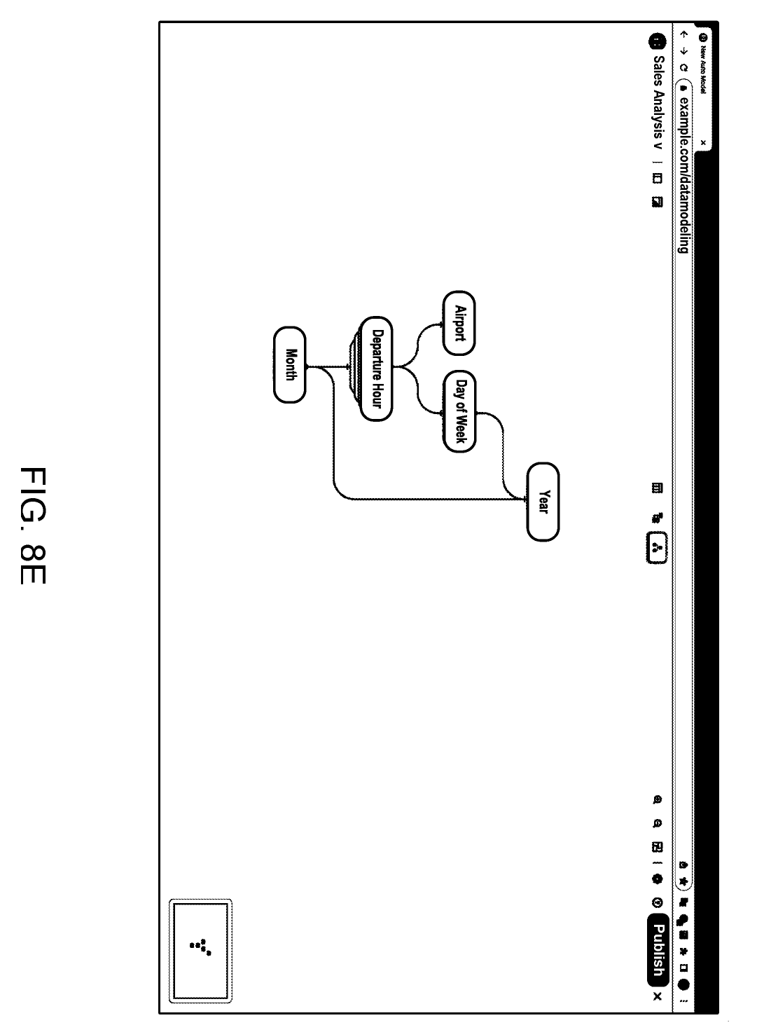

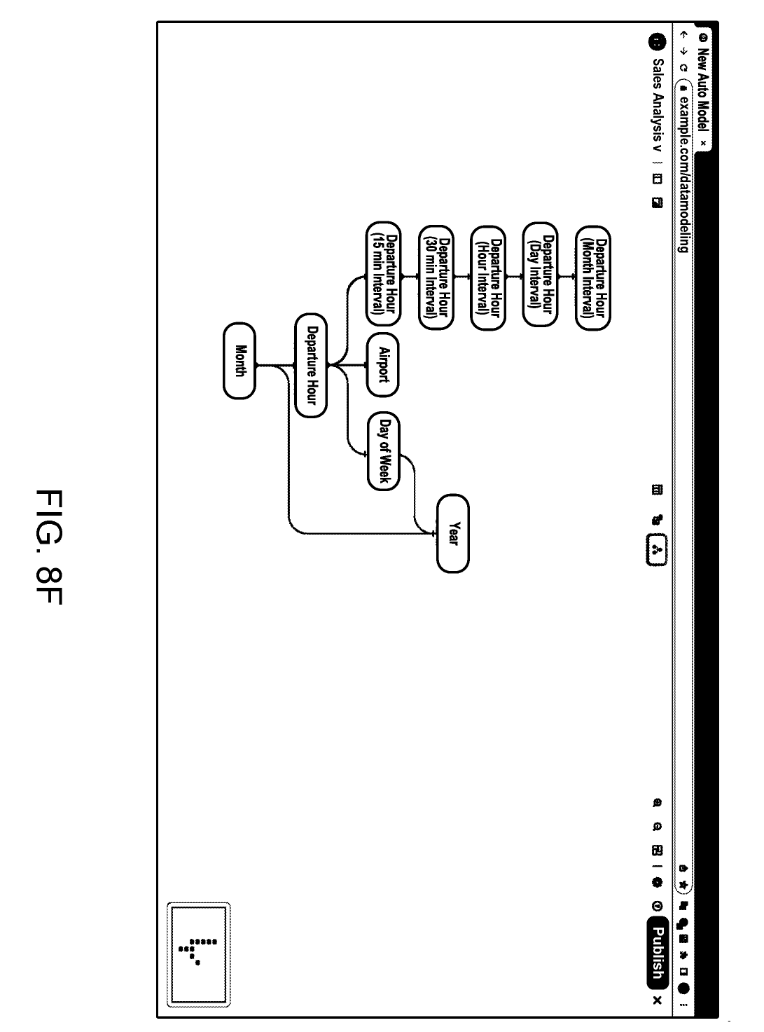

FIGS. 8A-8F are diagrams showing examples of user interfaces that show relationships between data objects and actions determined using the AI/ML models 132 to validate or establish relationships among data objects. The relationships can be determined and validated using the table relationship analysis 180 and attribute linking 175 and other techniques discussed above.

FIG. 8A shows a view of attributes and metrics and their relationships. Dashed lines show proposed connections or relationships that the computer system 110 identified based on analysis of the tables and their columns. FIG. 8B shows an example where a recommended connection based on a “PEER STORES” table, is suggested and the user can click the checkbox to approve or the x to remove the connection. FIG. 8C shows additional detail where the interface allows the user to set the connection or relationship type. FIG. 8D shows that from the relationship view, the system shows how related metrics for an attribute or metric are identified and shown to the user.

FIG. 8E shows relationships among attributes or metrics. The “departure hour” attribute is shown with its time hierarchy collapsed. FIG. 8F shows the time hierarchy expanded, showing the various different expanded attributes that the computer system has added.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

1. A method performed by one or more computers, the method comprising:
identifying, by the one or more computers, multiple data tables to be represented in a data model;
analyzing, by the one or more computers, the data tables using one or more artificial intelligence and/or machine learning (AI/ML) models, including a series of analysis operations including:
performing, for each of the data tables, semantic analysis for columns of the data table;
generating, for each of the data tables, names or descriptions for the columns of the data table based on results of the semantic analysis performed for the columns; and
performing relationship analysis for the multiple data tables to determine relationships among the data tables;
generating, by the one or more computers, content of the data model that includes the results of the semantic analysis, the names or descriptions for the columns in the data tables, and the determined relationships among the data tables; and
providing, by the one or more computers, content of the data model to one or more applications or services.

2. The method of claim 1, wherein performing the semantic analysis comprises performing semantic analysis for the columns using one or more AI/ML models to infer data types, detect semantic data roles, or detect data formats for the columns.

3. The method of claim 2, wherein the one or more AI/ML models perform the semantic analysis using (i) a table name for the data table, (ii) column names for columns in the data table, and (iii) a subset of rows of data of the data table.

4. The method of claim 1, wherein generating the names or descriptions for the columns is performed by the one or more AI/ML models to generate a natural language column name or a natural language column description based in part on data types or data roles determined through the semantic analysis for the columns.

5. The method of claim 1, wherein generating the names or descriptions for the columns is performed by the one or more AI/ML models based on column names generated by the one or more AI/ML models based on the semantic analysis for the columns.

6. The method of claim 1, wherein generating the names or descriptions for the columns is performed by the one or more AI/ML models using (i) a table name for the data table, (ii) column names for columns in the data table, and (iii) a subset of rows of data of the data table.

7. The method of claim 1, wherein performing the relationship analysis comprises performing the relationship analysis to detect within-group relationships and cross-group relationships for groups of columns using the one or more AI/ML models.

8. The method of claim 1, wherein performing the relationship analysis comprises:
performing a first relationship analysis process to detect one or more simple relationships among the data tables, including at least one of a one-to-one relationship between columns or a one-to-many relationship among columns;
performing a second relationship analysis process to detect one or more complex relationships among the data tables, including at least one of (i) a hierarchical relationship between columns, (ii) a grouping of related columns, or (iii) a relationship between columns within a group of columns, or (iv) a relationship between columns in different groups of columns; and
merging results of the first relationship analysis process and results of the second relationship analysis process, including validating the results to detect whether an inconsistency is present between the results of the of the first relationship analysis process and the results of the second relationship analysis process.

9. The method of claim 1, wherein the series of analysis operations comprises performing multi-form attribute grouping to group related columns or data objects, such that each group includes an identifier column and a set of related columns; and
wherein the generated content of the data model indicates one or more multi-form attribute groupings that indicates an identifier and a corresponding set of related columns.

10. The method of claim 9, wherein the multi-form attribute grouping is performed by the one or more AI/ML models based at least in part on one or more table names and column names.

11. The method of claim 1, wherein the series of analysis operations comprises determining, for each of one or more columns, a lookup table for the column based at least in part on a natural language table name and a natural language column name; and
wherein the generated content of the data model indicates one or more determined lookup tables for one or more columns.

12. The method of claim 11, wherein determining the lookup table is performed by the one or more AI/ML models based at least in part on a measure of amounts of distinct values for each of multiple columns.

13. The method of claim 1, wherein the series of analysis operations comprises attribute linking to identify columns of different data tables for joining the different data tables; and
wherein the generated content of the data model indicates identified set of columns for joining two or more data tables.

14. The method of claim 1, comprising, based on results of the series of analysis operations, generating user interface data configured to (i) indicate changes to make to the data model or one or more of the multiple data tables and (ii) display one or more interactive controls configured to cause the indicated changes to selectively applied in response to use interaction with the one or more interactive controls;
transmitting the user interface data to a client device over a communication network; and
receiving data indicating user input through interaction with the one or more interactive controls;
wherein generating the content of the data model is based on the data indicating the user input.

15. A system comprising:
one or more computers; and
one or more computer-readable media storing instructions that, when executed by the one or more computers, cause the one or more computers to perform operations comprising:
identifying, by the one or more computers, multiple data tables to be represented in a data model;
analyzing, by the one or more computers, the data tables using one or more artificial intelligence and/or machine learning (AI/ML) models, including a series of analysis operations including:
performing, for each of the data tables, semantic analysis for columns of the data table;
generating, for each of the data tables, names or descriptions for the columns of the data table based on results of the semantic analysis performed for the columns; and
performing relationship analysis for the multiple data tables to determine relationships among the data tables;
generating, by the one or more computers, content of the data model that includes the results of the semantic analysis, the names or descriptions for the columns in the data tables, and the determined relationships among the data tables; and
providing, by the one or more computers, content of the data model to one or more applications or services.

16. The system of claim 15, wherein performing the semantic analysis comprises performing semantic analysis for the columns using one or more AI/ML models to infer data types, detect semantic data roles, or detect data formats for the columns.

17. The system of claim 16, wherein the one or more AI/ML models perform the semantic analysis using (i) a table name for the data table, (ii) column names for columns in the data table, and (iii) a subset of rows of data of the data table.

18. One or more non-transitory computer-readable media storing instructions that, when executed by the one or more computers, cause the one or more computers to perform operations comprising:
identifying, by the one or more computers, multiple data tables to be represented in a data model;
analyzing, by the one or more computers, the data tables using one or more artificial intelligence and/or machine learning (AI/ML) models, including a series of analysis operations including:
performing, for each of the data tables, semantic analysis for columns of the data table;
generating, for each of the data tables, names or descriptions for the columns of the data table based on results of the semantic analysis performed for the columns; and
performing relationship analysis for the multiple data tables to determine relationships among the data tables;
generating, by the one or more computers, content of the data model that includes the results of the semantic analysis, the names or descriptions for the columns in the data tables, and the determined relationships among the data tables; and
providing, by the one or more computers, content of the data model to one or more applications or services.

19. The one or more non-transitory computer-readable media of claim 18, wherein performing the semantic analysis comprises performing semantic analysis for the columns using one or more AI/ML models to infer data types, detect semantic data roles, or detect data formats for the columns.

20. The one or more non-transitory computer-readable media of claim 19, wherein the one or more AI/ML models perform the semantic analysis using (i) a table name for the data table, (ii) column names for columns in the data table, and (iii) a subset of rows of data of the data table.
